SEQUENCE LISTING (112 sequences)

SEQ ID NO: 1 - protein, 429 aa, Podocoryna carnea
GPQGVVGADGKDGTPGEKGEQGRTGAAGKQGSPGADGARGPLGSIGQQGARGEPGDPGSPGLRGDTGLAGVKGVAGPSGRPGQPGANGLPGVNGRGGLRGKPGAKGIAGSDGEAGESGAPGQSGPTGPRGQRGPSGEDGNPGLQGLPGSDGEPGEEGQPGRSGQPGQQGPRGSPGEVGPRGSKGPSGDRGDRGERGVPGQTGSAGNVGEDGEQGGKGVDGASGPSGALGARGPPGSRGDTGAVGPPGPTGRSGLPGNAGQKGPSGEPGSPGKAGSAGEQGPPGKDGSNGEPGSPGKEGERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLR

SEQ ID NO: 2 - DNA, 1289 bp, Podocoryna carnea
ggaccacaaggtgttgtaggagctgatggcaaagatggaacaccgggagagaaaggtgagcaaggacgaaccggagctgcaggaaaacagggaagccctggagcagatggagcaagaggccctcttggatcaattggacaacaaggtgctcgtggagaacctggtgatccaggatctcccggcttaagaggagatactggattggctggagtcaaaggagtagcaggaccatctggtcgacctggacaacccggtgcaaatggattacctggtgtgaatggcagaggcggtttgagaggcaaacctggtgctaaaggaattgctggcagtgatggagaagcgggagaatctggcgcacctggacagtccggacctaccggtccacgtggtcaacgaggaccaagtggtgaggatggtaatcctggattacagggattgcctggttctgatggagagcccggagaggaaggacaacctggaagatctggtcaaccaggacagcaaggaccacgtggttcccctggagaggtaggaccaagaggatctaaaggtccatcaggagatcgtggtgacaggggagagagaggtgttcctggacaaacaggttcggctggaaatgtaggagaagatggagagcaaggaggcaaaggtgtcgatggagcgagtggaccaagtggagctcttggtgctcgtggtcccccaggaagtagaggtgacaccggggcagtgggacctcccggacctactgggcgatctggtttacctggaaacgcaggacaaaagggaccaagtggtgaaccaggtagtccaggaaaagcaggatcagctggtgaacagggtcctcctggtaaagacggatcaaatggtgaacctggatctcctggcaaagagggtgaacgtggtcttgctggtccaccaggtccagatggcagacgtggtgaaacgggatctccaggtatcgctggtgctcttggtaaaccaggtttggaaggacctaaaggttatccaggattaagaggaagagatggaaccaatggcaaacgaggagaacaaggagaaactggtcctgatggagtcagaggtattcctggaaatgatggacaatctggcaaaccaggtattgatggtattgacggaacaaatggtcaaccaggtgaggctggataccaaggtggtagaggtacacgtggtcagttaggtgaaactggtgatgtcggacagaatggagatcgaggagctcctggtcctgatggatctaaaggttctgctggtagaccaggacttcgtgg

SEQ ID NO: 3 - DNA, 1425 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatcaccatcaccaccaccaccatcaccactctggctcgagcctggtgccgcgcggcagccatatgggtccgcagggtgttgttggtgcagatggtaaagacggtaccccgggtgaaaaaggagaacagggacgtacaggtgcagcaggtaaacagggcagcccgggtgccgatggtgcccgtggcccgctgggtagcattggtcagcagggtgcaagaggcgaaccgggcgatccgggtagtccgggcctgcgtggtgatacgggtctggccggtgttaaaggcgttgcaggtccttcaggtcgtccaggtcaaccgggtgcaaatggtctgccgggtgttaatggtcgtggcggtctgcgtggcaaaccgggagcaaaaggtattgcaggtagcgatggagaagccggtgaaagcggtgccccgggtcagagtggtccgaccggtccgcgcggtcagcgtggtccgtctggtgaagatggcaatccgggtctgcagggtctgcctggtagtgatggcgaaccaggtgaagaaggtcagccgggtcgttcaggccagccgggccagcagggcccgcgtggtagcccgggcgaagttggcccgcggggtagtaaaggtcctagtggcgatcgcggtgatcgtggtgaacgcggtgttcctggtcagaccggtagcgcaggtaatgttggcgaagatggtgaacagggtggcaaaggtgttgatggtgcaagcggtccgagcggtgcactgggtgcacgtggtcctccgggcagccgtggtgacaccggtgcagttggtccgcctggcccgaccggccgtagtggcttaccgggtaatgcaggtcagaaaggtccgtcaggtgaacctggcagccctggtaaagcaggtagtgccggtgagcagggtccgccgggcaaagatggtagtaatggtgagccgggtagccctggcaaagaaggtgaacgtggtctggcaggaccgccgggtcctgatggtcgccgcggtgaaacgggttcaccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaacaggtgatgttggtcagaatggtgatcgcggcgcaccgggtccggatggtagcaaaggtagcgccggtcgtccgggtttacgttaa

SEQ ID NO: 4 - DNA, 1425 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatcaccatcaccaccaccaccatcaccactctggctcgagcctggtgccgcgcggcagccatatgggtccgcagggtgttgttggtgcagatggtaaagacggtaccccgggtgaaaaaggtgaacagggtcgtaccggtgcagcaggtaaacagggcagcccgggtgccgatggtgcccgtggcccgctgggtagcattggtcagcagggtgcacgtggcgaaccgggcgatccgggtagcccgggcctgcgtggtgatacgggtctggccggtgttaaaggcgttgcaggtccttctggtcgtccaggtcaaccgggtgcaaatggtctgccgggtgttaatggtcgtggcggtctgcgtggcaaaccgggtgcaaaaggtattgcaggtagcgatggcgaagccggtgaaagcggtgccccgggtcagagcggtccgaccggtccgcgcggtcagcgtggtccgtctggtgaagatggcaatccgggtctgcagggtctgcctggtagcgatggcgaaccaggtgaagaaggtcagccgggtcgttctggccagccgggccagcagggcccgcgtggtagcccgggcgaagttggcccgcgcggttctaaaggtcctagcggcgatcgcggtgatcgtggtgaacgcggtgttcctggtcagaccggtagcgcaggtaatgttggcgaagatggtgaacagggtggcaaaggtgttgatggtgcaagcggtccgagcggtgcactgggtgcacgtggtcctccgggcagccgtggtgacaccggtgcagttggtccgcctggcccgaccggccgtagcggcctgccgggtaatgcaggtcagaaaggtccgtctggtgaacctggcagccctggtaaagcaggtagcgccggtgagcagggtccgccgggcaaagatggtagcaatggtgagccgggtagccctggcaaagaaggtgaacgtggtctggcaggtccgccgggtcctgatggtcgccgcggtgaaacgggttctccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaaccggtgatgttggtcagaatggtgatcgcggcgcaccgggtccggatggtagcaaaggtagcgccggtcgtccgggtctgcgttaa

SEQ ID NO: 5 - protein, 474 aa, Artificial Sequence
  source: /note=“Description of Artificial Sequence Synthetic polypeptide”
MKKIWLALAGLVLAFSASAAQYEDHHHHHHHHHSGSSLVPRGSHMGPQGVVGADGKDGTPGEKGEQGRTGAAGKQGSPGADGARGPLGSIGQQGARGEPGDPGSPGLRGDTGLAGVKGVAGPSGRPGQPGANGLPGVNGRGGLRGKPGAKGIAGSDGEAGESGAPGQSGPTGPRGQRGPSGEDGNPGLQGLPGSDGEPGEEGQPGRSGQPGQQGPRGSPGEVGPRGSKGPSGDRGDRGERGVPGQTGSAGNVGEDGEQGGKGVDGASGPSGALGARGPPGSRGDTGAVGPPGPTGRSGLPGNAGQKGPSGEPGSPGKAGSAGEQGPPGKDGSNGEPGSPGKEGERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLR

SEQ ID NO: 6 - DNA, 1362 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatggtccgcagggtgttgttggtgcagatggtaaagacggtaccccgggtgaaaaaggagaacagggacgtacaggtgcagcaggtaaacagggcagcccgggtgccgatggtgcccgtggcccgctgggtagcattggtcagcagggtgcaagaggcgaaccgggcgatccgggtagtccgggcctgcgtggtgatacgggtctggccggtgttaaaggcgttgcaggtccttcaggtcgtccaggtcaaccgggtgcaaatggtctgccgggtgttaatggtcgtggcggtctgcgtggcaaaccgggagcaaaaggtattgcaggtagcgatggagaagccggtgaaagcggtgccccgggtcagagtggtccgaccggtccgcgcggtcagcgtggtccgtctggtgaagatggcaatccgggtctgcagggtctgcctggtagtgatggcgaaccaggtgaagaaggtcagccgggtcgttcaggccagccgggccagcagggcccgcgtggtagcccgggcgaagttggcccgcggggtagtaaaggtcctagtggcgatcgcggtgatcgtggtgaacgcggtgttcctggtcagaccggtagcgcaggtaatgttggcgaagatggtgaacagggtggcaaaggtgttgatggtgcaagcggtccgagcggtgcactgggtgcacgtggtcctccgggcagccgtggtgacaccggtgcagttggtccgcctggcccgaccggccgtagtggcttaccgggtaatgcaggtcagaaaggtccgtcaggtgaacctggcagccctggtaaagcaggtagtgccggtgagcagggtccgccgggcaaagatggtagtaatggtgagccgggtagccctggcaaagaaggtgaacgtggtctggcaggaccgccgggtcctgatggtcgccgcggtgaaacgggttcaccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaacaggtgatgttggtcagaatggtgatcgcggcgcaccgggtccggatggtagcaaaggtagcgccggtcgtccgggtttacgttaa

SEQ ID NO: 7 - DNA, 1362 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatggtccgcagggtgttgttggtgcagatggtaaagacggtaccccgggtgaaaaaggtgaacagggtcgtaccggtgcagcaggtaaacagggcagcccgggtgccgatggtgcccgtggcccgctgggtagcattggtcagcagggtgcacgtggcgaaccgggcgatccgggtagcccgggcctgcgtggtgatacgggtctggccggtgttaaaggcgttgcaggtccttctggtcgtccaggtcaaccgggtgcaaatggtctgccgggtgttaatggtcgtggcggtctgcgtggcaaaccgggtgcaaaaggtattgcaggtagcgatggcgaagccggtgaaagcggtgccccgggtcagagcggtccgaccggtccgcgcggtcagcgtggtccgtctggtgaagatggcaatccgggtctgcagggtctgcctggtagcgatggcgaaccaggtgaagaaggtcagccgggtcgttctggccagccgggccagcagggcccgcgtggtagcccgggcgaagttggcccgcgcggttctaaaggtcctagcggcgatcgcggtgatcgtggtgaacgcggtgttcctggtcagaccggtagcgcaggtaatgttggcgaagatggtgaacagggtggcaaaggtgttgatggtgcaagcggtccgagcggtgcactgggtgcacgtggtcctccgggcagccgtggtgacaccggtgcagttggtccgcctggcccgaccggccgtagcggcctgccgggtaatgcaggtcagaaaggtccgtctggtgaacctggcagccctggtaaagcaggtagcgccggtgagcagggtccgccgggcaaagatggtagcaatggtgagccgggtagccctggcaaagaaggtgaacgtggtctggcaggtccgccgggtcctgatggtcgccgcggtgaaacgggttctccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaaccggtgatgttggtcagaatggtgatcgcggcgcaccgggtccggatggtagcaaaggtagcgccggtcgtccgggtctgcgttaa

SEQ ID NO: 8 - protein, 453 aa, Artificial Sequence
  source: /note=“Description of Artificial Sequence Synthetic polypeptide”
MKKIWLALAGLVLAFSASAAQYEDGPQGVVGADGKDGTPGEKGEQGRTGAAGKQGSPGADGARGPLGSIGQQGARGEPGDPGSPGLRGDTGLAGVKGVAGPSGRPGQPGANGLPGVNGRGGLRGKPGAKGIAGSDGEAGESGAPGQSGPTGPRGQRGPSGEDGNPGLQGLPGSDGEPGEEGQPGRSGQPGQQGPRGSPGEVGPRGSKGPSGDRGDRGERGVPGQTGSAGNVGEDGEQGGKGVDGASGPSGALGARGPPGSRGDTGAVGPPGPTGRSGLPGNAGQKGPSGEPGSPGKAGSAGEQGPPGKDGSNGEPGSPGKEGERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLR

SEQ ID NO: 9 - DNA, 825 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatcaccatcaccaccaccaccatcaccactctggctcgagcctggtgccgcgcggcagccatatgggtccgcagggtgttgttggtgcagatggtaaagacggtaccccgggtgaaaaaggagaacagggacgtacaggtgcagcaggtaaacagggcagcccgggtgccgatggtgcccgtggcccgctgggtagcattggtcagcagggtgcaagaggcgaaccgggcgatccgggtagtccgggcctgcgtggtgatacgggtctggccggtgttaaaggcgttgcaggtccttcaggtcgtccaggtcaaccgggtgcaaatggtctgccgggtgttaatggtcgtggcggtctggaacgtggtctggcaggaccgccgggtcctgatggtcgccgcggtgaaacgggttcaccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaacaggtgatgttggtcagaatggtgatcgcggcgcaccgggtccggatggtagcaaaggtagcgccggtcgtccgggtttacgttaa

SEQ ID NO: 10 - protein, 274 aa, Artificial Sequence
  source: /note=“Description of Artificial Sequence Synthetic polypeptide”
MKKIWLALAGLVLAFSASAAQYEDHHHHHHHHHSGSSLVPRGSHMGPQGVVGADGKDGTPGEKGEQGRTGAAGKQGSPGADGARGPLGSIGQQGARGEPGDPGSPGLRGDTGLAGVKGVAGPSGRPGQPGANGLPGVNGRGGLERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLR

SEQ ID NO: 11 - DNA, 642 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatggtccgcagggtgttgttggtgcagatggtaaagacggtaccccgggtaatgcaggtcagaaaggtccgtcaggtgaacctggcagccctggtaaagcaggtagtgccggtgagcagggtccgccgggcaaagatggtagtaatggtgagccgggtagccctggcaaagaaggtgaacgtggtctggcaggaccgccgggtcctgatggtcgccgcggtgaaacgggttcaccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaacaggtgatgttggtcagaatggtgatcgcggcgcaccgggtccggatggtagcaaaggtagcgccggtcgtccgggtttacgttaa

SEQ ID NO: 12 - protein, 213 aa, Artificial Sequence
  source: /note=“Description of Artificial Sequence Synthetic polypeptide”
MKKIWLALAGLVLAFSASAAQYEDGPQGVVGADGKDGTPGNAGQKGPSGEPGSPGKAGSAGEQGPPGKDGSNGEPGSPGKEGERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLR

SEQ ID NO: 13 - DNA, 696 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatggtgaaaaaggtgaaaagggcgagaaaggtgagaaaggcgaaaagggtgaaaaaggtccgcagggtgttgttggtgcagatggtaaagacggtaccccgggtaatgcaggtcagaaaggtccgtcaggtgaacctggcagccctggtaaagcaggtagtgccggtgagcagggtccgccgggcaaagatggtagtaatggtgagccgggtagccctggcaaagaaggtgaacgtggtctggcaggaccgccgggtcctgatggtcgccgcggtgaaacgggttcaccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaacaggtgatgttggtcagaatggtgatcgcggcgcaccgggtccggatggtagcaaaggtagcgccggtcgtccgggtttacgttaa

SEQ ID NO: 14 - protein, 231 aa, Artificial Sequence
  source: /note=“Description of Artificial Sequence Synthetic polypeptide”
MKKIWLALAGLVLAFSASAAQYEDGEKGEKGEKGEKGEKGEKGPQGVVGADGKDGTPGNAGQKGPSGEPGSPGKAGSAGEQGPPGKDGSNGEPGSPGKEGERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLR

SEQ ID NO: 15 - DNA, 696 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatggtgataaaggtgataagggcgacaaaggtgacaaaggcgataagggtgataaaggtccgcagggtgttgttggtgcagatggtaaagacggtaccccgggtaatgcaggtcagaaaggtccgtcaggtgaacctggcagccctggtaaagcaggtagtgccggtgagcagggtccgccgggcaaagatggtagtaatggtgagccgggtagccctggcaaagaaggtgaacgtggtctggcaggaccgccgggtcctgatggtcgccgcggtgaaacgggttcaccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaacaggtgatgttggtcagaatggtgatcgcggcgcaccgggtccggatggtagcaaaggtagcgccggtcgtccgggtttacgttaa

SEQ ID NO: 16 - protein, 231 aa, Artificial Sequence
  source: /note=“Description of Artificial Sequence Synthetic polypeptide”
MKKIWLALAGLVLAFSASAAQYEDGDKGDKGDKGDKGDKGDKGPQGVVGADGKDGTPGNAGQKGPSGEPGSPGKAGSAGEQGPPGKDGSNGEPGSPGKEGERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLR

SEQ ID NO: 17 - DNA, 2232 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatcaccatcaccaccaccaccatcaccactctggctcgagcctggtgccgcgcggcagccatatgtctggctcgagcagtaaaggtgaagaactgttcaccggtgttgttccgatcctggttgaactggatggtgatgttaacggccacaaattctctgttcgtggtgaaggtgaaggtgatgcaaccaacggtaaactgaccctgaaattcatctgcactaccggtaaactgccggttccatggccgactctggtgactaccctgacctatggtgttcagtgtttttctcgttacccggatcacatgaagcagcatgatttcttcaaatctgcaatgccggaaggttatgtacaggagcgcaccatttctttcaaagacgatggcacctacaaaacccgtgcagaggttaaatttgaaggtgatactctggtgaaccgtattgaactgaaaggcattgatttcaaagaggacggcaacatcctgggccacaaactggaatataacttcaactcccataacgtttacatcaccgcagacaaacagaagaacggtatcaaagctaacttcaaaattcgccataacgttgaagacggtagcgtacagctggcggaccactaccagcagaacactccgatcggtgatggtccggttctgctgccggataaccactacctgtccacccagtctaaactgtccaaagacccgaacgaaaagcgcgaccacatggtgctgctggagttcgttactgcagcaggtatcacgcacggcatggatgaactctacaaatctggcgcgccgggcggtccgcagggtgttgttggtgcagatggtaaagacggtaccccgggtaatgcaggtcagaaaggtccgtcaggtgaacctggcagccctggtaaagcaggtagtgccggtgagcagggtccgccgggcaaagatggtagtaatggtgagccgggtagccctggcaaagaaggtgaacgtggtctggcaggaccgccgggtcctgatggtcgccgcggtgaaacgggttcaccgggtattgccggtgccctgggtaaaccaggtctggaaggtccgaaaggttatcctggtctgcgcggtcgtgatggtaccaatggcaaacgtggcgaacagggcgaaaccggtccagatggtgttcgtggtattccgggtaacgatggtcagagcggtaaaccgggcattgatggtattgatggcaccaatggtcagcctggcgaagcaggttatcagggtggtcgcggtacccgtggtcagctgggtgaaacaggtgatgttggtcagaatggtgatcgcggcgcaccgggtccggatggtagcaaaggtagcgccggtcgtccgggtttacgtcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaa

SEQ ID NO: 18 - protein, 743 aa, Artificial Sequence
  source: /note=“Description of Artificial Sequence Synthetic polypeptide”
MKKIWLALAGLVLAFSASAAQYEDHHHHHHHHHSGSSLVPRGSHMSGSSSKGEELFTGVVPILVELDGDVNGHKFSVRGEGEGDATNGKLTLKFICTTGKLPVPWPTLVTTLTYGVQCFSRYPDHMKQHDFFKSAMPEGYVQERTISFKDDGTYKTRAEVKFEGDTLVNRIELKGIDFKEDGNILGHKLEYNFNSHNVYITADKQKNGIKANFKIRHNVEDGSVQLADHYQQNTPIGDGPVLLPDNHYLSTQSKLSKDPNEKRDHMVLLEFVTAAGITHGMDELYKSGAPGGPQGVVGADGKDGTPGNAGQKGPSGEPGSPGKAGSAGEQGPPGKDGSNGEPGSPGKEGERGLAGPPGPDGRRGETGSPGIAGALGKPGLEGPKGYPGLRGRDGTNGKRGEQGETGPDGVRGIPGNDGQSGKPGIDGIDGTNGQPGEAGYQGGRGTRGQLGETGDVGQNGDRGAPGPDGSKGSAGRPGLRHPETLVKVKDAEDQLGARVGYIELDLNSGKILESFRPEERFPMMSTFKVLLCGAVLSRIDAGQEQLGRRIHYSQNDLVEYSPVTEKHLTDGMTVRELCSAAITMSDNTAANLLLTTIGGPKELTAFLHNMGDHVTRLDRWEPELNEAIPNDERDTTMPVAMATTLRKLLTGELLTLASRQQLIDWMEADKVAGPLLRSALPAGWFIADKSGAGERGSRGIIAALGPDGKPSRIVVIYTTGSQATMDERNRQIAEIGASLIKHW

SEQ ID NO: 19 - DNA, 2232 bp, Artificial Sequence; identical to SEQ ID NO: 17
  source: /note=“Description of Artificial Sequence Synthetic polynucleotide”

SEQ ID NO: 20 - protein, 743 aa, Artificial Sequence; identical to SEQ ID NO: 18
  source: /note=“Description of Artificial Sequence Synthetic polypeptide”

SEQ ID NO: 21 - protein, 786 aa, Homo sapiens
MAGLTAAAPRPGVLLLLLSILHPSRPGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 22 - DNA, 2361 bp, Homo sapiens
atggcgggtctgacggcggcggccccgcggcccggagtcctcctgctcctgctgtccatcctccacccctctcggcctggaggggtccctggggccattcctggtggagttcctggaggagtcttttatccaggggctggtctcggagcccttggaggaggagcgctggggcctggaggcaaacctcttaagccagttcccggagggcttgcgggtgctggccttggggcagggctcggcgccttccccgcagttacctttccgggggctctggtgcctggtggagtggctgacgctgctgcagcctataaagctgctaaggctggcgctgggcttggtggtgtcccaggagttggtggcttaggagtgtctgcaggtgcggtggttcctcagcctggagccggagtgaagcctgggaaagtgccgggtgtggggctgccaggtgtatacccaggtggcgtgctcccaggagctcggttccccggtgtgggggtgctccctggagttcccactggagcaggagttaagcccaaggctccaggtgtaggtggagcttttgctggaatcccaggagttggaccctttgggggaccgcaacctggagtcccactggggtatcccatcaaggcccccaagctgcctggtggctatggactgccctacaccacagggaaactgccctatggctatgggcccggaggagtggctggtgcagcgggcaaggctggttacccaacagggacaggggttggcccccaggcagcagcagcagcggcagctaaagcagcagcaaagttcggtgctggagcagccggagtcctccctggtgttggaggggctggtgttcctggcgtgcctggggcaattcctggaattggaggcatcgcaggcgttgggactccagctgcagctgcagctgcagcagcagccgctaaggcagccaagtatggagctgctgcaggcttagtgcctggtgggccaggctttggcccgggagtagttggtgtcccaggagctggcgttccaggtgttggtgtcccaggagctgggattccagttgtcccaggtgctgggatcccaggtgctgcggttccaggggttgtgtcaccagaagcagctgctaaggcagctgcaaaggcagccaaatacggggccaggcccggagtcggagttggaggcattcctacttacggggttggagctgggggctttcccggctttggtgtcggagtcggaggtatccctggagtcgcaggtgtccctggtgtcggaggtgttcccggagtcggaggtgtcccgggagttggcatttcccccgaagctcaggcagcagctgccgccaaggctgccaagtacggtgctgcaggagcaggagtgctgggtgggctagtgccaggtccccaggcggcagtcccaggtgtgccgggcacgggaggagtgccaggagtggggaccccagcagctgcagctgctaaagcagccgccaaagccgcccagtttgggttagttcctggtgtcggcgtggctcctggagttggcgtggctcctggtgtcggtgtggctcctggagttggcttggctcctggagttggcgtggctcctggagttggtgtggctcctggcgttggcgtggctcccggcattggccctggtggagttgcagctgcagcaaaatccgctgccaaggtggctgccaaagcccagctccgagctgcagctgggcttggtgctggcatccctggacttggagttggtgtcggcgtccctggacttggagttggtgctggtgttcctggacttggagttggtgctggtgttcctggcttcggggcaggtgcagatgagggagttaggcggagcctgtcccctgagctcagggaaggagatccctcctcctctcagcacctccccagcaccccctcatcacccagggtacctggagccctggctgccgctaaagcagccaaatatggagcagcagtgcctggggtccttggagggctcggggctctcggtggagtaggcatcccaggcggtgtggtgggagccggacccgccgccgccgctgccgcagccaaagctgctgccaaagccgcccagtttggcctagtgggagccgctgggctcggaggactcggagtcggagggcttggagttccaggtgttgggggccttggaggtatacctccagctgcagccgctaaagcagctaaatacggtgctgctggccttggaggtgtcctagggggtgccgggcagttcccacttggaggagtggcagcaagacctggcttcggattgtctcccattttcccaggtggggcctgcctggggaaagcttgtggccggaagagaaaatga

SEQ ID NO: 23 - DNA, 2418 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatcaccatcaccaccaccaccatcaccactctggctcgagcctggtgccgcgcggcagccatatgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 24 - protein, 805 aa, Artificial Sequence
  source: /note=“Description of Artificial Sequence Synthetic polypeptide”
MKKIWLALAGLVLAFSASAAQYEDHHHHHHHHHSGSSLVPRGSHMGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 25 - DNA, 2358 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatatgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 26 - protein, 785 aa, Artificial Sequence
  source: /note=“Description of Artificial Sequence Synthetic polypeptide”
MKKIWLALAGLVLAFSASAAQYEDMGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 27 - DNA, 3945 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatcaccatcaccaccaccaccatcaccactctggctcgagcctggtgccgcgcggcagccatatgtctggctcgagcagtaaaggtgaagaactgttcaccggtgttgttccgatcctggttgaactggatggtgatgttaacggccacaaattctctgttcgtggtgaaggtgaaggtgatgcaaccaacggtaaactgaccctgaaattcatctgcactaccggtaaactgccggttccatggccgactctggtgactaccctgacctatggtgttcagtgtttttctcgttacccggatcacatgaagcagcatgatttcttcaaatctgcaatgccggaaggttatgtacaggagcgcaccatttctttcaaagacgatggcacctacaaaacccgtgcagaggttaaatttgaaggtgatactctggtgaaccgtattgaactgaaaggcattgatttcaaagaggacggcaacatcctgggccacaaactggaatataacttcaactcccataacgtttacatcaccgcagacaaacagaagaacggtatcaaagctaacttcaaaattcgccataacgttgaagacggtagcgtacagctggcggaccactaccagcagaacactccgatcggtgatggtccggttctgctgccggataaccactacctgtccacccagtctaaactgtccaaagacccgaacgaaaagcgcgaccacatggtgctgctggagttcgttactgcagcaggtatcacgcacggcatggatgaactctacaaatctggcgcgccgggcggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaacacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaa

SEQ ID NO: 28 - protein, 1314 aa, Artificial Sequence
  source: /note=“Description of Artificial Sequence Synthetic polypeptide”
MKKIWLALAGLVLAFSASAAQYEDHHHHHHHHHSGSSLVPRGSHMSGSSSKGEELFTGVVPILVELDGDVNGHKFSVRGEGEGDATNGKLTLKFICTTGKLPVPWPTLVTTLTYGVQCFSRYPDHMKQHDFFKSAMPEGYVQERTISFKDDGTYKTRAEVKFEGDTLVNRIELKGIDFKEDGNILGHKLEYNFNSHNVYITADKQKNGIKANFKIRHNVEDGSVQLADHYQQNTPIGDGPVLLPDNHYLSTQSKLSKDPNEKRDHMVLLEFVTAAGITHGMDELYKSGAPGGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRKHPETLVKVKDAEDQLGARVGYIELDLNSGKILESFRPEERFPMMSTFKVLLCGAVLSRIDAGQEQLGRRIHYSQNDLVEYSPVTEKHLTDGMTVRELCSAAITMSDNTAANLLLTTIGGPKELTAFLHNMGDHVTRLDRWEPELNEAIPNDERDTTMPVAMATTLRKLLTGELLTLASRQQLIDWMEADKVAGPLLRSALPAGWFIADKSGAGERGSRGIIAALGPDGKPSRIVVIYTTGSQATMDERNRQIAEIGASLIKHW

SEQ ID NO: 29 - protein, 761 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 30 - DNA, 2118 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgccctaa

SEQ ID NO: 31 - protein, 705 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPP

SEQ ID NO: 32 - DNA, 2118 bp, Artificial Sequence; identical to SEQ ID NO: 30
  source: /note=“Description of Artificial Sequence Synthetic polynucleotide”

SEQ ID NO: 33 - protein, 677 aa, Artificial Sequence
  source: /note=“Description of Artificial Sequence Synthetic polypeptide”
MGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 34 - DNA, 2034 bp, Artificial Sequence
  source: /note=“Description of Artificial Sequence Synthetic polynucleotide”
atgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 35 - protein, 660 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGP

SEQ ID NO: 36 - DNA, 1983 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccgtaa

SEQ ID NO: 37 - protein, 623 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGA

SEQ ID NO: 38 - DNA, 1872 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcataa

SEQ ID NO: 39 - protein, 528 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGV

SEQ ID NO: 40 - DNA, 1587 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtctaa

SEQ ID NO: 41 - protein, 516 aa, Artificial Sequence
  source: /note=“Description of Artificial Sequence Synthetic polypeptide”
MGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 42 - DNA, 1551 bp, Artificial Sequence
  source: /note=“Description of Artificial Sequence Synthetic polynucleotide”
atgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 43 - protein, 467 aa, Artificial Sequence
  source: /note=“Description of Artificial Sequence Synthetic polypeptide”
MGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 44 - DNA, 1404 bp, Artificial Sequence
  source: /note=“Description of Artificial Sequence Synthetic polynucleotide”
atgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 45 - protein, 461 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTP

SEQ ID NO: 46 - DNA, 1386 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccgtaa

SEQ ID NO: 47 - protein, 417 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTYGVGAGGFPGFGVGVGGIPGVAGVPGVGGVPGVGGVPGVGISPEAQ

SEQ ID NO: 48 - DNA, 1254 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacagtaa

SEQ ID NO: 49 - protein, 402 aa, Artificial Sequence
  source: /note=“Description of Artificial Sequence Synthetic polypeptide”
MRPGVGVGGIPTYGVGAGGFPGFGVGVGGIPGVAGVPGVGGVPGVGGVPGVGISPEAQAAAAAKAAKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 50 - DNA, 1209 bp, Artificial Sequence
  source: /note=“Description of Artificial Sequence Synthetic polynucleotide”
atgcgcccaggagtcggcgtgggtggtatcccgacctatggggtgggcgcagggggttttcctggtttcggcgtaggtgtaggaggtataccgggcgtggccggtgtaccaggggttggtggcgtccctggtgttggcggtgtgccaggtgttggtatttcaccggaagcacaggcagcagccgcagctaaggcagcgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 51 - protein, 372 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPEAAAKAAAKAAKYGARPGVGVGGIPTY

SEQ ID NO: 52 - DNA, 1119 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaagccgcagcgaaggctgcggcaaaggcagcaaagtatggcgcacgcccaggagtcggcgtgggtggtatcccgacctattaa

SEQ ID NO: 53 - protein, 346 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTPAAAAAAAAAAKAAKYGAAAGLVPGGPGFGPGVVGVPGAGVPGVGVPGAGIPVVPGAGIPGAAVPGVVSPE

SEQ ID NO: 54 - DNA, 1041 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccggccgcggcagctgcggcagcggcggctgccaaagctgctaaatacggtgccgcggcgggtctggtgccaggaggtccgggttttggtccgggagtggttggcgtgcctggcgcaggcgttcctggtgtgggcgttccaggtgcagggattcctgttgtgcctggtgccggtattcccggcgcggccgttccgggggtggttagcccggaataa

SEQ ID NO: 55 - protein, 337 aa, Artificial Sequence
  source: /note=“Description of Artificial Sequence Synthetic polypeptide”
MKYGAAGAGVLGGLVPGPQAAVPGVPGTGGVPGVGTPAAAAAKAAAKAAQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 56 - DNA, 1014 bp, Artificial Sequence
  source: /note=“Description of Artificial Sequence Synthetic polynucleotide”
atgaaatatggtgccgccggcgcaggagttttaggtgggctggttccgggcccgcaggcagctgtgccgggggttccaggcaccggtggtgtccctggagtcggtacgccggctgcagcggcagccaaagcggctgcgaaagcagcacagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 57 - protein, 289 aa, Artificial Sequence
  source: /note=“Description of Artificial Sequence Synthetic polypeptide”
MQFGLVPGVGVAPGVGVAPGVGVAPGVGLAPGVGVAPGVGVAPGVGVAPGIGPGGVAAAAKSAAKVAAKAQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 58 - DNA, 870 bp, Artificial Sequence
  source: /note=“Description of Artificial Sequence Synthetic polynucleotide”
atgcagtttggcttagtaccgggtgtgggagttgcccccggcgttggcgttgctccaggggtgggtgttgctcctggcgtcggtctggctcctggagtgggcgtagcacccggtgtgggggtggccccgggtgttggggttgcaccgggtatcggtccgggcggtgtcgcagcagcagctaaaagcgcggcgaaagttgcggccaaagcccaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 59 - protein, 276 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQAAAAAAAKAAAKFGAGAAGVLPGVGGAGVPGVPGAIPGIGGIAGVGTP

SEQ ID NO: 60 - DNA, 831 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcaggccgctgctgccgccgccgcaaaagcagcggctaaatttggcgccggagcagcgggtgttctgcctggagttggtggtgcgggcgtgccaggggtacctggtgcaattccgggtattggtggtattgccggtgtcggcaccccgtaa

SEQ ID NO: 61 - protein, 228 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVADAAAAYKAAKAGAGLGGVPGVGGLGVSAGAVVPQPGAGVKPGKVPGVGLPGVYPGGVLPGARFPGVGVLPGVPTGAGVKPKAPGVGGAFAGIPGVGPFGGPQPGVPLGYPIKAPKLPGGYGLPYTTGKLPYGYGPGGVAGAAGKAGYPTGTGVGPQ

SEQ ID NO: 62 - DNA, 687 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgatgcagccgcggcatataaagccgctaaagccggtgcgggtttaggaggcgtcccaggtgtcggtggcctgggtgttagcgccggtgcagttgttccgcagccgggagcaggggttaaacctggtaaagtgccgggagtaggtctgccaggcgtttatcctggtggtgttttgccgggtgcccgttttccgggcgttggtgttcttccaggcgtgccgaccggagccggtgttaaaccgaaagcccccggtgttggaggtgcatttgcaggcatcccgggagttggcccgtttggtggtccgcaacctggggttccgttaggttatccgattaaagcaccgaaactgcccggcggttatggtctgccgtacacaaccggtaaactgccgtatggttatggcccgggtggagttgcgggtgcagcaggtaaagcgggttatcctaccggaaccggtgtaggtccgcagtaa

SEQ ID NO: 63 - protein, 220 aa, Artificial Sequence
  source: /note=“Description of Artificial Sequence Synthetic polypeptide”
MQLRAAAGLGAGIPGLGVGVGVPGLGVGAGVPGLGVGAGVPGFGAGADEGVRRSLSPELREGDPSSSQHLPSTPSSPRVPGALAAAKAAKYGAAVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 64 - DNA, 663 bp, Artificial Sequence
  source: /note=“Description of Artificial Sequence Synthetic polynucleotide”
atgcaactgcgcgccgccgcgggcctcggtgcaggtattccggggctgggtgtcggagttggagtcccgggtttgggcgtgggcgcgggagttccgggactgggagtgggtgccggagttcctggctttggtgcaggcgcagatgaaggtgttcgtcgtagcctgagtccggaactgcgtgaaggtgatccgagtagcagccagcatctgccgagcaccccgagcagcccgcgtgttccgggtgcattagctgcagcaaaagccgccaagtatggtgcagccgtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 65 - protein, 127 aa, Artificial Sequence
  source: /note=“Description of Artificial Sequence Synthetic polypeptide”
MVPGVLGGLGALGGVGIPGGVVGAGPAAAAAAAKAAAKAAQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 66 - DNA, 384 bp, Artificial Sequence
  source: /note=“Description of Artificial Sequence Synthetic polynucleotide”
atggtgccgggcgtcttaggtggtctgggcgccctgggtggtgtaggcattccgggaggtgttgtgggtgcaggaccggccgccgcagctgcggccgccaaagcagctgcaaaagcggcccagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 67 - protein, 88 aa, Artificial Sequence
  source: /note=“Description of Artificial Sequence Synthetic polypeptide”
MQFGLVGAAGLGGLGVGGLGVPGVGGLGGIPPAAAAKAAKYGAAGLGGVLGGAGQFPLGGVAARPGFGLSPIFPGGACLGKACGRKRK

SEQ ID NO: 68 - DNA, 267 bp, Artificial Sequence
  source: /note=“Description of Artificial Sequence Synthetic polynucleotide”
atgcagtttggtttagtgggcgccgcaggtttaggcggtttaggtgtgggtggactgggtgtacctggcgtaggcggtctgggtggaattccgcccgcagcggccgcgaaagcggcaaaatatggcgcggcaggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 69 - protein, 73 aa, Artificial Sequence
  source: /note=“Description of Artificial Sequence Synthetic polypeptide”
MGGVPGAIPGGVPGGVFYPGAGLGALGGGALGPGGKPLKPVPGGLAGAGLGAGLGAFPAVTFPGALVPGGVAD

SEQ ID NO: 70 - DNA, 222 bp, Artificial Sequence
  source: /note=“Description of Artificial Sequence Synthetic polynucleotide”
atgggtggcgtaccaggcgcaattcctgggggtgtcccaggcggtgttttttatccgggcgccggtcttggcgcactgggtggcggtgcactgggcccgggcggcaaaccgctgaaaccggtaccaggtggtttagcaggcgccggcttaggcgcaggtctgggagcatttccggcagttacctttccaggggcactggttcctggaggtgtggccgattaa

SEQ ID NO: 71 - protein, 45 aa, Artificial Sequence
  source: /note=“Description of Artificial Sequence Synthetic polypeptide”
MGLGGVLGGAGQFPLGGVAARPGFGLSPIFPGGACLGKACGRKRK

SEQ ID NO: 72 - DNA, 138 bp, Artificial Sequence
  source: /note=“Description of Artificial Sequence Synthetic polynucleotide”
atgggcctgggcggcgtgctgggtggggcaggtcagtttccgctgggcggggttgccgcacgtccgggatttggtctgagcccgattttccctggcggcgcatgtctgggtaaagcatgtggtcgtaaacgtaaataa

SEQ ID NO: 73 - protein, 1102 aa, Artificial Sequence
  source: /note=“Description of Artificial Sequence Synthetic polypeptide”
MKKIWLALAGLVLAFSASAAQYEDHHHHHHHHHSGSSLVPRGSHMQLSYGYDEKSAGGISVPGPMGPSGPRGLPGPPGAPGPQGFQGPPGEPGEPGASGPMGPRGPPGPPGKNGDDGEAGKPGRPGERGPPGPQGARGLPGTAGLPGMKGHRGFSGLDGAKGDAGPAGPKGEPGSPGENGAPGQMGPRGLPGERGRPGAPGPAGARGNDGATGAAGPPGPTGPAGPPGFPGAVGAKGEAGPQGARGSEGPQGVRGEPGPPGPAGAAGPAGNPGADGQPGAKGANGAPGIAGAPGFPGARGPAGPQGPSGAPGPKGNSGEPGAPGSKGDAGAKGEPGPIGIQGPPGPAGEEGKRGARGEPGPTGLPGPPGERGGPGSRGFPGADGVAGPKGPAGERGSPGPAGPKGSPGEAGRPGEAGLPGAKGLTGSPGSPGPDGKTGPPGPAGQDGRPGPPGPPGARGQAGVMGFPGPKGAAGEPGKAGERGVPGPPGAVGAAGKDGEAGAQGPPGPAGPAGERGEQGPAGSPGFQGLPGPAGPPGEAGKPGEQGVPGDLGAPGPSGARGERGFPGERGVQGPPGPAGPRGSNGAPGNDGAKGDAGAPGAPGSQGAPGLQGMPGERGAAGLPGPKGDRGDAGPKGADGSPGKDGPRGLTGPIGPPGPAGAPGDKGEAGPSGPAGPTGARGAPGDRGEPGPPGPAGFAGPPGADGQPGAKGEPGDAGAKGDAGPPGPAGPTGAPGPIGNVGAPGAKGARGSAGPPGATGFPGAAGRVGPPGPSGNAGPPGPPGPAGKEGGKGPRGETGPAGRPGEVGPPGPPGPAGEKGSPGADGPAGAPGTPGPQGIGGQRGVVGLPGQRGERGFPGLPGPSGEPGKQGPSGSSGERGPPGPAGPPGLAGPPGESGREGAPGAEGSPGRDGSPGPKGDRGETGPSGPPGAPGAPGAPGPVGPAGKSGDRGETGPAGPAGPAGPAGVRGPAGPQGPRGDKGETGEQGDRGLKGHRGFSGLQGPPGPPGSPGEQGPSGASGPAGPRGPPGSAGAPGKDGLNGLPGPPGPPGPRGRTGDAGPVGPPGPPGPPGPPGPPSGAFDFSFLPQPPQEKAHDGGRYYRA

SEQ ID NO: 74 - DNA, 3309 bp, Artificial Sequence
  source: /note=“Description of Artificial Sequence Synthetic polynucleotide”
atgaaaaagatttggctggcgctggctggtttagttttagcgtttagcgcatcggcggcgcagtatgaagatcaccatcaccaccaccaccatcaccactctggctcgagcctggtgccgcgcggcagccatatgcagctgagctatggttatgatgaaaaaagcgccggtggtattagcgtcccgggccctatgggcccgagcgggccgcggggtctgccgggtcctcccggagcccctgggcctcagggttttcaggggccaccgggagaacctggcgaacccggggcaagcggtcctatgggtccacgtggtccgccggggcctccggggaaaaatggtgacgatggtgaagctggtaaacctggccgtccaggggaacgggggccgcctggaccgcagggagcgcgcggtttaccgggtaccgcaggtttgccgggtatgaaaggccatcgtggttttagcggtctggatggtgcaaaaggtgacgctgggccagccgggccaaaaggcgagccggggtcaccgggggagaatggagctccaggccagatgggtcctcggggtttacctggtgaacgtggtagaccgggagcaccaggtccggcgggcgcacgtggtaacgatggcgcaaccggtgccgctggtccccccggtcctacaggccctgcgggcccaccaggttttcctggtgccgttggcgcgaaaggcgaagcaggtccgcaaggtgcacgcggtagcgaagggccgcagggtgttcgcggcgagcctgggcccccaggtcctgctggcgcggcgggtcctgccggtaatcctggcgccgatggtcagccgggtgctaaaggagcaaatggcgcccccggtattgcaggagcaccgggctttccaggggcaaggggtccggctggtcctcaaggtcctagtggtgcacctgggcctaaaggtaatagcggtgaaccgggtgcaccgggtagtaaaggcgatgccggtgcgaaaggtgaaccagggcctattggtattcagggccctcctgggcctgctggtgaagaaggtaaacgtggcgcaagaggggaaccgggacctaccggtcttccgggtccgcctggggaacgtggaggtccgggtagccgtggctttcctggagcagatggtgtagcggggccgaaaggcccagccggagaaagaggtagcccgggtcccgctggaccgaaaggtagtccgggtgaggcaggccgtccgggggaagcaggactgccaggcgctaaaggcttaaccggcagcccggggagccctggcccggatggtaaaacgggaccgccgggaccggcaggtcaggatggtcgccctggtccaccaggccctccgggagcccgcggtcaggcaggcgttatgggttttccgggaccaaaaggggcagcaggcgaaccgggcaaagccggcgaacggggcgttccaggaccgcctggtgcagttggtgccgcaggcaaagatggagaagccggagcacaaggacctcccggaccggcggggcctgccggtgagcgcggtgagcagggtccagctgggagtccgggatttcagggacttccgggcccagcaggtcccccgggtgaagcgggtaaaccaggtgaacagggcgtgccgggtgatctgggcgcacctggcccaagcggtgcacggggtgagcgtggtttcccgggcgagcggggtgttcagggtcccccagggccagctggtccgcgtggcagcaacggtgcgcctggtaatgatggcgccaaaggtgatgcaggggccccgggagctccgggttcacagggtgcgccgggtctgcagggtatgccgggagagcgcggcgcagcaggtctgcctggtccgaagggtgatcgtggcgatgcaggtccgaaaggagccgacggttctccgggtaaagatggcccgcgtggactgaccggcccgataggtccgccagggccggctggagcgccgggggataaaggagaagcgggccccagcggccctgctggcccgactggtgcacgtggagcacctggagatcgtggagaaccaggaccacccgggccggcgggttttgcgggacctccgggtgccgatggccagcctggggccaaaggagaacccggtgatgcgggtgccaaaggcgacgcaggcccgcccggacccgctggccctaccggggcgccgggcccgattggtaatgttggcgcaccaggagctaaaggtgcccgtggtagcgccggaccacctggggcaacaggctttccgggcgctgctggtcgtgttggcccacccggtccgagcggtaacgcgggtcctccaggtcctcctggccccgcaggtaaagaaggtggtaaaggaccgcgtggtgagacgggccctgcaggtcgtcctggagaagttggccctcccggcccaccggggccggccggtgaaaaaggttccccgggggcagacggcccggcaggggcacctggtaccccaggcccacagggcattggtggtcagcgtggtgttgttggccttccggggcagcgtggcgaacgcggttttccaggtcttcctggtcccagtggtgagcctggcaaacaaggtccgagtggtagcagcggagaacgtgggccacctggtcctgcgggtcctccgggcttagctgggccgccaggagaaagcggtcgtgaaggcgccccaggagcagaagggagtcctggtcgggatggtagcccaggacctaaaggggatcgcggtgaaaccggtccgtctggcccgccgggcgcccctggcgcgccgggagcgccaggtccagttggtccggcaggtaaaagcggcgatcgtggtgaaactgggccggcaggtccagccggtcctgcaggcccggccggcgttcgtggtcccgcggggccacagggtccgcggggagataaaggtgagacaggagaacagggtgatagaggtctgaaaggtcatagaggttttagtggtctgcaaggtccaccgggccccccaggcagtccaggcgaacagggaccgtctggtgcaagtggaccggccggaccgcgcggccctccaggcagcgcgggggctccagggaaagatggtctgaatggtctgcccggtccgcccggcccgcctggccctcgtggtcgtacgggtgatgctggaccagttggaccgccaggcccccctggaccaccgggtccacctggacccccgtcaggtgcatttgattttagctttctgccgcagccgccgcaggaaaaagcacatgatggtggtcgctattatcgtgcataa

SEQ ID NO: 75 - protein, 30 aa, Artificial Sequence
  source: /note=“Description of Artificial Sequence Synthetic His tag”
  SITE (1)..(30): This sequence may encompass 2-30 residues
HHHHHHHHHHHHHHHHHHHHHHHHHHHHHH

SEQ ID NO: 76 - protein, 20 aa, Artificial Sequence
  source: /note=“Description of Artificial Sequence Synthetic His tag”
  SITE (1)..(20): /note=“This sequence may encompass 2-20 residues”
HHHHHHHHHHHHHHHHHHHH

SEQ ID NO: 77 - protein, 15 aa, Artificial Sequence
  source: /note=“Description of Artificial Sequence Synthetic His tag”
  SITE (1)..(15): /note=“This sequence may encompass 5-15 residues”
HHHHHHHHHHHHHHH

SEQ ID NO: 78 - protein, 18 aa, Artificial Sequence
  source: /note=“Description of Artificial Sequence Synthetic His tag”
  SITE (1)..(18): /note=“This sequence may encompass 5-18 residues”
HHHHHHHHHHHHHHHHHH

SEQ ID NO: 79 - protein, 16 aa, Artificial Sequence
  source: /note=“Description of Artificial Sequence Synthetic His tag”
  SITE (1)..(16): /note=“This sequence may encompass 5-16 residues”
HHHHHHHHHHHHHHHH

SEQ ID NO: 80 - protein, 14 aa, Artificial Sequence
  source: /note=“Description of Artificial Sequence Synthetic His tag”
  SITE (1)..(14): /note=“This sequence may encompass 5-14 residues”
HHHHHHHHHHHHHH

SEQ ID NO: 81 - protein, 13 aa, Artificial Sequence
  source: /note=“Description of Artificial Sequence Synthetic His tag”
  SITE (1)..(13): /note=“This sequence may encompass 5-13 residues”
HHHHHHHHHHHHH

SEQ ID NO: 82 - protein, 12 aa, Artificial Sequence
  source: /note=“Description of Artificial Sequence Synthetic His tag”
  SITE (1)..(12): /note=“This sequence may encompass 5-12 residues”
HHHHHHHHHHHH

SEQ ID NO: 83 - protein, 11 aa, Artificial Sequence
  source: /note=“Description of Artificial Sequence Synthetic His tag”
  SITE (1)..(11): /note=“This sequence may encompass 5-11 residues”
HHHHHHHHHHH

SEQ ID NO: 84 - protein, 10 aa, Artificial Sequence
  source: /note=“Description of Artificial Sequence Synthetic His tag”
  SITE (1)..(10): /note=“This sequence may encompass 5-10 residues”
HHHHHHHHHH

SEQ ID NO: 85 - protein, 12 aa, Artificial Sequence
  source: /note=“Description of Artificial Sequence Synthetic His tag”
  SITE (1)..(12): /note=“This sequence may encompass 6-12 residues”
HHHHHHHHHHHH

SEQ ID NO: 86 - protein, 11 aa, Artificial Sequence
  source: /note=“Description of Artificial Sequence Synthetic His tag”
  SITE (1)..(11): /note=“This sequence may encompass 6-11 residues”
HHHHHHHHHHH

SEQ ID NO: 87 - protein, 10 aa, Artificial Sequence
  source: /note=“Description of Artificial Sequence Synthetic His tag”
  SITE (1)..(10): /note=“This sequence may encompass 7-10 residues”
HHHHHHHHHH

SEQ ID NO: 88 - protein, 150 aa, Artificial Sequence
  source: /note=“Description of Artificial Sequence Synthetic polypeptide”
  SITE (1)..(150): /note=“This sequence may encompass 2-50 ′Gly Glu Lys′ repeating units”
GEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEK

SEQ ID NO: 89 - protein, 150 aa, Artificial Sequence
  source: /note=“Description of Artificial Sequence Synthetic polypeptide”
  SITE (1)..(150): /note=“This sequence may encompass 2-50 ′Gly Asp Lys′ repeating units”
GDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDK

SEQ ID NO: 90 - protein, 120 aa, Artificial Sequence
  source: /note=“Description of Artificial Sequence Synthetic polypeptide”
  SITE (1)..(120): /note=“This sequence may encompass 2-40 ′Gly Glu Lys′ repeating units”
GEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEKGEK

SEQ ID NO: 91 - protein, 120 aa, Artificial Sequence
  source: /note=“Description of Artificial Sequence Synthetic polypeptide”
  SITE (1)..(120): /note=“This sequence may encompass 2-40 ′Gly Asp Lys′ repeating units”
GDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDKGDK

SEQ ID NO: 92 - protein, 90 aa, Artificial Sequence
  source: /note=“Description of Artificial Sequence Synthetic polypeptide”
  SITE (1)..(90): /note=“This sequence may encompass 2-30 ′Gly Glu Lys′ repeating units”
GEKGEKGEKGEKGEKGEKGEKGEKGEKGEKGEKGEKGEKGEKGEKGEKGEKGEKGEKGEKGEKGEKGEKGEKGEKGEKGEKGEKGEKGEK

SEQ ID NO: 93 - protein, 90 aa, Artificial Sequence
  source: /note=“Description of Artificial Sequence Synthetic polypeptide”
  SITE (1)..(90): /note=“This sequence may encompass 2-30 ′Gly Asp Lys′ repeating units”
GDKGDKGDKGDKGDKGDKGDKGDKGDKGDKGDKGDKGDKGDKGDKGDKGDKGDKGDKGDKGDKGDKGDKGDKGDKGDKGDKGDKGDKGDK

SEQ ID NO: 94 - protein, 60 aa, Artificial Sequence
  source: /note=“Description of Artificial Sequence Synthetic polypeptide”
  SITE (1)..(60): /note=“This sequence may encompass 2-20 ′Gly Glu Lys′ repeating units”
GEKGEKGEKGEKGEKGEKGEKGEKGEKGEKGEKGEKGEKGEKGEKGEKGEKGEKGEKGEK

SEQ ID NO: 95 - protein, 60 aa, Artificial Sequence
  source: /note=“Description of Artificial Sequence Synthetic polypeptide”
  SITE (1)..(60): /note=“This sequence may encompass 2-20 ′Gly Asp Lys′ repeating units”
GDKGDKGDKGDKGDKGDKGDKGDKGDKGDKGDKGDKGDKGDKGDKGDKGDKGDKGDKGDK

SEQ ID NO: 96 - protein, 45 aa, Artificial Sequence
  source: /note=“Description of Artificial Sequence Synthetic polypeptide”
  SITE (1)..(45): /note=“This sequence may encompass 2-15 ′Gly Glu Lys′ repeating units”
GEKGEKGEKGEKGEKGEKGEKGEKGEKGEKGEKGEKGEKGEKGEK

SEQ ID NO: 97 - protein, 45 aa, Artificial Sequence
  source: /note=“Description of Artificial Sequence Synthetic polypeptide”
  SITE (1)..(45): /note=“This sequence may encompass 2-15 ′Gly Asp Lys′ repeating units”
GDKGDKGDKGDKGDKGDKGDKGDKGDKGDKGDKGDKGDKGDKGDK

SEQ ID NO: 98 - protein, 30 aa, Artificial Sequence
  source: /note=“Description of Artificial Sequence Synthetic polypeptide”
  SITE (1)..(30): /note=“This sequence may encompass 2-10 ′Gly Glu Lys′ repeating units”
GEKGEKGEKGEKGEKGEKGEKGEKGEKGEK

SEQ ID NO: 99 - protein, 30 aa, Artificial Sequence
  source: /note=“Description of Artificial Sequence Synthetic polypeptide”
  SITE (1)..(30): /note=“This sequence may encompass 2-10 ′Gly Asp Lys′ repeating units”
GDKGDKGDKGDKGDKGDKGDKGDKGDKGDK

SEQ ID NO: 100 - protein, 27 aa, Artificial Sequence
  source: /note=“Description of Artificial Sequence Synthetic peptide”
  SITE (1)..(27): /note=“This sequence may encompass 2-9 ′Gly Glu Lys′ repeating units”
GEKGEKGEKGEKGEKGEKGEKGEKGEK

SEQ ID NO: 101 - protein, 27 aa, Artificial Sequence
  source: /note=“Description of Artificial Sequence Synthetic peptide”
  SITE (1)..(27): /note=“This sequence may encompass 2-9 ′Gly Asp Lys′ repeating units”
GDKGDKGDKGDKGDKGDKGDKGDKGDK

SEQ ID NO: 102 - protein, 24 aa, Artificial Sequence
  source: /note=“Description of Artificial Sequence Synthetic peptide”
  SITE (1)..(24): /note=“This sequence may encompass 2-8 ′Gly Glu Lys′ repeating units”
GEKGEKGEKGEKGEKGEKGEKGEK

SEQ ID NO: 103 - protein, 24 aa, Artificial Sequence
  source: /note=“Description of Artificial Sequence Synthetic peptide”
  SITE (1)..(24): /note=“This sequence may encompass 2-8 ′Gly Asp Lys′ repeating units”
GDKGDKGDKGDKGDKGDKGDKGDK

SEQ ID NO: 104 - protein, 21 aa, Artificial Sequence
  source: /note=“Description of Artificial Sequence Synthetic peptide”
  SITE (1)..(21): /note=“This sequence may encompass 2-7 ′Gly Glu Lys′ repeating units”
GEKGEKGEKGEKGEKGEKGEK

SEQ ID NO: 105 - protein, 21 aa, Artificial Sequence
  source: /note=“Description of Artificial Sequence Synthetic peptide”
  SITE (1)..(21): /note=“This sequence may encompass 2-7 ′Gly Asp Lys′ repeating units”
GDKGDKGDKGDKGDKGDKGDK

SEQ ID NO: 106 - protein, 18 aa, Artificial Sequence
  source: /note=“Description of Artificial Sequence Synthetic peptide”
  SITE (1)..(18): /note=“This sequence may encompass 2-6 ′Gly Glu Lys′ repeating units”
GEKGEKGEKGEKGEKGEK

SEQ ID NO: 107 - protein, 18 aa, Artificial Sequence
  source: /note=“Description of Artificial Sequence Synthetic peptide”
  SITE (1)..(18): /note=“This sequence may encompass 2-6 ′Gly Asp Lys′ repeating units”
GDKGDKGDKGDKGDKGDK

SEQ ID NO: 108 - protein, 15 aa, Artificial Sequence
  source: /note=“Description of Artificial Sequence Synthetic peptide”
  SITE (1)..(15): /note=“This sequence may encompass 2-5 ′Gly Glu Lys′ repeating units”
GEKGEKGEKGEKGEK

SEQ ID NO: 109 - protein, 15 aa, Artificial Sequence
  source: /note=“Description of Artificial Sequence Synthetic peptide”
  SITE (1)..(15): /note=“This sequence may encompass 2-5 ′Gly Asp Lys′ repeating units”
GDKGDKGDKGDKGDK

SEQ ID NO: 110 - protein, 12 aa, Artificial Sequence
  source: /note=“Description of Artificial Sequence Synthetic peptide”
  SITE (1)..(12): /note=“This sequence may encompass 2-4 ′Gly Glu Lys′ repeating units”
GEKGEKGEKGEK

SEQ ID NO: 111 - protein, 12 aa, Artificial Sequence
  source: /note=“Description of Artificial Sequence Synthetic peptide”
  SITE (1)..(12): /note=“This sequence may encompass 2-4 ′Gly Asp Lys′ repeating units”
GDKGDKGDKGDK

SEQ ID NO: 112 - protein, 9 aa, Artificial Sequence
  source: /note=“Description of Artificial Sequence Synthetic His tag”
HHHHHHHHH

(19) United States
(12) Patent Application Publication
(10) Pub. No.: US 2020/0392668 A1
(43) Pub. Date: Dec. 17, 2020

(54) TEXTILE COMPRISING SILANIZED SYMBIOTIC CULTURE OF BACTERIA AND YEAST

(71) Applicant: Geltor, Inc., San Leandro, CA (US)

(72) Inventors: Nikolay Ouzounov, San Ramon, CA (US); Anthony Achacoso, Union City, CA (US)

(21) Appl. No.: 15/930,697

(22) Filed: May 13, 2020

Related U.S. Application Data
(63) Continuation of application No. PCT/US2018/061111, filed on Nov. 14, 2018.
(60) Provisional application No. 62/586,785, filed on Nov. 15, 2017.

(51) Int. Cl. D06M 16/00; D06N 3/00; D06N 3/02

(52) U.S. Cl. CPC D06M 16/003; D06N 3/0061; D06N 3/0063; B82Y 30/00; D06N 2211/28; D06N 2203/026; D06N 3/02

(57) ABSTRACT

The disclosure provides flexible, hydrophobic textiles, methods of producing the textiles and uses of the textiles. The flexible, hydrophobic textiles feel and behave like leather. The textiles are prepared from a symbiotic culture of bacteria and yeast and are reacted with silica sol.

### CROSS-REFERENCE

This application is a continuation application of International Application No. PCT/US2018/061111, filed Nov. 14, 2018, which claims the benefit of U.S. Provisional Application No. 62/586,785, filed Nov. 15, 2017, each of which is incorporated herein by reference in its entirety.

### SEQUENCE LISTING

The instant application contains a Sequence Listing which has been submitted electronically in ASCII format and is hereby incorporated by reference in its entirety. Said ASCII copy, created on Dec. 21, 2018, is named 57607 704 301 SL.txt and is 254,648 bytes in size.

### FIELD

The present disclosure relates to a flexible, hydrophobic textile comprising silanized symbiotic culture of bacteria and yeast. Methods of producing the textile are also disclosed.

### BACKGROUND

Leather is a textile prepared from the hides of animals. Leather is used in many applications including clothing, shoes, luggage, furniture, sports equipment, automotive upholstery and many other uses. The use of the skins of animals creates significant environmental issues, not the least of which is the environmental impact of raising the animals. Additionally, the tanning of animal skins into leather requires the use of significant amounts of toxic chemicals including chromium salts.

The development of synthetic, non-animal leather has long been a goal of the textile industry. For example, in WO2016/0734453 and WO2017/053433 synthetic leathers are described in which collagen producing cells are cultivated on a scaffold. After cultivation, the scaffold comprising the collagen producing cells is then further processed to prepare the synthetic leather. The silanization of cotton to prepare hydrophobic material is known in the art. See for example, Shang, et al., Appl. Surf. Sci., 2010, 257, 1495-14599. The silanization of cotton can produce hydrophobic material, however silanized cotton does not look, feel or behave like leather. Therefore, the currently available non-animal derived synthetic leather products are inadequate to meet the long-felt need. In addition, synthetic, non-animal leather can be expensive. There is thus a need for non-animal textiles that look, feel and behave like leather.

### SUMMARY

In an embodiment, the invention provides a flexible, hydrophobic textile comprising a symbiotic culture of bacteria and yeast (SCOBY) and silica sol, wherein hydroxyl moieties present in the SCOBY are silanized.

In another embodiment, the invention provides a flexible, hydrophobic textile comprising SCOBY and silica sol, wherein hydroxyl moieties present in the SCOBY are covalently bonded to the silica sol or a silicon alkoxide.

In one embodiment, the flexible, hydrophobic textile has a grain that resembles leather and does not show a regular, or repeating pattern. The invention also provides a flexible, hydrophobic textile that looks, feels and/or behaves like leather.

Another embodiment of the invention provides a flexible, hydrophobic textile comprising SCOBY, silica sol and optionally collagen or elastin. In one embodiment, the collagen or elastin is selected from the group consisting of recombinant jellyfish collagen, recombinant jellyfish elastin, recombinant mastodon collagen and recombinant mastodon elastin. In yet another embodiment, hydroxyl moieties present in the collagen or elastin covalently bond to the silica sol or a silicon alkoxide.

In one embodiment, the flexible, hydrophobic textile can further comprise a polyglycol. Yet another embodiment of the invention provides a silica sol that comprises the reaction product of water glass and silicon alkoxide. In one embodiment, the silicon alkoxide is is selected from the group consisting of tetramethoxysilane (TMOS), tetraethoxysilane (TEOS), tetrapropoxysilane (TPOS), tetraisopropoxysilane (TiPOS), 3-glycidyloxypropyltrimethoxysilane (GPTMS) and n-octadecyltriethoxysilane (ODTES).

One embodiment of the invention provides a flexible, hydrophobic textile comprising SCOBY and silica sol, wherein the SCOBY comprises cellulose producing bacteria. The cellulose producing bacteria is a genus selected from the group consisting of Acetobacter, Allobaculum, Bacillus, Bifidobacterium, Enterococcus, Gluconacetobacter, Lactobaccilus, Lactococcus, Leuconostoc, Ruminancoccaceae Incertae Sedis, Pediococcus, Propionibacterium, Streptococcus, and Thermus. In an embodiment, the bacteria is of the genus Acetobacter. In one embodiment, the bacteria is selected from the group consisting of Acetobacter aceti, Acetobacter febarum, Acetobacter orientalis, Acetobacter pasteurianus, Acetobacter xylinum, and Acetobacter xylinoides. In another embodiment, the bacteria is selected from the group consisting of Bacillus subtilis, Bacillus graveolus, Lactobacillus acidophilus, Lactobacillus alactosus, Lactobacillus brevis, Lactobacillus bulgaricus, Lactobacillus casei, Lactobacillus coryneformis, Lactobacillus fructosus, Lactobacillus hilgardii, Lactobacillus homoiochi, Lactobacillus hordei, Lactobacillus nagelii, Lactobacillus planatarum, Lactobacillus pseudoplanatarum, Lactobacillus reuterietc, Lactobacillus yamashiensis Leuconostoc citreum, Leuconontoc mesenteroides, Streptococcus agalactiae, Streptococcus bovis, Streptococcus cremeris, Streptococcus faecalis, Streptococcus lactis, Streptococcusmutans, Streptococcus pneumoniae, Streptococcus pyogenes, Streptococcus salivaruis, Streptococcus sanguinis, Streptococcus suris, Streptococcus viridans, pediococcus damnosus. In one embodiment of the invention the bacteria produce nanocellulose.

One embodiment of the invention provides a flexible, hydrophobic textile comprising SCOBY and silica sol, wherein the SCOBY comprises yeast. The yeast is preferably a genus selected from the group consisting of Candida, Davidiella, Dekerra, Hansenula, Hanseniaospora, Kazachstania, Kloeckera, kluyveromyces, Lachanacea, Leucosporidiella, Meyerozyma, Naumovozyma, Picchia, Saccharomyces, Wallemia, and Zygosacchromyces. In an embodiment the yeast is of the genus Zygosaccharomyces. In one embodiment, the yeast is Candida gueretana, Candida lamica, Candida valida, Hansenula yalbensis, Kloeckera spiculata, Saccharomyces bayanus, Saccharomyces boullardii, Saccharomyces cerevisiae, Saccharomyces florentinus, Saccharomyces pretoriensis, and Saccharomyces uvarum.

The flexible, hydrophobic textile of the invention in one embodiment has a moisture content of between 0.1% and 10% by dry weight.

In one embodiment, the invention provides flexible, hydrophobic textile comprising symbiotic culture of bacteria and yeast (SCOBY) and silica sol, the textile can be prepared by a process comprising: optionally drying the SCOBY to prepare a dried SCOBY sheet; exposing the SCOBY or the dried SCOBY sheet to a silica sol to prepare a SCOBY/silica sol matrix, the silica sol can be prepared from water glass and a first silicon alkoxide; heat treating dried SCOBY/silica sol matrix to prepare a dried, silanized SCOBY pad; applying a second silicon alkoxide to the dried, silanized SCOBY pad to prepare an uncured textile; and curing the uncured textile by exposure to heat to prepare the flexible, hydrophobic textile.

The process steps described in this application can be performed in the order described herein. In some cases, certain steps are not performed. In some cases, the order of the steps can be altered and in other cases, new steps can be added to or interspersed between the depicted steps.

In an embodiment, the flexible, hydrophobic textile of the invention is prepared by a process wherein the SCOBY is incubated in an aqueous solution comprising polyglycol. In one embodiment, the SCOBY incubated in the polyglycol solution is dried to prepare the dried SCOBY sheet. In another embodiment, the SCOBY without incubation in polyglycol is dried to prepare the dried SCOBY sheet.

In another embodiment, the flexible, hydrophobic textile comprising SCOBY and silica sol prepared by a process, wherein hydroxyl moieties present in the SCOBY are covalently bonded to the silica sol.

Another embodiment of the invention provides a flexible, hydrophobic textile comprising SCOBY, silica sol and optionally collagen or elastin prepared by a process disclosed herein. In one embodiment, the collagen or elastin is selected from the group consisting of recombinant jellyfish collagen, recombinant jellyfish elastin, recombinant mastodon collagen and recombinant mastodon elastin. In yet another embodiment, hydroxyl moieties present in the collagen or elastin are covalently bonded to the silica sol.

In one embodiment, the flexible, hydrophobic textile is prepared by a process wherein the SCOBY is incubated in an aqueous solution comprising polyglycol. The polyglycol is selected from the group consisting of polyacrylamide, polyacrylic acid, polymethacrylate, polyethylene imine, polyethylene glycol, polyethylene oxide, polyoxypropylene, polypropylene glycol, polypropylene oxide, polyoxypropylene, polyvinyl alcohol, and polyvinylpyrrolidone.

In another embodiment, the flexible, hydrophobic textile further comprises one or more plasticizers. Plasticizers include phthalates, terephthalates, trimellitates, adipates, maleates, citrates, and other well-known plasticizers. Additional plasticizers useful in preparing the flexible, hydrophobic textile are selected from the group consisting of polyacrylamide, polyacrylic acid, polymethacrylate, and polyethylene imine,

Another embodiment of the invention provides a flexible, hydrophobic textile comprising SCOBY and silica sol prepared by a process, wherein the first silicon alkoxide and the second silicon alkoxide are the same or different and are selected from the group consisting of tetramethoxysilane (TMOS), tetraethoxysilane (TEOS), tetrapropoxysilane (TPOS), tetraisopropoxysilane (TiPOS), 3-glycidyloxypropyltrimethoxysilane (GPTMS) and n-octadecyltriethoxysilane (ODTES).

One embodiment of the invention provides a flexible, hydrophobic textile comprising SCOBY and silica sol prepared by a process, wherein the SCOBY comprises cellulose producing bacteria. The cellulose producing bacteria is a genus selected from the group consisting of Acetobacter, Allobaculum, Bacillus, Bifidobacterium, Enterococcus, Gluconacetobacter, Lactobaccilus, Lactococcus, Leuconostoc, Ruminancoccaceae Incertae Sedis, Pediococcus, Propionibacterium, Streptococcus, and Thermus. In an embodiment, the bacteria is of the genus Acetobacter. In one embodiment, the bacteria is Acetobacter aceti, Acetobacter febarum, Acetobacter orientalis, Acetobacter pasteurianus, Acetobacter xylinum, and Acetobacter xylinoides. In one embodiment of the invention the bacteria produce nanocellulose.

One embodiment of the invention provides a flexible, hydrophobic textile comprising SCOBY and silica sol prepared by a process disclosed herein, wherein the SCOBY comprises yeast. The yeast is a genus selected from the group consisting of Candida, Davidiella, Dekerra, Hansenula, Hanseniaospora, Kazachstania, Kloeckera, kluyveromyces, Lachanacea, Leucosporidiella, Meyerozyma, Naumovozyma, Picchia, Saccharomyces, Wallemia, and Zygosacchromyces. In one embodiment the yeast is of the genus Zygosaccharomyces. In one embodiment, the yeast is Candida gueretana, Candida lamica, Candida valida, Hansenula yalbensis, Kloeckera spiculata, Saccharomyces bayanus, Saccharomyces boullardii, Saccharomyces cerevisiae, Saccharomyces florentinus, Saccharomyces pretoriensis, and Saccharomyces uvarum.

In another embodiment, a flexible, hydrophobic textile prepared by a process, wherein the hydroxyl moieties present in the SCOBY, polyglycol, collagen, or elastin are covalently linked to the silica sol or the silicon alkoxide is provided.

Yet another embodiment provides a flexible, hydrophobic textile prepared by a process that prepares a dried SCOBY sheet, wherein the dried SCOBY sheet has a moisture content of between 1% and 10%.

In another embodiment, the invention provides a flexible, hydrophobic textile prepared by a process that prepares a dried, silanized SCOBY pad, wherein the dried SCOBY sheet has a moisture content of between 1% and 10%.

The flexible, hydrophobic textile of the invention prepared by a process disclosed herein in one embodiment has a moisture content of between 0.1% and 10%.

In one embodiment, the invention provides a method of producing a flexible, hydrophobic textile comprising SCOBY and silica sol, the method comprising optionally drying the SCOBY to prepare a dried SCOBY sheet; exposing the SCOBY or the dried SCOBY sheet to a silica sol to prepare a SCOBY/silica sol matrix, the silica sol prepared from water glass and a first silicon alkoxide; heat treating dried SCOBY/silica sol matrix to prepare a dried, silanized SCOBY pad; applying a second silicon alkoxide to the dried, silanized SCOBY pad to prepare an uncured textile; and curing the uncured textile by exposure to heat to prepare the flexible, hydrophobic textile.

In an embodiment, the method of producing the flexible, hydrophobic textile comprises incubating the SCOBY in an aqueous solution comprising polyglycol. In one embodiment, the aqueous polyglycol solution comprises between 5% and 95% polyglycol. The polyglycol is selected from the group consisting of polyethylene glycol, polyethylene oxide, polyoxypropylene, polypropylene glycol, polypropylene oxide, polyoxypropylene, polyvinyl alcohol, and polyvinylpyrrolidone.

In another embodiment, the method of producing the flexible, hydrophobic textile further comprises the addition of one or more plasticizers. Plasticizers include phthalates, terephthalates, trimellitates, adipates, maleates, citrates, and other well-known plasticizers. Additional plasticizers useful in the methods of preparing the flexible, hydrophobic textile are selected from the group consisting of polyacrylamide, polyacrylic acid, polymethacrylate, and polyethylene imine.

The method of producing a flexible, hydrophobic textile can further comprise collagen or elastin. In one embodiment, the collagen or elastin is a collagen selected from the group consisting of recombinant jellyfish collagen, recombinant jellyfish elastin, recombinant mastodon collagen and recombinant mastodon elastin. In yet another embodiment, hydroxyl moieties present in the collagen or elastin are covalently bonded to the silica sol.

In one embodiment, the SCOBY comprises cellulose producing bacteria. The cellulose producing bacteria is a genus selected from the group consisting of Acetobacter, Allobaculum, Bifidobacterium, Gluconacetobacter, Lactobaccilus, Lactococcus, Leuconostoc, Thermus, Ruminancoccaceae Incertae Sedis, Propionibacterium, and Streptococcus. In an embodiment, the bacteria is of the genus Acetobacter. In one embodiment, the bacteria is selected from the group consisting of Bacillus subtilis, Bacillus graveolus, Lactobacillus acidophilus, Lactobacillus alactosus, Lactobacillus brevis, Lactobacillus bulgaricus, Lactobacillus casei, Lactobacillus coryneformis, Lactobacillus fructosus, Lactobacillus hilgardii, Lactobacillus homoiochi, Lactobacillus hordei, Lactobacillus nagelii, Lactobacillus planatarum, Lactobacillus pseudoplanatarum, Lactobacillus reuterietc, Lactobacillus yamashiensis Leuconostoc citreum, Leuconontoc mesenteroides, Streptococcus agalactiae, Streptococcus bovis, Streptococcus cremeris, Streptococcus faecalis, Streptococcus lactis, Streptococcusmutans, Streptococcus pneumoniae, Streptococcus pyogenes, Streptococcus salivaruis, Streptococcus sanguinis, Streptococcus suris, Streptococcus viridans, pediococcus damnosus. In yet another embodiment, the bacteria of the invention produce nanocellulose.

Yet another embodiment of the method of producing a flexible, hydrophobic textile, provides a SCOBY that comprises yeast. The yeast in an embodiment is a genus selected from the group consisting of Candida, Davidiella, Dekerra, Hansenula, Hanseniaospora, Kazachstania, Kloeckera, kluyveromyces, Lachanacea, Leucosporidiella, Meyerozyma, Naumovozyma, Picchia, Saccharomyces, Wallemia, and Zygosacchromyces. In an embodiment, the yeast is of the genus Zygosaccharomyces. In one embodiment, the yeast is Candida gueretana, Candida lamica, Candida valida, Hansenula yalbensis, Kloeckera spiculata, Saccharomyces bayanus, Saccharomyces boullardii, Saccharomyces cerevisiae, Saccharomyces florentinus, Saccharomyces pretoriensis, and Saccharomyces uvarum.

On embodiment of the invention provides a method wherein the SCOBY is incubated in an aqueous solution comprising polyglycol prior to the preparation of the dried SCOBY sheet. The aqueous polyglycol solution comprises between 5% and 95% polyglycol by volume or weight. The polyglycol of the invention is selected from the group consisting of polyethylene glycol, polyethylene oxide, polyoxypropylene, polypropylene glycol, polypropylene oxide, polyoxypropylene, polyvinyl alcohol, and polyvinylpyrrolidone.

In another embodiment, a plasticizer is added to the SCOBY. The plasticizer includes phthalates, terephthalates, trimellitates, adipates, maleates, citrates, polyacrylamide, polyacrylic acid, polymethacrylate, or polyethylene imine. The plasticizer can be added to the aqueous solution comprising polyglycol. Alternatively, the plasticizer can be added to the SCOBY before or after the step incubating the SCOBY in the aqueous polyglycol solution.

The methods of the invention in an embodiment provides a method of drying the SCOBY, optionally incubated with polyglycol, at a temperature of between 20° C. and 150° C. to prepare the dried SCOBY sheet. In one embodiment, the SCOBY sheet can comprise two or more pieces of SCOBY stacked together. In this embodiment, when a thicker flexible, hydrophobic textile is desired, two or more pieces of SCOBY are stacked and dried to prepare a single SCOBY sheet.

The invention further provides methods of preparing the flexible, hydrophobic textile wherein the textile further comprises collagen or elastin. The collagen or elastin in one embodiment is a recombinant collagen or elastin. In another embodiment, the recombinant collagen or elastin is selected from the group consisting of recombinant jellyfish collagen, recombinant jellyfish elastin, recombinant mastodon collagen, recombinant mastodon elastin, recombinant human collagen, and recombinant human elastin. Natural, or non-recombinant collagen or elastin can be used in preparation of the flexible, hydrophobic textile. Many natural, or non-recombinant collagens are available commercially, including natural collagen from domesticated and non-domesticated animals including cattle, pig, sheep, goat, and fish. Collagens extracted from other animals are also available commercially.

One embodiment of the invention provides methods of preparing flexible, hydrophobic textiles comprising SCOBY and silica sol, wherein the SCOBY comprises cellulose producing bacteria. The cellulose producing bacteria is a genus selected from the group consisting of Acetobacter, Allobaculum, Bacillus, Bifidobacterium, Enterococcus, Gluconacetobacter, Lactobaccilus, Lactococcus, Leuconostoc, Ruminancoccaceae Incertae Sedis, Pediococcus, Propionibacterium, Streptococcus, and Thermus. In an embodiment, the bacteria is of the genus Acetobacter. In one embodiment, the bacteria is selected from the group consisting of Bacillus subtilis, Bacillus graveolus, Lactobacillus acidophilus, Lactobacillus alactosus, Lactobacillus brevis, Lactobacillus bulgaricus, Lactobacillus casei, Lactobacillus coryneformis, Lactobacillus fructosus, Lactobacillus hilgardii, Lactobacillus homoiochi, Lactobacillus hordei, Lactobacillus nagelii, Lactobacillus planatarum, Lactobacillus pseudoplanatarum, Lactobacillus reuterietc, Lactobacillus yamashiensis Leuconostoc citreum, Leuconontoc mesenteroides, Streptococcus agalactiae, Streptococcus bovis, Streptococcus cremeris, Streptococcus faecalis, Streptococcus lactis, Streptococcusmutans, Streptococcus pneumoniae, Streptococcus pyogenes, Streptococcus salivaruis, Streptococcus sanguinis, Streptococcus suris, Streptococcus viridans, pediococcus damnosus. In one embodiment of the invention the bacteria produce nanocellulose.

Another embodiment of the invention provides methods of preparing flexible, hydrophobic textiles comprising SCOBY and silica sol, wherein the SCOBY comprises yeast. The yeast is a genus selected from the group consisting of Candida, Davidiella, Dekerra, Hansenula, Hanseniaospora, Kazachstania, Kloeckera, kluyveromyces, Lachanacea, Leucosporidiella, Meyerozyma, Naumovozyma, Picchia, Saccharomyces, Wallemia, and Zygosacchromyces. In embodiment, the yeast is of the genus Zygosaccharomyces. In one embodiment, the yeast is Candida gueretana, Candida lamica, Candida valida, Hansenula yalbensis, Kloeckera spiculata, Saccharomyces bayanus, Saccharomyces boullardii, Saccharomyces cerevisiae, Saccharomyces florentinus, Saccharomyces pretoriensis, and Saccharomyces uvarum. The invention provides methods of producing a dried SCOBY sheet, wherein the dried SCOBY sheet has a moisture content of between 1% and 10%.

In one embodiment, the invention provides methods of preparing a silica sol. The method comprises admixing water glass, a silicon alkoxide and an acid. In an embodiment, the acid is HCl. Water glass is an aqueous solution of sodium silicate, (Na₂SiO₂)ₙO. Typically, the concentration of (Na₂SiO₂)ₙO at a concentration between 1% and 50% by weight. In the methods of preparing silica sol, the amount of silicon alkoxide admixed with (Na₂SiO₂)ₙO is at a concentration 1% and 50% by weight. The silicon alkoxide is selected from the group consisting of an aminosilane, a glycidoxysilane, or a mercaptosilane. In an embodiment, the silicon alkoxide is selected from the group consisting of 3-aminopropyl-trimethoxysilane (APTMS), 3-aminopropyl-triethoxysilane (APTES), 3-aminopropyl-diethoxy-methylsilane (APDEMS), 3-aminopropyl-dimethyl-ethoxysilane (APDMES), 3-methacryl-oxypropyl-trimethoxysilane (MAPMS), methyl-trimethoxysilane (MTMS), vinyl-trimethoxysilane (VTMS), dimethyl-dimethoxysilane (DMDMS), Trimethoxypropylsilane (TMOPS), hexadecyl-trimethoxysilane (HDTOS), isobutyl-trimethoxysilane (IBTTMOS), triethoxyoctylsilane (TEOOS), trimethoxyoctadecylsilane (TMEOS), tetramethoxysilane (TMOS), tetraethoxysilane (TEOS), n-octadecyltriethoxysilane (ODTES), Triethoxyphenylsilane (TEOPS), tetrapropoxysilane (TPOS), tetraisopropoxysilane (TiPOS), 3-glycidoxypropyl-dimethyl-ethoxysilane (GPMS), 3-glycidyloxypropyl-trimethoxysil ane (GPTMS), 3-mercaptopropyl-trimethoxysilane (MPTMS), and 3-mercaptopropyl-methyl-dimethoxysilane (MPDMS).

The dried SCOBY sheet is exposed to silica sol to prepare a SCOBY/silica sol matrix then heat treated to prepare a dried, silanized SCOBY pad. In one embodiment, the hydroxyl moieties present in the SCOBY are silanized by exposure to silica sol and heat treatment. In one embodiment, the dried, silanized SCOBY pad has a moisture content of between 1% and 10%.

The method comprises in one embodiment, applying a second silicon alkoxide to the dried, silanized SCOBY pad to prepare an uncured textile. The second silicon alkoxide is selected from the group consisting of an aminosilane, a glycidoxysilane, or a mercaptosilane. In an embodiment, the silicon alkoxide is selected from the group consisting of 3-aminopropyl-trimethoxysilane (APTMS), 3-aminopropyl-triethoxysilane (APTES), 3-aminopropyl-diethoxy-methylsilane (APDEMS), 3-aminopropyl-dimethyl-ethoxysilane (APDMES), 3-methacryl-oxypropyl-trimethoxysilane (MAPMS), methyl-trimethoxysilane (MTMS), vinyl-trimethoxysilane (VTMS), dimethyl-dimethoxysilane (DMDMS), Trimethoxypropylsilane (TMOPS), hexadecyl-trimethoxysilane (HDTOS), isobutyl-trimethoxysilane (MTMOS), triethoxyoctylsilane (TEOOS), trimethoxyoctadecylsilane (TMEOS), tetramethoxysilane (TMOS), tetraethoxysilane (TEOS), n-octadecyltriethoxysilane (ODTES), Triethoxyphenylsilane (TEOPS), tetrapropoxysilane (TPOS), tetraisopropoxysilane (TiPOS), 3-glycidoxypropyl-dimethyl-ethoxysilane (GPMS), 3-glycidyloxypropyl-trimethoxysilane (GPTMS), 3-mercaptopropyl-trimethoxysilane (MPTMS), and 3-mercaptopropyl-methyl-dimethoxysilane (MPDMS).

The uncured textile is cured by exposure to heat at a temperature of between 60° C. and 200° C. to prepare the flexible, hydrophobic textile. The methods of the invention produce flexible, hydrophobic textiles wherein the moisture content of the textile is between 0.1% and 10%.

In one embodiment, the methods of the invention produces flexible, hydrophobic textiles wherein the hydroxyl moieties present in the SCOBY, polyglycol, collagen, or elastin are covalently linked to the silica sol or the second silicon alkoxide.

These and other objects and features of the present disclosure will become more fully apparent from the following description and appended claims, or may be learned by the practice of the disclosure as set forth hereinafter.

### BRIEF DESCRIPTION OF THE DRAWINGS

FIG. 1 provides a photograph of a SCOBY prior to incubation in an aqueous PEG 200

### SOLUTION

FIG. 2a provides a photograph of a flexible, hydrophobic textile prepared without PEG 200. FIG. 2b provides a photograph of a flexible, hydrophobic textile prepared with PEG 200

FIG. 3 shows a photograph of a flexible, hydrophobic textile comprising PEG 200 in which water is beading on the surface of the textile. Water was placed on the textile and the textile was lifted at an angle so that the water rolled to the bottom of the textile.

FIG. 4 shows a photograph of a flexible, hydrophobic textile prepared without PEG200 that was bent and restored to the original unbent configuration.

FIG. 5 shows a photograph of a flexible, hydrophobic textile prepared with PEG200 that was bent and restored to the original unbent configuration.

### DETAILED DESCRIPTION

This disclosure describes flexible, hydrophobic textiles comprising SCOBY and silica sol, and optionally polyglycol in which hydroxyl moieties present in the SCOBY and/or the polyglycol are covalently bonded to the silica sol. Methods of preparing the flexible, hydrophobic textiles are provided. The flexible, hydrophobic textiles are useful in any application that uses textiles including leather.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The headings provided herein are not intended to limit the disclosure.

Unless defined otherwise herein, all technical and scientific terms used herein have the same meaning as commonly understood by one of ordinary skill in the art. Various scientific dictionaries that include the terms included herein are well known and available to those in the art. Although any methods and materials similar or equivalent to those described herein find use in the practice or testing of the embodiments disclosed herein, some methods and materials are described.

The terms defined immediately below are more fully described by reference to the specification as a whole. It is to be understood that this disclosure is not limited to the particular methodology, protocols, and reagents described, as these may vary, depending upon the context they are used by those of skill in the art.

As used in this specification and appended claims, the singular forms “a”, “an”, and “the” include plural referents unless the content and context clearly dictates otherwise. Thus, for example, reference to “a device” includes a combination of two or more such devices, and the like. Unless indicated otherwise, an “or” conjunction is intended to be used in its correct sense as a Boolean logical operator, encompassing both the selection of features in the alternative (A or B, where the selection of A is mutually exclusive from B) and the selection of features in conjunction (A or B, where both A and B are selected).

As used herein the term “about” refers to ±10%.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

Collagen is a structural protein in the extracellular space in the various connective tissues in animal bodies. Collagen consists of amino acids wound together to form triple-helices.

The quaternary structure of natural collagen is a triple helix typically composed of three polypeptides. Of the three polypeptides that form natural collagen, two are usually identical and are designated as the alpha chain. The third polypeptide is designated as the beta chain. Thus a typical natural collagen can be designated as AAB, wherein the collagen is composed of two alpha (“A”) strands and one beta (“B”) strand. The term “procollagen” as used herein refers to polypeptides produced by cells that can be processed to naturally occurring collagen.

The term “collagen peptide” or “collagen-like peptide” as used herein refers to a monomeric polypeptide that can associate with one or more collagen or collagen-like polypeptides to form a quaternary structure.

The term “recombinant collagen” as used herein refers to collagen molecules produced by use of recombinant technologies. Recombinant collagens include full length collagens, truncated collagens or other collagen molecules wherein the amino acid sequence is different than a wild-type collagen.

The term “truncated collagen” refers to a monomeric polypeptide that is smaller than a full-length collagen wherein one or more portions of the full-length collagen is not present. Collagen polypeptides are truncated at the C-terminal end, the N-terminal end, or truncated by removal of internal portion(s) of the full-length collagen polypeptide.

The term “truncated elastin” refers to a monomeric polypeptide that is smaller than a full-length elastin wherein one or more portions of the full-length elastin are not present. Elastin polypeptides are truncated at the C-terminal end, the N-terminal end, or truncated by removal of internal portion(s) of the full-length elastin polypeptide.

Gelatin is an irreversibly hydrolyzed form of collagen, wherein the hydrolysis results in the reduction of protein fibrils into smaller peptides, which have broad molecular weight ranges associated with physical and chemical methods of denaturation, based on the process of hydrolysis. Collagen can be treated with acid, base or heat to prepare gelatin. While not wishing to be bound by theory or mechanism, treatment of collagen with acid, base or heat is thought to denature the collagen polypeptides. Aqueous denatured collagen solutions form reversible gels used in foods, cosmetics, pharmaceuticals, industrial products, medical products, laboratory culture growth media, and many other applications.

The term “elastin” as used herein refers to an elastic protein found in connective tissues and other tissues in the animal. Upon stretching or contracting tissue that contains elastin, the tissue returns to its un-stretched or un-contracted state. Elastin

The term “recombinant elastin” as used herein refers to elastin molecules produced by use of recombinant technologies. Recombinant elastins include full length elastins, truncated elastin s or other elastin molecules wherein the amino acid sequence is different than a wild-type elastin.

The term “truncated elastin” refers to a monomeric polypeptide that is smaller than a full-length elastin wherein one or more portions of the full-length elastin is not present. Elastin polypeptides are truncated at the C-terminal end, the N-terminal end, or truncated by removal of internal portion(s) of the full-length elastin polypeptide.

The terms “protein,” “polypeptide” and “peptide” are used interchangeably to denote a polymer of at least two amino acids covalently linked by an amide bond, regardless of length or post-translational modification (e.g., glycosylation, phosphorylation, lipidation, myristilation, ubiquitination, etc.). In some cases, the polymer has at least about 30 amino acid residues, and usually at least about 50 amino acid residues. More typically, they contain at least about 100 amino acid residues. It is not intended that the present invention be limited to amino acid sequences of any specific length. The terms include compositions conventionally considered to be fragments of full-length proteins or peptides. Included within this definition are D- and L-amino acids, and mixtures of D- and L-amino acids. The polypeptides described herein are not restricted to the genetically encoded amino acids. Indeed, in addition to the genetically encoded amino acids, the polypeptides described herein may be made up of, either in whole or in part, naturally-occurring and/or synthetic non-encoded amino acids. In some embodiments, a polypeptide is a portion of the full-length ancestral or parental polypeptide, containing amino acid additions or deletions (e.g., gaps), and/or substitutions as compared to the amino acid sequence of the full-length parental polypeptide, while still retaining functional activity (e.g., catalytic activity).

As used herein, the term “wild-type” or “wildtype” (WT) refers to naturally-occurring organisms, enzymes and/or other proteins (e.g., non-recombinant enzymes). A substrate or ligand that reacts with a wild-type biomolecule is sometimes considered a “native” substrate or ligand.

The term “sequence” is used herein to refer to the order and identity of any biological sequences including but not limited to a whole genome, whole chromosome, chromosome segment, collection of gene sequences for interacting genes, gene, nucleic acid sequence, protein, peptide, polypeptide, polysaccharide, etc. In some contexts, a “sequence” refers to the order and identity of amino acid residues in a protein (i.e., a protein sequence or protein character string) or to the order and identity of nucleotides in a nucleic acid (i.e., a nucleic acid sequence or nucleic acid character string). A sequence may be represented by a character string. A “nucleic acid sequence” refers to the order and identity of the nucleotides comprising a nucleic acid. A “protein sequence” refers to the order and identity of the amino acids comprising a protein or peptide.

The term “expression vector” or “vector” as used herein refers to a nucleic acid assembly that is capable of directing an expression of an exogenous gene. The expression vector may include a promoter which is operably linked to the exogenous gene, restriction endonuclease sites, nucleic acids that encode one or more selection markers, and other nucleic acids useful in the practice of recombinant technologies.

The term “fibroblast” as used herein refers to a cell that synthesizes procollagen and other structural proteins. Fibroblasts are widely distributed in the body and found in skin, connective tissue and other tissues.

The term “fluorescent protein” is a protein that is commonly used in genetic engineering technologies used as a reporter of expression of an exogenous polynucleotide. The protein when exposed to ultraviolet or blue light fluoresces and emits a bright visible light. Proteins that emit green light is green fluorescent protein (GFP) and proteins that emit red light is red fluorescent protein (RFP)

The term “gene” as used herein refers to a polynucleotide that encodes a specific protein, and which may refer to the coding region alone or may include regulatory sequences preceding (5′ non-coding sequences) and following (3′ non-coding sequences) the coding sequence.

The term “histidine tag” is a 2-30 contiguous series of histidine residues (SEQ ID NO: 75) on a recombinant polypeptide.

The term “host cell” is a cell that is engineered to express an introduced exogenous polynucleotide.

The term “lactamase” as used herein refer to enzymes that hydrolyze antibiotics that contain a lactam (cyclic amide) moiety. “Beta-lactamase” or “β-lactamase” are enzymes that hydrolyze antibiotics that contain a β-lactam moiety.

The term “non-naturally occurring” as used herein refers to collagen, gelatin or elastin that is not normally found in nature. The non-naturally occurring collagen is in one embodiment a truncated collagen. The non-naturally occurring elastin is in one embodiment a truncated elastin. Other non-naturally occurring collagen polypeptides or elastin polypeptideds include chimeric collagens and chimeric elastins, respectively. A chimeric collagen is a polypeptide wherein one portion of a collagen polypeptide is contiguous with a portion of a second collagen polypeptide. A chimeric elastin is a polypeptide wherein one portion of an elastin polypeptide is contiguous with a portion of a second elastin polypeptide. For example, a collagen molecule comprising a portion of a jellyfish collagen contiguous with a portion of a Tilapia collagen is a chimeric collagen. In another embodiment, the non-naturally occurring collagen comprises a fusion polypeptide that includes additional amino acids such as a secretion tag, histidine tag, green fluorescent protein, protease cleavage site, GEK repeats, GDK repeats, and/or beta-lactamase. In yet another embodiment, the non-naturally occurring elastin comprises a fusion polypeptide that includes additional amino acids such as a secretion tag, histidine tag, green fluorescent protein, protease cleavage site, GEK repeats, GDK repeats, and/or beta-lactamase.

The term “protease cleavage site” is an amino acid sequence that is cleaved by a specific protease.

The term “secretion tag” or “signal peptide” refers to an amino acid sequence that recruits the host cell's cellular machinery to transport an expressed protein to a particular location or cellular organelle of the host cell.

The term “bacteria” refers to prokaryotic organisms. In one embodiment, the bacteria produce cellulose.

The term “yeast” refers to single-celled eukaryotic organisms that are members of the fungus kingdom.

The term “cellulose” refers to molecules with the formula (C₆H₁₀O₅)_{N}. Cellulose are glucose polymers connected through β-glycosidic linkages. The term “nanocellulose” refers to cellulosic fibrils wherein the length of the fibrils are about 5-20 nm and with width of the fibrils are about 1-10 microns. Compositions comprising nanocellulose are thixotropic and behave as non-Newtonian fluids. For non-Newtonian fluids, viscosity decreases as shear rate increases. Non-Newtonian fluids exhibit pseudo-plastic behavior and become thinner as greater shear forces are applied.

The term “covalently linked” or a “covalent bond” refers to a chemical bond between at least two atoms that share a pair of electrons.

The term “polyglycol” refers to compounds that possess one or more ether linkages that produce glycols when hydrolyzed. Certain polyglycols contain two or more hydroxyl moieties.

The term “silica sol” also known as “colloidal silica” refers to an aerogel prepared from water glass and a silicon alkoxide. Silica sols comprise colloidal silica particles that are polymerizes. Silica sols are often referred to as aerogels.

The term “flexible” refers to a textile that can bend without breaking or cracking when bent at an angle of at least 20 degrees.

The term “hydrophobic” refers to material that does not absorb water or minimally absorbs water.

The term “silicon alkoxide” refers to compounds of the formula Si(OR)₄.

The term “silanized” refers to material in which alkoxysilane molecules are covalently attached to reactive groups on the material. Typically, the reactive groups on the material are hydroxyl moieties

The term “symbiotic culture of bacteria or yeast” or “SCOBY” refers to a syntrophic culture of bacteria and yeast. The SCOBY comprises mixed cultures bacteria and yeast.

The term “natural fabric” refers to a fabric made from natural fibers. Common natural fabrics include cotton, wool, linen, ramie, hemp, burlap, silk, and others.

The term “synthetic fabric” refers to a fabric made from man-made fibers, typically produced from petroleum derived material. Common synthetic fabrics are made of polyacrylonitrile, polyamide, polyaramid, polyester, polypropylene, polylactic acid, and others

The term “textile” refers to a flexible material that can be further processed into articles of commerce.

The term “water glass” refers to an aqueous solution comprising polymeric sodium silicate moieties, (Na₂SiO₂)ₙO. Water glass is available commercially and is typically described with corresponding SiO₂: Na₂O ratios. The SiO₂: Na₂O ratio of water glass is typically between 2:1 and 3.75:1.

The invention provides a flexible, hydrophobic textile comprising a symbiotic culture of bacteria and yeast (SCOBY), and silica sol, wherein hydroxyl moieties present in the SCOBY are silanized. In an embodiment, the invention provides a flexible, hydrophobic textile comprising a symbiotic culture of bacteria and yeast (SCOBY), and silica sol, wherein hydroxyl moieties present in the SCOBY are silanized.

In one embodiment, the flexible, hydrophobic textile of the invention has a grain that resembles leather and does not show a regular, or repeating pattern. The invention also provides a flexible, hydrophobic textile that looks, feels and/or behaves like leather.

The SCOBY is prepared by cultivating bacteria and yeast. In one embodiment the bacteria produces cellulose or nanocellulose.

In one embodiment, the bacteria is a genus selected from the group consisting of Acetobacter, Allobaculum, Bifidobacterium, Gluconacetobacter, Lactobaccilus, Lactosoccus, Leuconostoc, Thermus, Ruminancoccaceae Incertae Sedis, Propionibacterium, and Streptococcus. In an embodiment, the bacteria is of the genus Acetobacter. In one embodiment, the bacteria is Acetobacter aceti, Acetobacter febarum, Acetobacter orientalis, Acetobacter pasteurianus, Acetobacter xylinum, and Acetobacter xylinoides.

The SCOBY further comprises yeast. In an embodiment, the yeast is of the genus selected from the group consisting of Candida, Davidiella, Dekerra, Hansenula, Hanseniaospora, Kazachstania, Kloeckera, kluyveromyces, Lachanacea, Leucosporidiella, Meyerozyma, Naumovozyma, Picchia, Saccharomyces, Wallemia, and Zygosacchromyces. In an embodiment, the yeast is of the genus Zygosaccharomyces. In one embodiment, the yeast is Candida gueretana, Candida lamica, Candida valida, Hansenula yalbensis, Kloeckera spiculata, Saccharomyces bayanus, Saccharomyces boullardii, Saccharomyces cerevisiae, Saccharomyces florentinus, Saccharomyces pretoriensis, and Saccharomyces uvarum.

In one embodiment, the SCOBY is cultivated on the surface of the liquid/air boundary beneath a natural fabric or a synthetic fabric. The natural fabric is in one embodiment cotton, wool, linen, ramie, hemp, burlap, silk, or any fabric. Upon completion of the cultivation, the natural or synthetic fabric is removed and the SCOBY is harvested.

In one embodiment, the SCOBY comprises polyglycol. The SCOBY is incubated in an aqueous solution of polyglycol. The polyglycol is selected from the group consisting of polyethylene glycol, polyethylene oxide, polyoxypropylene, polypropylene glycol, polypropylene oxide, polyoxypropylene, polyvinyl alcohol, and polyvinylpyrrolidone. In one embodiment, hydroxyl moieties present in the polyglycol are covalently bonded to the silica sol or a silicon alkoxide. The flexible, hydrophobic textile comprising polyglycol is more flexible and resists tearing when compared to the flexible, hydrophobic textile made without the polyglycol. Various Polyethylene glycols are commercially available and useful in the invention including PEG 200, PEG 400, PEG 600, PEG 1000, PEG 1500, PEG 2000, and PEG 3400.

In one embodiment, the SCOBY comprises one or more plasticizers. Exemplary plasticizer include phthalates, terephthalates, trimellitates, adipates, maleates, citrates polyacrylamide, polyacrylic acid, polymethacrylate, and polyethylene imine,

The aqueous polyglycol solution comprises between 5% to 95% polyglycol, between 5% to 90% polyglycol, between 10% to 85% polyglycol, between 15% to 80% polyglycol, between 20% to 75% polyglycol, between 25% to 10% polyglycol, between 30% to 65% polyglycol, between 40% to 60% polyglycol, or between 45% to 55% polyglycol,

The SCOBY is dried to prepare a dried SCOBY sheet. The SCOBY comprising glycol is dried to prepare a dried SCOBY sheet. The SCOBY (with or without polyglycol) is dried at a temperature of between 20° C. and 150° C., between 30° C. and 140° C., between 40° C. and 130° C., between 40° C. and 120° C., between 40° C. and 110° C., between 40° C. and 100° C., between 40° C. and 90° C., and between 40° C. and 80° C. In one embodiment, the SCOBY sheet can comprise two or more pieces of SCOBY stacked together. In this embodiment, when a thicker flexible, hydrophobic textile is desired, two or more pieces of SCOBY are stacked and dried to prepare a single SCOBY sheet.

In one embodiment, the moisture content of the dried SCOBY sheet is between 1% and 20%, between 1% and 15%, between 1% and 16%, between 1% and 15%, between 1% and 14%, between 1% and 13%, between 1% and 12%, between 1% and 11%, between 1% and 10%, between 2% and 15%, between 2% and 10%, between 3% and 15%, and between 3% and 10%.

To silanize the dried SCOBY sheet, a silica sol is prepared. The silica sol is prepared by admixing water glass and a first silicon alkoxide. To the admixture of water glass and silicon alkoxide, an acid is slowly added while stirring. In an embodiment, the silicon alkoxide is selected from the group consisting of 3-aminopropyl-trimethoxysilane (APTMS), 3-aminopropyl-triethoxysilane (APTES), 3-aminopropyl-diethoxy-methylsilane (APDEMS), 3-aminopropyl-dimethyl-ethoxysilane (APDMES), 3-methacryl-oxypropyl-trimethoxysilane (MAPMS), methyl-trimethoxysilane (MTMS), vinyl-trimethoxysilane (VTMS), dimethyl-dimethoxysilane (DMDMS), Trimethoxypropylsilane (TMOPS), hexadecyl-trimethoxysilane (HDTOS), isobutyl-trimethoxysilane (IBTMOS), triethoxyoctylsilane (TEOOS), trimethoxyoctadecylsilane (TMEOS), tetramethoxysilane (TMOS), tetraethoxysilane (TEOS), n-octadecyltriethoxysilane (ODTES), Triethoxyphenylsilane (TEOPS), tetrapropoxysilane (TPOS), tetraisopropoxysilane (TiPOS), 3-glycidoxypropyl-dimethyl-ethoxysilane (GPMS), 3-glycidyloxypropyl-trimethoxysil ane (GPTMS), 3-mercaptopropyl-trimethoxysilane (MPTMS), and 3-mercaptopropyl-methyl-dimethoxysilane (MPDMS).

The silica sol comprises water glass, (Na₂SiO₂)ₙO, at a concentration, by weight, of between 0.1% and 10%, between 0.1% and 9%, between 0.1% and 8%, between 0.1% and 7%, between 0.1% and 6%, between 0.1% and 5%, between 0.1% and 4%, between 0.1% and 3%, between 0.1% and 2%, between 0.1% and 1.5%, between 0.1% and 1%, between 0.1% and 0.9%, between 0.1% and 0.8%, between 0.1% and 0.7%, between 0.1% and 0.6%, and between 0.1% and 0.5%.

The silica col comprises silicon alkoxide, at a concentration, by weight, of between 0.1% and 10%, between 0.1% and 9%, between 0.1% and 8%, between 0.1% and 7%, between 0.1% and 6%, between 0.1% and 5%, between 0.1% and 4%, between 0.1% and 3%, between 0.1% and 2%, between 0.1% and 1.5%, between 0.1% and 1%, between 0.1% and 0.9%, between 0.1% and 0.8%, between 0.1% and 0.7%, between 0.1% and 0.6%, and between 0.1% and 0.5%.

The acid used to prepare the silica is any acid. Typically, the acid is HCl, H₂SO₄, H₃PO₄, HNO₃, and citric acid.

After the silica sol is prepared, the dried SCOBY sheet is exposed to the silica sol, typically by immersion of the dried SCOBY sheet into the silica sol to prepare a SCOBY/silica sol matrix. The dried SCOBY sheet is incubated in the silica sol for a period of between 30 min. to 48 hours, between 1 hour and 48 hours, between 2 hours and 44 hours, between 3 hours and 44 hours, between 4 hours and 40 hours, between 5 hours and 35 hours, between 6 hours and 30 hours, between 7 hours and 24 hours, between 8 hours and 24 hours, between 9 hours and 24 hours, between 10 hours and 24 hours, and between 8 hours and 16 hours.

The SCOBY/silica sol matrix is next heat treated to prepare a dried, silanized SCOBY pad. The heat treatment to prepare the dried, silanized SCOBY pad is performed by exposing the SCOBY/silica sol matrix to heat at a temperature of between 40° C. and 150° C., between 40° C. and 140° C., between 40° C. and 130° C., between 40° C. and 120° C., between 40° C. and 110° C., and between 40° C. and 100° C.

In one embodiment, the moisture content of the dried, silanized SCOBY pad is between 1% and 20%, between 1% and 15%, between 1% and 16%, between 1% and 15%, between 1% and 14%, between 1% and 13%, between 1% and 12%, between 1% and 11%, between 1% and 10%, between 2% and 15%, between 2% and 10%, between 3% and 15%, and between 3% and 10%.

To prepare the uncured textile, a second silicon alkoxide is applied to the dried, silanized SCOBY pad. The second silicon alkoxide is the same or different than the first silicon alkoxide. The silicon alkoxide is selected from the group consisting of an aminosilane, a glycidoxysilane, or a mercaptosilane. In an embodiment, the silicon alkoxide is selected from the group consisting of 3-aminopropyl-trimethoxysilane (APTMS), 3-aminopropyl-triethoxysilane (APTES), 3-aminopropyl-diethoxy-methylsilane (APDEMS), 3-aminopropyl-dimethyl-ethoxysilane (APDMES), 3-methacryl-oxypropyl-trimethoxysilane (MAPMS), methyl-trimethoxysilane (MTMS), vinyl-trimethoxysilane (VTMS), dimethyl-dimethoxysilane (DMDMS), Trimethoxypropylsilane (TMOPS), hexadecyl-trimethoxysilane (HDTOS), isobutyl-trimethoxysilane (IBTMOS), triethoxyoctylsilane (TEOOS), trimethoxyoctadecylsilane (TMEOS), tetramethoxysilane (TMOS), tetraethoxysilane (TEOS), n-octadecyltriethoxysilane (ODTES), Triethoxyphenylsilane (TEOPS), tetrapropoxysilane (TPOS), tetraisopropoxysilane (TiPOS), 3-glycidoxypropyl-dimethyl-ethoxysilane (GPMS), 3-glycidyloxypropyl-trimethoxysilane (GPTMS), 3-mercaptopropyl-trimethoxysilane (MPTMS), and 3-mercaptopropyl-methyl-dimethoxysilane (MPDMS).

The second silicon alkoxide is applied to the dried, silanized SCOBY pad. In one embodiment, the second silicon alkoxide is dissolved in a solvent to prepare a silicon alkoxide solution and the dried, silanized SCOBY pad is immersed in the silicon alkoxide solution. The solvent can be any hydrophilic solvent, including methanol, ethanol, acetonitrile, methyl acetate, ethyl acetate, ketones, esters and other oxygen containing solvents.

The uncured textile is cured by exposure to heat to prepare the flexible, hydrophobic textile.

In one embodiment, the moisture content of the uncured textile is between 1% and 20%, between 1% and 15%, between 1% and 16%, between 1% and 15%, between 1% and 14%, between 1% and 13%, between 1% and 12%, between 1% and 11%, between 1% and 10%, between 2% and 15%, between 2% and 10%, between 3% and 15%, and between 3% and 10%.

In one embodiment the flexible, hydrophobic textile further comprises collagen or elastin. In another embodiment, the collagen or elastin is a recombinant collagen or elastin selected from the group consisting of jellyfish collagen, truncated jelly fish collagen, jellyfish elastin, truncated jellyfish elastin, mastodon collagen, truncated mastodon collagen mastodon elastin, and truncated mastodon elastin.

In one embodiment, the moisture content of the flexible, hydrophobic textile is between 0.1% and 10%, between 0.1% and 9%, between 0.1% and 8%, between 0.1% and 7%, between 0.1% and 6%, between 0.1% and 5%, between 0.1% and 4%, between 0.1% and 3%, between 0.1% and 2%, and between 0.1% and 1%.

FIGS. 4 and 5 show photographs of the flexible, hydrophobic textile made without and with polyglycol, respectively. The textile prepared without PEG is more brittle than the textile made with polyglycol. Depending on the application, more or less brittle textile may be useful.

Without being bound by theory, the hydroxyl moieties present in collagen or elastin are covalently linked to the silica sol or a silicon alkoxide. The silanization of the hydroxyl moieties of the collagen or elastin provides a highly flexible, hydrophobic textile that feel and behaves like leather derived from animals.

### Expression System and Collagen and Elastin Molecules

A number of protein expression systems can be used to express nucleic acid sequence obtained from the process disclosed above. In co-owned application PCT/US17/24857, incorporated by reference, an expression system that uses modified bacterial cells (switched cells) in which cell division is inhibited and growth of the periplasmic space is greatly enhanced was disclosed. In this expression system, the expressed proteins are targeted to the periplasmic space. Recombinant protein production in these switched cells is dramatically increased compared with that in non-switched cells. Structurally, the cells comprise both inner and outer membranes but lack a functional peptidoglycan cell wall, while the cell shape is spherical and increases in volume over time. Notably, while the periplasmic space normally comprises only 10-20% of the total cell volume, the periplasmic compartment of the switched state described herein can comprise more than 20%, 30%, 40% or 50% and up to 60%, 70%, 80% or 90% of the total cell volume.

The modified bacterial cells of PCT/US17/24857 are derived from Gram-negative bacteria, e.g. selected from: gammaproteobacteria and alphaproteobacteria. In some embodiments, the bacterium is selected from: Escherichia coli, Vibrio natriegens, Pseudomonas fluorescens, Caulobacter crescentus, Agrobacterium tumefaciens, and Brevundimonas diminuta. In specific embodiments, the bacterium is Escherichia coli, e.g. strain BL21(DE3).

In another aspect, the host bacterial cells have an enlarged periplasmic space in a culture medium comprising a magnesium salt, wherein the concentration of magnesium ions in the medium is at least about 3, 4, 5 or 6 mM. In further embodiments, the concentration of magnesium ions in the medium is at least about 7, 8, 9 or 10 mM. In some embodiments, the concentration of magnesium ions in the medium is between about 5 mM and 25 mM, between about 6 mM and/or about 20, 15 or 10 mM. In some embodiments, the magnesium salt is selected from: magnesium sulfate and magnesium chloride.

In other embodiments, the culture medium further comprises an osmotic stabilizer, including, e.g. sugars (e.g., arabinose, glucose, sucrose, glycerol, sorbitol, mannitol, fructose, galactose, saccharose, maltotrioseerythritol, ribitol, pentaerythritol, arabitol, galactitol, xylitol, iditol, maltotriose, and the like), betaines (e.g., trimethylglycine), proline, sodium chloride, wherein the concentration of the osmotic stabilizer in the medium is at least about 4%, 5%, 6%, or 7% (w/v). In further embodiments, the concentration of osmotic stabilizer is at least about 8%, 9%, or 10% (w/v). In some embodiments, the concentration of the osmotic stabilizer in the medium is between about 5% to about 20% (w/v).

In some embodiments, the cell culture medium further comprise ammonium chloride, ammonium sulfate, calcium chloride, amino acids, iron(II) sulfate, magnesium sulfate, peptone, potassium phosphate, sodium chloride, sodium phosphate, and yeast extract.

The host bacterial cell may be cultured continuously or discontinuously; in a batch process, a fed-batch process or a repeated fed-batch process.

In some embodiments, the cell culture medium further comprises one or more antibiotics. In some implementations, the antibiotic is selected from: β-lactam antibiotics (e.g. penicillins, cephalosporins, carbapenems, and monobactams), phosphonic acid antibiotics, polypeptide antibiotics, and glycopeptide antibiotics. In particular embodiments, the antibiotic is selected from alafosfalin, amoxicillin, ampicillin, aztreonam, bacitracin, carbenicillin, cefamandole, cefotaxime, cefsulodin, cephalothin, fosmidomycin, methicillin, nafcillin, oxacillin, penicillin g, penicillin v, fosfomycin, primaxin, and vancomycin.

Without being bound by theory, the cell morphology that promotes recombinant protein production and inhibits cell division appears to be driven by the removal of the cell wall under the media conditions stated above. In some embodiments, the methods for removal/inhibition of cell wall synthesis can be through the use of antibiotics that inhibit peptidoglycan synthesis (such as ampicillin, carbenicillin, penicillins or fosfomycin), or other methods known in the art.

With an appropriate periplasmic targeting signal sequence, recombinantly produced polypeptides can be secreted into the periplasmic space of bacterial cells. Joly, J. C. and Laird, M. W., in The Periplasm ed. Ehrmann, M., ASM Press, Washington D.C., (2007) 345-360. The chemically oxidizing environment of the periplasm favors the formation of disulfide bonds and thereby the functionally correct folding of polypeptides.

In general, the signal sequence may be a component of the expression vector, or it may be a part of the exogenous gene that is inserted into the vector. The signal sequence selected should be one that is recognized and processed (i.e., cleaved by a signal peptidase) by the host cell. For bacterial host cells that do not recognize and process the native signal sequence of the exogenous gene, the signal sequence is substituted by any commonly known bacterial signal sequence. In some embodiments, recombinantly produced polypeptides can be targeted to the periplasmic space using the DsbA signal sequence. Dinh and Bernhardt, J Bacteriol, September 2011, 4984-4987. DsbA is a bacterial thiol disulfide oxidoreductase (TDOR). DsbA is a key component of the Dsb (disulfide bond) family of enzymes. DsbA catalyzes intrachain disulfide bond formation as peptides emerge into the cell's periplasm.

The non-naturally occurring collagen or elastin of the invention further comprises amino acid sequences including a secretion tag. The secretion tag directs the collagen or elastin of the invention to the periplasmic space of the host cell. In particular embodiments, the signal peptide is derived from DsbA, pelB, OmpA, To1B, MalE, 1pp, TorA, or Hy1A. In one aspect the secretion tag is attached to the non-naturally occurring collagen or elastin of the invention. In another aspect the secretion tag is cleaved from the non-naturally occurring collagen or elastin of the invention.

The non-naturally occurring collagen or the non-naturally occurring elastin of the invention further comprises a histidine tag. The histidine tag or polyhistidine tag is a sequence of 2 to 20 histidine residues (SEQ ID NO: 76) that are attached to the collagen or elastin. The histidine tag comprises 2 to 20 histidine residues (SEQ ID NO: 76), 5 to 15 histidine residues (SEQ ID NO: 77), 5 to 18 histidine residues (SEQ ID NO: 78), 5 to 16 histidine residues (SEQ ID NO: 79), 5 to 15 histidine residues (SEQ ID NO: 77), 5 to 14 histidine residues (SEQ ID NO: 80), 5 to 13 histidine residues (SEQ ID NO: 81), 5 to 12 histidine residues (SEQ ID NO: 82), 5 to 11 (SEQ ID NO: 83), 5 to 10 histidine residues (SEQ ID NO: 84), 6 to 12 histidine residues (SEQ ID NO: 85), 6 to 11 histidine residues (SEQ ID NO: 86), or 7 to 10 histidine residues (SEQ ID NO: 87). The histidine tags are useful in purification of proteins by chromatographic methods utilizing nickel based chromatographic media. Exemplary fluorescent proteins include green fluorescent protein (GFP) or red fluorescent protein (RFP). Fluorescent proteins are well known in the art. In one embodiment the non-naturally occurring collagen or the non-naturally occurring elastin comprises a GFP and/or RFP. In one embodiment a superfolder GFP is fused to the non-naturally occurring collagen or elastin. The superfolder GFP is a GFP that folds properly even when fused to a poorly folded polypeptide. In one aspect the histidine tag is attached to the non-naturally occurring collagen or elastin of the invention. In another aspect the histidine tag is cleaved from the non-naturally occurring collagen or elastin of the invention.

The non-naturally occurring collagen or non-naturally occurring elastin of the invention further comprises a protease cleavage site. The protease cleavage site is useful to cleave the recombinantly produced collagen or elastin to remove portions of the polypeptide. The portions of the polypeptide that may be removed include the secretion tag, the histidine tag, the fluorescent protein tag and/or the Beta-lactamase. The proteases of the invention comprise endoproteases, exoproteases serine proteases, cysteine proteases, threonine proteases, aspartic proteases, glutamic proteases, and metalloproteases. Exemplary protease cleavage sites include amino acids that are cleaved by Thrombin, TEV protease, Factor Xa, Enteropeptidase, and Rhinovirus 3C Protease. In one aspect the cleavage tag is attached to the non-naturally occurring collagen or elastin of the invention. In another aspect the cleavage tag is removed by an appropriate protease from the non-naturally occurring collagen or elastin of the invention.

The non-naturally occurring collagen or non-naturally occurring elastin of the invention further comprises an enzyme that is a Beta-lactamase. The beta-lactamase is useful as a selection marker. In one aspect the beta-lactamase is attached to the non-naturally occurring collagen or elastin of the invention. In another aspect the beta-lactamase is cleaved from the non-naturally occurring collagen or elastin of the invention.

The non-naturally occurring collagen or non-naturally occurring elastin of the invention further comprises GEK amino acid trimer repeats and/or GDK amino acid trimer repeats. The GEK and the GDK trimer repeats facilitate the gelling of the collagen and/or the gelatin. In one embodiment, the non-naturally occurring collagen or the non-naturally occurring elastin of the invention comprises 2-50 GEK and/or 2-50 GDK (SEQ ID NOS 88-89, respectively) trimer repeats, 2-40 GEK and/or 2-40 GDK (SEQ ID NOS 90-91, respectively) trimer repeats, 2-30 GEK and/or 2-30 GDK (SEQ ID NOS 92-93, respectively) trimer repeats, 2-20 GEK and/or 2-20 GDK (SEQ ID NOS 94-95, respectively) trimer repeats, 2-15 GEK and/or 2-15 GDK (SEQ ID NOS 96-97, respectively) trimer repeats. 2-10 GEK and/or 2-10 GDK (SEQ ID NOS 98-99, respectively) trimer repeats, 2-9 GEK and/or 2-9 GDK (SEQ ID NOS 100-101, respectively) trimer repeats, 2-8 GEK and/or 2-8 GDK (SEQ ID NOS 102-103, respectively) trimer repeats, 2-7 GEK and/or 2-7 GDK (SEQ ID NOS 104-105, respectively) trimer repeats, 2-6 GEK and/or 2-6 GDK (SEQ ID NOS 106-107, respectively) trimer repeats, 2-5 GEK and/or 2-5 GDK trimer repeats (SEQ ID NOS 108-109, respectively), or 2-4 GEK and/or 2-4 GDK (SEQ ID NOS 110-111, respectively) trimer repeats. In one aspect the GEK trimer repeat or the GDK trimer repeat is attached to the non-naturally occurring collagen or elastin of the invention. In another aspect the GEK trimer repeat or the GDK trimer repeat is cleaved from the non-naturally occurring collagen or elastin of the invention.

One aspect of the invention provides polynucleotides that encode a non-naturally occurring collagen or a non-naturally occurring elastin. The polynucleotides encode collagen or elastin from jellyfish, tilapia, human, porcine, bovine, sheep, chicken, or Vicugna. The polynucleotides encode for collagen or elastin that is full length or truncated.

Another aspect of the invention provides polynucleotides that encode collagen or elastin fusion proteins. The elastin or collagen fusion proteins comprise a secretion tag, a histidine tag, a fluorescent protein tag, a protease cleavage site, a Beta-lactamase along and/or GEK amino acid trimer repeats and/or GDK amino acid trimer repeats together with collagen or elastin.

The polynucleotides are in one aspect vectors used to transform host cells and express the polynucleotides. The polynucleotides further comprise nucleic acids that encode enzymes that permit the host organism to grow in the presence of a selection agent. The selection agents include certain sugars including galactose containing sugars or antibiotics including ampicillin, hygromycin, G418 and others. Enzymes that are used to confer resistance to the selection agent include β-galactosidase or a β-lactamase.

In one aspect the disclosure provides host cells that express the polynucleotides. Host cells can be any host cell including gram negative bacterial cells, gram positive bacterial cells, yeast cells, insect cells, mammalian cells, plant cells or any other cells used to express exogenous polynucleotides. An exemplary gram-negative host cell is E. coli.

The disclosure provides bacterial host cells in which the cells have been modified to inhibit cell division and the periplasmic space is increased. As discussed herein and taught in example 1, Beta-lactam antibiotics are useful as a switch to convert wild-type bacterial cells to a modified bacterial cell in which cell replication is inhibited and the periplasmic space is increased. Exemplary Beta-lactam antibiotics including penicillins, cephalosporins, carbapenems, and monobactams.

The switched form of bacteria (L-form) are cultivated in culture media that include certain salts and other nutrients. Salts and media compositions that support the physiological switch physiology that have been tested are M63 salt media, M9 salt media, PYE media, and Luria-Bertani (LB) media. Any necessary supplements besides carbon, nitrogen, and inorganic phosphate sources may also be included at appropriate concentrations introduced alone or as a mixture with another supplement or medium such as a complex nitrogen source. In certain embodiments, the medium further comprises one or more ingredients selected from: ammonium chloride, ammonium sulfate, calcium chloride, casamino acids, iron(II) sulfate, magnesium sulfate, peptone, potassium phosphate, sodium chloride, sodium phosphate, and yeast extract.

Beta-lactamases are enzymes that confer resistance to lactam antibiotics in prokaryotic cells. Typically when Beta-lactamases are expressed in bacterial host cells, the expressed Beta-lactamase protein also includes targeting sequences (secretion tag) that direct the Beta-lactamase protein to the periplasmic space. Beta-lactamases are not functional unless they are transported to the periplasmic space. This disclosure provides for targeting a Beta-lactamase to the periplasmic space without the use of an independent secretion tag that targets the enzyme to the periplasmic space. By creating a fusion protein in which a periplasmic secretion tag added to the N-terminus of a protein such as GFP, collagen, or GFP/collagen chimeras, the functionality of the Beta-lactamase lacking a native secretion tag can be used to select for full translation and secretion of the N-terminal fusion proteins. Using this approach, we have used a DsbA-GFP-Collagen-Beta-lactamase fusion to select for truncation products in the target collagens that favor translation and secretion.

Another aspect provides a method of producing a non-naturally occurring collagen or a non-naturally occurring elastin. The method comprises the steps of inoculating a culture medium with a recombinant host cell comprising polynucleotides that encode the collagen, cultivating the host cell, and isolating the non-naturally occurring collagen or the non-naturally occurring elastin from the host cell.

The present disclosure furthermore provides a process for fermentative preparation of a protein, comprising the steps of:

culturing a recombinant Gram-negative bacterial cell in a medium comprising a magnesium salt, wherein the concentration of magnesium ions in the medium is at least about 6 mM, and wherein the bacterial cell comprises an exogenous gene encoding the protein;

adding an antibiotic to the medium, wherein the antibiotic inhibits peptidoglycan biogenesis in the bacterial cell; and

harvesting the protein from the medium.

The bacteria may be cultured continuously—as described, for example, in WO 05/021772—or discontinuously in a batch process (batch cultivation) or in a fed-batch or repeated fed-batch process for the purpose of producing the target protein. In some embodiments, protein production is conducted on a large-scale. Various large-scale fermentation procedures are available for production of recombinant proteins. Large-scale fermentations have at least 1,000 liters of capacity, preferably about 1,000 to 100,000 liters of capacity. These fermentors use agitator impellers to distribute oxygen and nutrients, especially glucose (the preferred carbon/energy source). Small-scale fermentation refers generally to fermentation in a fermentor that is no more than approximately 20 liters in volumetric capacity.

For accumulation of the target protein, the host cell is cultured under conditions sufficient for accumulation of the target protein. Such conditions include, e.g., temperature, nutrient, and cell-density conditions that permit protein expression and accumulation by the cell. Moreover, such conditions are those under which the cell can perform basic cellular functions of transcription, translation, and passage of proteins from one cellular compartment to another for the secreted proteins, as are known to those skilled in the art.

The bacterial cells are cultured at suitable temperatures. For E. coli growth, for example, the typical temperature ranges from about 20° C. to about 39° C. In one embodiment, the temperature is from about 25° C. to about 37° C. In another embodiment, the temperature is at about 30° C.

The pH of the culture medium may be any pH from about 5-9, depending mainly on the host organism. For E. coli, the pH is from about 6.8 to about 7.4, or about 7.0.

For induction of gene expression, typically the cells are cultured until a certain optical density is achieved, e.g., an OD600 of about 1.1, at which point induction is initiated (e.g., by addition of an inducer, by depletion of a repressor, suppressor, or medium component, etc.) to induce expression of the exogenous gene encoding the target protein. In some embodiments, expression of the exogenous gene is inducible by an inducer selected from, e.g. isopropyl-β-d-1-thiogalactopyranoside (IPTG), lactose, arabinose, maltose, tetracycline, anhydrotetracycline, vavlycin, xylose, copper, zinc, and the like.

After product accumulation, the cells are vortexed and centrifuged in order to induce lysis and release of recombinant proteins. The majority of the proteins are found in the supernatant but any remaining membrane bound proteins can be released using detergents (such as triton X-100).

In a subsequent step, the target protein, as a soluble or insoluble product released from the cellular matrix, is recovered in a manner that minimizes co-recovery of cellular debris with the product. The recovery may be done by any means, but in one embodiment, can comprise histidine tag purification through a nickel column. See, e.g., Purification of Proteins Using Polyhistidine Affinity Tags, Methods Enzymology. 2000; 326: 245-254.

### EXAMPLES

### Example 1: Expression System

### Materials and Methods:

### Tested Physiological Switch and Protein Production:

### Strains:

E. coli BL21(DE3)—From NEB, product #c2527

E. coli K12 NCM3722—From The Coli Genetic Stock Center, CGSC #12355

### Tested Physiological Switch:

Gammaproteobacteria:

Vibrio natriegens—From ATCC, product #14048

Pseudomonas fluorescens—From ATCC, product #31948

Pseudomonas aeruginosa PAO1—From ATCC, product #BAA-47

Alphaproteobacteria:

Caulobacter crescentus—From ATCC, product #19089

Agrobacterium tumefaciens/Rhizobium radiobacter—From ATCC, product #33970

Brevundimonas diminuta—From ATCC, product #13184

Media compositions:

1 liter 5× m63 salts:

10 g (NH4)2SO4—From P212121, product #7783-20-2
68 g KH2PO4—From P212121, product #7778-77-0
2.5 mg FeSO4.7H2O—From Sigma Aldrich, product #F7002
Bring volume up to 1 liter with milliQ water
Adjust to pH 7 with KOH (From P212121, product #1310-58-3) Autoclave mixture

1 liter of 1M MgSO4:

246.5 g MgSO4 7H2O—From P212121, (Sigma Aldrich, product #10034-99-8)
Bring volume up to 1 liter with milliQ water.
Autoclave mixture.

1 liter of switch media 1:

133.4 mL 5×m63 salts

### 10 mL 1M MgSO4

38.6 g Glucose—From P212121, product #50-99-7
66.6 g Sucrose—From P212121, product #57-50-1
8.33 g LB mix—From P212121, product #1b-miller
Bring volume up to 1 liter with milliQ water.
Filter sterilize mixture through a 0.22 μM pore vacuum filter (Sigma Aldrich, product #CLS430517).

1 liter of switch media 2:

133.4 mL 5×m63 salts

### 10 mL 1M MgSO4

38.6 g Glucose—From P212121, product #50-99-7
66.6 g Sucrose—From P212121, product #57-50-1
10 g Yeast Extract—From FisherSci.com, product #J60287A1
Bring volume up to 1 liter with milliQ water.
Filter sterilize mixture through a 0.22 μM pore vacuum filter (Sigma Aldrich, product #CLS430517).

For Bioreactor growth:

5 liter of bioreactor media MGZ12:
1) Autoclave 1 L of Glucose at concentration of 500 g/L in DI water. (VWR, product #97061-170).
2) Autoclave 1 L of Sucrose at concentration of 500 g/L in DI water. (Geneseesci.com, product #62-112).
3) Autoclave in 3946 mL of DI water:
20 g (NH4)2HPO4. (VWR, product #97061-932).
66.5 g KH2PO4. (VWR, product #97062-348).
22.5 g H3C6H5O7. (VWR, product #BDH9228-2.5KG).
2.95 g MgSO4.7H2O. (VWR, product #97062-134).
10 mL Trace Metals (Teknova), 1000×. (Teknova, product #T1001).
After autoclaving add 400 mL of (1) to (3), 65 mL of 10M NaOH (VWR, product #97064-480) to (3), and 666 mL of (2) to (3).
A feed of 500 g/L of glucose can be used during fermentation run as needed.

At induction add:

50 mL of 1M MgSO4.7H2O to a 5 L bioreactor
1 to 10 mM concentration of IPTG. (carbosynth.com, product #EI05931).
Add Fosfomycin (50 μg/mL or higher) and Carbenicillin (100 μg/mL or higher).

### Physiological Switch:

The physiological switch is optimally flipped at an OD 600 of 1 to 1.1 for E. coli for growth in shake flasks at volumes up to 1 L. For the other species tested, cultures were grown in switch media and subcultured once cultures reached maximal OD 600. In all cases the physiological switch is flipped through the addition of 100-200 ug/mL Carbenicillin (From P212121, product #4800-94-6) and 50-100 ug/mL Fosfomycin (From P212121, product #26016-99-9). The majority of the population is in the switched state within a few hours. To confirm that cells underwent a physiological switch, cells were imaged on a Nikon Ti-E with perfect focus system, Nikon CFI60 Plan Apo 100X NA 1.45 objective, Prior automated filter wheels and stage, LED-CFP/YFP/mCherry and LED-DA/FT/TX filter sets (Semrock), a Lumencor Sola II SE LED illumination system, and a Hamamatsu Flash 4.0 V2 CMOS camera.

### Image Analysis of Physiological Switch:

Images were analyzed using ImageJ to measure dimensions. In the switched state, the spherical outline of the outer membrane is treated as a sphere to calculate total volume (V=(4/3)itr3). The cytoplasmic volume is calculated as an ellipsoid that exists within the sphere (V=(4/3)π*(longest radius)*(short radius)2). To calculate the periplasmic volume, the cytoplasmic volume is subtracted from the total volume of the cell.

### Protein Expression and Quantification:

E. coli BL21(DE3) (NEB product #c2527) containing pET28a (emd Millipore product #69864) and its derivatives carrying GFP or collagen derivatives were grown in a shaking incubator at 37° C. overnight in switch media containing 50 mg/mL kanamycin (p212121 product #2251180). Next day, subcultures are started with a 1:10 dilution of the overnight culture into fresh switch media containing 50 mg/mL kanamycin. The culture is then physiologically switched and protein production is induced simultaneously at an OD 600 of 1 to 1.1 (Read on a Molecular Devices Spectramax M2 microplate reader). The physiological switch and protein production are flipped through the addition of 100 ug/mL Carbenicillin, 50 ug/mL Fosfomycin, and 100 ug/mL IPTG (p212121 product #367-93-1). Protein expression is continued in the switched state from between 8 hours to overnight at room temperature (approximately 22° C.) on an orbital shaker. In order to quantify total protein levels, Quick Start™ Bradford Protein Assay was used on mixed portion of culture and standard curves are quantitated on a Molecular Devices Spectramax M2 microplate reader. In order to quantitate the relative intensity of target protein production relative to the rest of the protein population the mixed portion of the cultures were run on Mini-PROTEAN® TGX™ Gels and stained with Bio-Safe™ Coomassie Stain.

### Induction of Protein Production:

Standard procedures have been followed to induce protein production in the physiological state. We have been using the strain BL21(DE3) containing the plasmid pET28a driving the IPTG/lactose inducible production of recombinant proteins and targeting them to the periplasmic space using the DsbA signal sequence. Using the GFP protein, targeted to the periplasmic space as described above, we have demonstrated the ability to gain and increase of 5-fold in protein production when compared to un-switched cell populations induced at the same optical density, for the same amount of time (see FIGS. 8-11). The induction was optimal at an OD600 of 1.1 and induction was continued for 10 hours at which point the protein produced was measured at about 200 mg/mL.

### Example 2: Production of Full-Length Collagen

Full length jellyfish collagen was produced using the expression system discussed in Example 1 herein. The wild-type, full length amino acid sequence of Podocoryna carnea (jellyfish) collagen is provided in Seq Id No: 1.

(Seq Id No: 1)
GPQGVVGADGKDGTPGEKGEQGRTGAAGKQGSPGADGARGPLGSIGQQGA
RGEPGDPGSPGLRGDTGLAGVKGVAGPSGRPGQPGANGLPGVNGRGGLRG
KPGAKGIAGSDGEAGESGAPGQSGPTGPRGQRGPSGEDGNPGLQGLPGSD
GEPGEEGQPGRSGQPGQQGPRGSPGEVGPRGSKGPSGDRGDRGERGVPGQ
TGSAGNVGEDGEQGGKGVDGASGPSGALGARGPPGSRGDTGAVGPPGPTG
RSGLPGNAGQKGPSGEPGSPGKAGSAGEQGPPGKDGSNGEPGSPGKEGER
GLAGPPGPDGRRGETGSPGIAGALGKPGLEGPKGYPGLRGRDGTNGKRGE
QGETGPDGVRGIPGNDGQSGKPGIDGIDGTNGQPGEAGYQGGRGTRGQLG
ETGDVGQNGDRGAPGPDGSKGSAGRPGLR
www.ncbi.nlm.nih.gov/protein/4379341?report=
genbank&log$=protalign&blast_rank=1&RID=
T1N9ZEUW014

The non-codon optimized polynucleotide sequence encoding the full length jellyfish collagen is disclosed in Seq Id No: 2.

(Seq Id No: 2)
ggaccacaaggtgttgtaggagctgatggcaaagatggaacaccgggaga
gaaaggtgagcaaggacgaaccggagctgcaggaaaacagggaagccctg
gagcagatggagcaagaggccctcttggatcaattggacaacaaggtgct
cgtggagaacctggtgatccaggatctcccggcttaagaggagatactgg
attggctggagtcaaaggagtagcaggaccatctggtcgacctggacaac
ccggtgcaaatggattacctggtgtgaatggcagaggcggtttgagaggc
aaacctggtgctaaaggaattgctggcagtgatggagaagcgggagaatc
tggcgcacctggacagtccggacctaccggtccacgtggtcaacgaggac
caagtggtgaggatggtaatcctggattacagggattgcctggttctgat
ggagagcccggagaggaaggacaacctggaagatctggtcaaccaggaca
gcaaggaccacgtggttcccctggagaggtaggaccaagaggatctaaag
gtccatcaggagatcgtggtgacaggggagagagaggtgttcctggacaa
acaggttcggctggaaatgtaggagaagatggagagcaaggaggcaaagg
tgtcgatggagcgagtggaccaagtggagctcttggtgctcgtggtcccc
caggaagtagaggtgacaccggggcagtgggacctcccggacctactggg
cgatctggtttacctggaaacgcaggacaaaagggaccaagtggtgaacc
aggtagtccaggaaaagcaggatcagctggtgaacagggtcctcctggta
aagacggatcaaatggtgaacctggatctcctggcaaagagggtgaacgt
ggtcttgctggtccaccaggtccagatggcagacgtggtgaaacgggatc
tccaggtatcgctggtgctcttggtaaaccaggtttggaaggacctaaag
gttatccaggattaagaggaagagatggaaccaatggcaaacgaggagaa
caaggagaaactggtcctgatggagtcagaggtattcctggaaatgatgg
acaatctggcaaaccaggtattgatggtattgacggaacaaatggtcaac
caggtgaggctggataccaaggtggtagaggtacacgtggtcagttaggt
gaaactggtgatgtcggacagaatggagatcgaggagctcctggtcctga
tggatctaaaggttctgctggtagaccaggacttcgtgg
www.ncbi.nlm.nih.gov/nucleotide/3355656?report=
genbank&log$=nuclalign&blast_rank=1&RID=
TSYP7CMV014

Two different codon optimized polynucleotide sequences encoding the wild-type, full-length jellyfish collagen were synthesized. The two polynucleotide sequences were slightly different due to slightly different codon optimization methods. In addition to the non-truncated, full-length jellyfish collagen, the polynucleotides also encoded a secretion tag, a 9 amino acid his tag (SEQ ID NO: 112), a short linker, and a thrombin cleavage site. The DsbA secretion tag is encoded by nucleotides 1-71. The histidine tag comprising 9 histidine residues (SEQ ID NO: 112) is encoded by nucleotides 73-99 and encodes amino acids 25-33. The linker is encoded by nucleotides 100-111. The thrombin cleavage tag is encoded by nucleotides 112-135 and encodes amino acids 38-45. The truncated collagen is encoded by nucleotides 136-1422. The two polynucleotides are disclosed below in Seq Id No: 3 and 4.

(Seq Id No: 3)
ATGAAAAAGATTTGGCTGGCGCTGGCTGGTTTAGTTTTAGCGTTTAGC
GCATCGGCGGCGCAGTATGAAGATCACCATCACCACCACCACCATCAC
CACTCTGGCTCGAGCCTGGTGCCGCGCGGCAGCCATATGGGTCCGCAG
GGTGTTGTTGGTGCAGATGGTAAAGACGGTACCCCGGGTGAAAAAGGA
GAACAGGGACGTACAGGTGCAGCAGGTAAACAGGGCAGCCCGGGTGCC
GATGGTGCCCGTGGCCCGCTGGGTAGCATTGGTCAGCAGGGTGCAAGA
GGCGAACCGGGCGATCCGGGTAGTCCGGGCCTGCGTGGTGATACGGGT
CTGGCCGGTGTTAAAGGCGTTGCAGGTCCTTCAGGTCGTCCAGGTCAA
CCGGGTGCAAATGGTCTGCCGGGTGTTAATGGTCGTGGCGGTCTGCGT
GGCAAACCGGGAGCAAAAGGTATTGCAGGTAGCGATGGAGAAGCCGGT
GAAAGCGGTGCCCCGGGTCAGAGTGGTCCGACCGGTCCGCGCGGTCAG
CGTGGTCCGTCTGGTGAAGATGGCAATCCGGGTCTGCAGGGTCTGCCT
GGTAGTGATGGCGAACCAGGTGAAGAAGGTCAGCCGGGTCGTTCAGGC
CAGCCGGGCCAGCAGGGCCCGCGTGGTAGCCCGGGCGAAGTTGGCCCG
CGGGGTAGTAAAGGTCCTAGTGGCGATCGCGGTGATCGTGGTGAACGC
GGTGTTCCTGGTCAGACCGGTAGCGCAGGTAATGTTGGCGAAGATGGT
GAACAGGGTGGCAAAGGTGTTGATGGTGCAAGCGGTCCGAGCGGTGCA
CTGGGTGCACGTGGTCCTCCGGGCAGCCGTGGTGACACCGGTGCAGTT
GGTCCGCCTGGCCCGACCGGCCGTAGTGGCTTACCGGGTAATGCAGGT
CAGAAAGGTCCGTCAGGTGAACCTGGCAGCCCTGGTAAAGCAGGTAGT
GCCGGTGAGCAGGGTCCGCCGGGCAAAGATGGTAGTAATGGTGAGCCG
GGTAGCCCTGGCAAAGAAGGTGAACGTGGTCTGGCAGGACCGCCGGGT
CCTGATGGTCGCCGCGGTGAAACGGGTTCACCGGGTATTGCCGGTGCC
CTGGGTAAACCAGGTCTGGAAGGTCCGAAAGGTTATCCTGGTCTGCGC
GGTCGTGATGGTACCAATGGCAAACGTGGCGAACAGGGCGAAACCGGT
CCAGATGGTGTTCGTGGTATTCCGGGTAACGATGGTCAGAGCGGTAAA
CCGGGCATTGATGGTATTGATGGCACCAATGGTCAGCCTGGCGAAGCA
GGTTATCAGGGTGGTCGCGGTACCCGTGGTCAGCTGGGTGAAACAGGT
GATGTTGGTCAGAATGGTGATCGCGGCGCACCGGGTCCGGATGGTAGC
AAAGGTAGCGCCGGTCGTCCGGGTTTACGTtaa
(Seq Id No: 4)
ATGAAAAAGATTTGGCTGGCGCTGGCTGGTTTAGTTTTAGCGTTTAGC
GCATCGGCGGCGCAGTATGAAGATCACCATCACCACCACCACCATCAC
CACTCTGGCTCGAGCCTGGTGCCGCGCGGCAGCCATATGGGTCCGCAG
GGTGTTGTTGGTGCAGATGGTAAAGACGGTACCCCGGGTGAAAAAGGt
GAACAGGGtCGTACcGGTGCAGCAGGTAAACAGGGCAGCCCGGGTGCC
GATGGTGCCCGTGGCCCGCTGGGTAGCATTGGTCAGCAGGGTGCAcgt
GGCGAACCGGGCGATCCGGGTAGcCCGGGCCTGCGTGGTGATACGGGT
CTGGCCGGTGTTAAAGGCGTTGCAGGTCCTTCtGGTCGTCCAGGTCAA
CCGGGTGCAAATGGTCTGCCGGGTGTTAATGGTCGTGGCGGTCTGCGT
GGCAAACCGGGtGCAAAAGGTATTGCAGGTAGCGATGGcGAAGCCGGT
GAAAGCGGTGCCCCGGGTCAGAGcGGTCCGACCGGTCCGCGCGGTCAG
CGTGGTCCGTCTGGTGAAGATGGCAATCCGGGTCTGCAGGGTCTGCCT
GGTagcGATGGCGAACCAGGTGAAGAAGGTCAGCCGGGTCGTTCtGGC
CAGCCGGGCCAGCAGGGCCCGCGTGGTAGCCCGGGCGAAGTTGGCCCG
CGcGGTtcTAAAGGTCCTAGcGGCGATCGCGGTGATCGTGGTGAACGC
GGTGTTCCTGGTCAGACCGGTAGCGCAGGTAATGTTGGCGAAGATGGT
GAACAGGGTGGCAAAGGTGTTGATGGTGCAAGCGGTCCGAGCGGTGCA
CTGGGTGCACGTGGTCCTCCGGGCAGCCGTGGTGACACCGGTGCAGTT
GGTCCGCCTGGCCCGACCGGCCGTAGcGGCctgCCGGGTAATGCAGGT
CAGAAAGGTCCGTCtGGTGAACCTGGCAGCCCTGGTAAAGCAGGTAGc
GCCGGTGAGCAGGGTCCGCCGGGCAAAGATGGTAGcAATGGTGAGCCG
GGTAGCCCTGGCAAAGAAGGTGAACGTGGTCTGGCAGGtCCGCCGGGT
CCTGATGGTCGCCGCGGTGAAACGGGTTCtCCGGGTATTGCCGGTGCC
CTGGGTAAACCAGGTCTGGAAGGTCCGAAAGGTTATCCTGGTCTGCGC
GGTCGTGATGGTACCAATGGCAAACGTGGCGAACAGGGCGAAACCGGT
CCAGATGGTGTTCGTGGTATTCCGGGTAACGATGGTCAGAGCGGTAAA
CCGGGCATTGATGGTATTGATGGCACCAATGGTCAGCCTGGCGAAGCA
GGTTATCAGGGTGGTCGCGGTACCCGTGGTCAGCTGGGTGAAACcGGT
GATGTTGGTCAGAATGGTGATCGCGGCGCACCGGGTCCGGATGGTAGC
AAAGGTAGCGCCGGTCGTCCGGGTctGCGTtaa

The amino acid sequence encoded by the polynucleotides of Seq Id No: 3 and Seq Id No:4 is disclosed in Seq Id No:5 below. In Seq Id No: 5 the DsbA secretion tag is encoded by nucleotides 1-71 and encodes amino acids 1-24; the histidine tag comprising 9 histidine residues (SEQ ID NO: 112) is encoded by nucleotides 73-99 and encodes amino acids 25-33; the linker is encoded by nucleotides 100-111 and encodes amino acids 34-37; the thrombin cleavage tag is encoded by nucleotides 112-135 and encodes amino acids 38-45; the full-length collagen is encoded by nucleotides 136-1422 and encodes amino acids 46-474.

(Seq Id No: 5)
MKKIWLALAGLVLAFSASAAQYEDHHHHHHHHHSGSSLVPRGSHMGPQ
GVVGADGKDGTPGEKGEQGRTGAAGKQGSPGADGARGPLGSIGQQGAR
GEPGDPGSPGLRGDTGLAGVKGVAGPSGRPGQPGANGLPGVNGRGGLR
GKPGAKGIAGSDGEAGESGAPGQSGPTGPRGQRGPSGEDGNPGLQGLP
GSDGEPGEEGQPGRSGQPGQQGPRGSPGEVGPRGSKGPSGDRGDRGER
GVPGQTGSAGNVGEDGEQGGKGVDGASGPSGALGARGPPGSRGDTGAV
GPPGPTGRSGLPGNAGQKGPSGEPGSPGKAGSAGEQGPPGKDGSNGEP
GSPGKEGERGLAGPPGPDGRRGETGSPGIAGALGKPGLEGPKGYPGLR
GRDGTNGKRGEQGETGPDGVRGIPGNDGQSGKPGIDGIDGTNGQPGEA
GYQGGRGTRGQLGETGDVGQNGDRGAPGPDGSKGSAGRPGLR

The polynucleotides of Seq ID No: 3 and Seq ID No: 4 were synthesized by Gen9 DNA, now Gingko Bioworks internal synthesis. Overlaps between the pET28 vector and Seq ID No: 3 and Seq ID No: 4 were designed to be between 30 and 40 bp long and added using PCR with the enzyme PrimeStar GXL polymerase (http://www.clontech.com/US/Products/PCR/GC_Rich/PrimeSTAR GXL DNA Polymerase?si tex=10020:22372:US). The opened pET28a vector and insert DNA (Seq ID No: 3 or Seq ID No: 4) were then assembled together into the final plasmid using SGI Gibson assembly (us.vwr.com/store/product/17613857/gibson-assembly-hifi-1-step-kit-synthetic-genomics-inc). Sequence of plasmid was then verified through sanger sequencing through Eurofins Genomics (www.eurofinsgenomics.com).

The transformed cells were cultivated in minimal media and frozen in 1.5 ml aliquots with glycerol at a ratio of 50:50 of cells to glycerol. One vial of this frozen culture was revived in 50 ml of minimal media overnight at 37° C., 200 rpm. Cells were transferred into 300 ml of minimal media and grown for 6-9 hours to reach an OD600 of 5-10.

Minimal media used in this example and throughout this application is prepared as follows. The components of the minimal media (Table 1) were autoclaved in several separate fractions. The salts mix (ammonium phosphate dibasic, potassium phosphate monobasic, citric acid anhydrous, magnesium sulfate heptahydrate), the sucrose at 500 g/L, the glucose at 55%, the trace metals TM5 (table 2), and sodium hydroxide 10M were autoclaved separately. The minimal media was then prepared by mixing the components at the desired concentrations post-autoclaving in the hood.

TABLE 1
Minimal media recipe for shake flask cultures

| chemical | Formula | MW | Conc (g/L) |
|---|---|---|---|
| Ammonium Phosphate dibasic | (NH₄)₂HPO₄ | 133 | 4 |
| Potassium phosphate monobasic | KH₂PO₄ | 137 | 13.3 |
| Citric acid anhydrous | H₃C₆H₅O₇ | 192.14 | 4.5 |
| Magnesium sulfate heptahydrate | MgSO₄•7H₂O | 246 | 0.59 |
| Trace Metals TM5 | | | 2 |
| Glucose | C₆H₁₂O₆ | 500 | 40 |
| Sodium Hydroxide 10M | NaOH | 400 | 5.2 |
| Sucrose 500 g/L | C₁₂H₂₂O₁₁ | 500 | 66.6 |

TABLE 2
Trace Metals TM5 composition

| chemical | Formula | MW | Conc (g/L) |
|---|---|---|---|
| Ferrous Sulfate Heptahydrate | FeSO₄•7H₂0 | 278.02 | 27.8 |
| Calcium Chloride | CaCl₂•2H₂0 | 147 | 2.94 |
| Manganese Chloride | MnCl₂ | 125.84 | 1.26 |
| Zinc Sulfate | ZnSO₄•H₂0 | 179.5 | 1.8 |
| Nickel Chloride | NiC₁₂•6H₂0 | 237.69 | 0.48 |
| Sodium Molybate | Na₂MoO₄•2H₂0 | 241.95 | 0.48 |
| Sodium Selenite | Na₂SeO₃ | 172.94 | 0.35 |
| Boric Acid | H₃BO₃ | 61.83 | 0.12 |

The harvested cells were disrupted in a homogenizer at 14,000 psi pressure in 2 passes. Resulting slurry contained the collagen protein along with other proteins.

The collagen was purified by acid treatment of homogenized cell broth. The pH of the homogenized slurry was decreased to 3 using 6M Hydrochloric acid. Acidified cell slurry was incubated overnight at 4° C. with mixing, followed by centrifugation. Supernatant of the acidified slurry was tested on a polyacrylamide gel and found to contain collagen in relatively high abundance compared to starting pellet. The collagen slurry thus obtained was high in salts. To obtain volume and salt reduction, concentration and diafiltration steps were performed using an EMD Millipore Tangential Flow Filtration system with ultrafiltration cassettes of 0.1 m2 each. Total area of filtration was 0.2 m2 using 2 cassettes in parallel. A volume reduction of 5× and a salt reduction of 19× was achieved in the TFF stage. Final collagen slurry was run on an SDS-PAGE gel to confirm presence of the collagen. This slurry was dried using a multi-tray lyophilizer over 3 days to obtain a white, fluffy collagen powder.

The purified collagen was analyzed on an SDS-PAGE gel and a thick and clear band was observed at the expected size of 42 kilodaltons. The purified collagen was also analyzed by mass spectrometry and it was confirmed that the 42 kilodalton protein was jellyfish collagen.

### Additional Full Length Jellyfish Collagens

A full length jellyfish collagen without a His tag, linker, and thrombin cleavage site is disclosed below. Two codon-optimized nucleotide sequence encoding this collagen are provided in Seq Id No: 6 and Seq Id No: 7. The differences in the nucleotide sequences are due to different codon-optimization strategies but encode the same protein. The amino acid sequence is disclosed in Seq Id No: 8. The DsbA secretion tag is encoded by nucleotides 1-72 and encodes amino acids 1-24. The collagen sequence is encoded by nucleotides 73-1359 and encodes amino acids 25-453.

(Seq Id No: 6)
ATGAAAAAGATTTGGCTGGCGCTGGCTGGTTTAGTTTTAGCGTTTAGC
GCATCGGCGGCGCAGTATGAAGATGGTCCGCAGGGTGTTGTTGGTGCA
GATGGTAAAGACGGTACCCCGGGTGAAAAAGGAGAACAGGGACGTACA
GGTGCAGCAGGTAAACAGGGCAGCCCGGGTGCCGATGGTGCCCGTGGC
CCGCTGGGTAGCATTGGTCAGCAGGGTGCAAGAGGCGAACCGGGCGAT
CCGGGTAGTCCGGGCCTGCGTGGTGATACGGGTCTGGCCGGTGTTAAA
GGCGTTGCAGGTCCTTCAGGTCGTCCAGGTCAACCGGGTGCAAATGGT
CTGCCGGGTGTTAATGGTCGTGGCGGTCTGCGTGGCAAACCGGGAGCA
AAAGGTATTGCAGGTAGCGATGGAGAAGCCGGTGAAAGCGGTGCCCCG
GGTCAGAGTGGTCCGACCGGTCCGCGCGGTCAGCGTGGTCCGTCTGGT
GAAGATGGCAATCCGGGTCTGCAGGGTCTGCCTGGTAGTGATGGCGAA
CCAGGTGAAGAAGGTCAGCCGGGTCGTTCAGGCCAGCCGGGCCAGCAG
GGCCCGCGTGGTAGCCCGGGCGAAGTTGGCCCGCGGGGTAGTAAAGGT
CCTAGTGGCGATCGCGGTGATCGTGGTGAACGCGGTGTTCCTGGTCAG
ACCGGTAGCGCAGGTAATGTTGGCGAAGATGGTGAACAGGGTGGCAAA
GGTGTTGATGGTGCAAGCGGTCCGAGCGGTGCACTGGGTGCACGTGGT
CCTCCGGGCAGCCGTGGTGACACCGGTGCAGTTGGTCCGCCTGGCCCG
ACCGGCCGTAGTGGCTTACCGGGTAATGCAGGTCAGAAAGGTCCGTCA
GGTGAACCTGGCAGCCCTGGTAAAGCAGGTAGTGCCGGTGAGCAGGGT
CCGCCGGGCAAAGATGGTAGTAATGGTGAGCCGGGTAGCCCTGGCAAA
GAAGGTGAACGTGGTCTGGCAGGACCGCCGGGTCCTGATGGTCGCCGC
GGTGAAACGGGTTCACCGGGTATTGCCGGTGCCCTGGGTAAACCAGGT
CTGGAAGGTCCGAAAGGTTATCCTGGTCTGCGCGGTCGTGATGGTACC
AATGGCAAACGTGGCGAACAGGGCGAAACCGGTCCAGATGGTGTTCGT
GGTATTCCGGGTAACGATGGTCAGAGCGGTAAACCGGGCATTGATGGT
ATTGATGGCACCAATGGTCAGCCTGGCGAAGCAGGTTATCAGGGTGGT
CGCGGTACCCGTGGTCAGCTGGGTGAAACAGGTGATGTTGGTCAGAAT
GGTGATCGCGGCGCACCGGGTCCGGATGGTAGCAAAGGTAGCGCCGGT
CGTCCGGGTTTACGTtaa
(Seq Id No: 7)
ATGAAAAAGATTTGGCTGGCGCTGGCTGGTTTAGTTTTAGCGTTTAGC
GCATCGGCGGCGCAGTATGAAGATGGTCCGCAGGGTGTTGTTGGTGCA
GATGGTAAAGACGGTACCCCGGGTGAAAAAGGtGAACAGGGtCGTACc
GGTGCAGCAGGTAAACAGGGCAGCCCGGGTGCCGATGGTGCCCGTGGC
CCGCTGGGTAGCATTGGTCAGCAGGGTGCAcgtGGCGAACCGGGCGAT
CCGGGTAGcCCGGGCCTGCGTGGTGATACGGGTCTGGCCGGTGTTAAA
GGCGTTGCAGGTCCTTCtGGTCGTCCAGGTCAACCGGGTGCAAATGGT
CTGCCGGGTGTTAATGGTCGTGGCGGTCTGCGTGGCAAACCGGGtGCA
AAAGGTATTGCAGGTAGCGATGGcGAAGCCGGTGAAAGCGGTGCCCCG
GGTCAGAGcGGTCCGACCGGTCCGCGCGGTCAGCGTGGTCCGTCTGGT
GAAGATGGCAATCCGGGTCTGCAGGGTCTGCCTGGTagcGATGGCGAA
CCAGGTGAAGAAGGTCAGCCGGGTCGTTCtGGCCAGCCGGGCCAGCAG
GGCCCGCGTGGTAGCCCGGGCGAAGTTGGCCCGCGcGGTtcTAAAGGT
CCTAGcGGCGATCGCGGTGATCGTGGTGAACGCGGTGTTCCTGGTCAG
ACCGGTAGCGCAGGTAATGTTGGCGAAGATGGTGAACAGGGTGGCAAA
GGTGTTGATGGTGCAAGCGGTCCGAGCGGTGCACTGGGTGCACGTGGT
CCTCCGGGCAGCCGTGGTGACACCGGTGCAGTTGGTCCGCCTGGCCCG
ACCGGCCGTAGcGGCctgCCGGGTAATGCAGGTCAGAAAGGTCCGTCt
GGTGAACCTGGCAGCCCTGGTAAAGCAGGTAGcGCCGGTGAGCAGGGT
CCGCCGGGCAAAGATGGTAGcAATGGTGAGCCGGGTAGCCCTGGCAAA
GAAGGTGAACGTGGTCTGGCAGGtCCGCCGGGTCCTGATGGTCGCCGC
GGTGAAACGGGTTCtCCGGGTATTGCCGGTGCCCTGGGTAAACCAGGT
CTGGAAGGTCCGAAAGGTTATCCTGGTCTGCGCGGTCGTGATGGTACC
AATGGCAAACGTGGCGAACAGGGCGAAACCGGTCCAGATGGTGTTCGT
GGTATTCCGGGTAACGATGGTCAGAGCGGTAAACCGGGCATTGATGGT
ATTGATGGCACCAATGGTCAGCCTGGCGAAGCAGGTTATCAGGGTGGT
CGCGGTACCCGTGGTCAGCTGGGTGAAACcGGTGATGTTGGTCAGAAT
GGTGATCGCGGCGCACCGGGTCCGGATGGTAGCAAAGGTAGCGCCGGT
CGTCCGGGTctgCGTtaa
(Seq Id No: 8)
MKKIWLALAGLVLAFSASAAQYEDGPQGVVGADGKDGTPGEKGEQGRT
GAAGKQGSPGADGARGPLGSIGQQGARGEPGDPGSPGLRGDTGLAGVK
GVAGPSGRPGQPGANGLPGVNGRGGLRGKPGAKGIAGSDGEAGESGAP
GQSGPTGPRGQRGPSGEDGNPGLQGLPGSDGEPGEEGQPGRSGQPGQQ
GPRGSPGEVGPRGSKGPSGDRGDRGERGVPGQTGSAGNVGEDGEQGGK
GVDGASGPSGALGARGPPGSRGDTGAVGPPGPTGRSGLPGNAGQKGPS
GEPGSPGKAGSAGEQGPPGKDGSNGEPGSPGKEGERGLAGPPGPDGRR
GETGSPGIAGALGKPGLEGPKGYPGLRGRDGTNGKRGEQGETGPDGVR
GIPGNDGQSGKPGIDGIDGTNGQPGEAGYQGGRGTRGQLGETGDVGQN
GDRGAPGPDGSKGSAGRPGLR

### Example 3: Production of Truncated Collagen

A codon optimized DNA sequence, optimized for expression in E. coli, encoding a jellyfish collagen with a truncation of 240 internal amino acids was synthesized and expressed. The DNA sequence is shown below in Seq Id No: 9. In Seq Id No: 9, The DsbA secretion tag is encoded by nucleotides 1-72 and encodes amino acids 1-24 of Seq Id No: 10. The histidine tag comprising 9 histidine residues (SEQ ID NO: 112) is encoded by nucleotides 73-99 and encodes amino acids 25-33 of Seq Id No: 10. The linker is encoded by nucleotides 100-111 and encodes amino acids 34-37 of Seq Id No: 10. The thrombin cleavage site is encoded by nucleotides 112-135 and encodes amino acids 38-45 of Seq Id No: 10. The truncated collagen is encoded by nucleotides 136-822 and encodes amino acids 46-274 of Seq Id No: 10.

(Seq Id No: 9)
ATGAAAAAGATTTGGCTGGCGCTGGCTGGTTTAGTTTTAGCGTTTAGC
GCATCGGCGGCGCAGTATGAAGATCACCATCACCACCACCACCATCAC
CACTCTGGCTCGAGCCTGGTGCCGCGCGGCAGCCATATGGGTCCGCAG
GGTGTTGTTGGTGCAGATGGTAAAGACGGTACCCCGGGTGAAAAAGGA
GAACAGGGACGTACAGGTGCAGCAGGTAAACAGGGCAGCCCGGGTGCC
GATGGTGCCCGTGGCCCGCTGGGTAGCATTGGTCAGCAGGGTGCAAGA
GGCGAACCGGGCGATCCGGGTAGTCCGGGCCTGCGTGGTGATACGGGT
CTGGCCGGTGTTAAAGGCGTTGCAGGTCCTTCAGGTCGTCCAGGTCAA
CCGGGTGCAAATGGTCTGCCGGGTGTTAATGGTCGTGGCGGTCTGGAA
CGTGGTCTGGCAGGACCGCCGGGTCCTGATGGTCGCCGCGGTGAAACG
GGTTCACCGGGTATTGCCGGTGCCCTGGGTAAACCAGGTCTGGAAGGT
CCGAAAGGTTATCCTGGTCTGCGCGGTCGTGATGGTACCAATGGCAAA
CGTGGCGAACAGGGCGAAACCGGTCCAGATGGTGTTCGTGGTATTCCG
GGTAACGATGGTCAGAGCGGTAAACCGGGCATTGATGGTATTGATGGC
ACCAATGGTCAGCCTGGCGAAGCAGGTTATCAGGGTGGTCGCGGTACC
CGTGGTCAGCTGGGTGAAACAGGTGATGTTGGTCAGAATGGTGATCGC
GGCGCACCGGGTCCGGATGGTAGCAAAGGTAGCGCCGGTCGTCCGGGT
TTACGTtaa

The truncated collagen is approximately 54% of the full length collagen and is disclosed below in Seq ID No: 9.

(Seq Id No: 10)
MKKIWLALAGLVLAFSASAAQYEDHHHHHEIHREISGSSLVPRGSHMG
PQGVVGADGKDGTPGEKGEQGRTGAAGKQGSPGADGARGPLGSIGQQG
ARGEPGDPGSPGLRGDTGLAGVKGVAGPSGRPGQPGANGLPGVNGRGG
LERGLAGPPGPDGRRGETGSPGIAGALGKPGLEGPKGYPGLRGRDGTN
GKRGEQGETGPDGVRGIPGNDGQSGKPGIDGIDGTNGQPGEAGYQGGR
GTRGQLGETGDVGQNGDRGAPGPDGSKGSAGRPGLR

The polynucleotides of Seq ID No: 9 were codon optimized and synthesized by Gen9 DNA, now Gingko Bioworks internal synthesis. Overlaps between the pET28 vector and Seq ID No: 9 were designed to be between 30 and 40 bp long and added using PCR with the enzyme PrimeStar GXL polymerase (http://www.clontech.com/US/Products/PCR/GC_Rich/PrimeSTAR GXL DNA Polymerase?si tex=10020:22372:US). The opened pET28a vector and insert DNA (Seq ID No: 9) was then assembled together into the final plasmid using SGI Gibson assembly (us.vwr.com/store/product/17613857/gibson-assembly-hifi-1-step-kit-synthetic-genomics-inc). Sequence of plasmid was then verified through sanger sequencing through Eurofins Genomics (www.eurofinsgenomics.com).

The transformed cells were cultivated in minimal media and frozen in 1.5 ml aliquots with glycerol at a ratio of 50:50 of cells to glycerol. One vial of this frozen culture was revived in 50 ml of minimal media overnight at 37° C., 200 rpm. Cells were transferred into 300 ml of minimal media and grown for 6-9 hours to reach an OD600 of 5-10.

A bioreactor was prepared with 2.7 L of minimal media+glucose and 300 ml of OD600 of 5-10 culture was added to bring the starting volume to 3 L. Cells were grown at 28° C., pH7 with Dissolved Oxygen maintained at 20% saturation using a cascade containing agitation, air and oxygen. pH was controlled using 28% w/w Ammonium Hydroxide solution. Fermentation was run in a fed-batch mode using a DO-stat based feeding algorithm once the initial bolus of 40 g/L was depleted around 13 hours. After 24-26 hours of initial growth, the OD600 reached above 100. At this point, 300 mL of 500 g/L sucrose was added and temperature was reduced to 25° C. High density culture was induced for protein production using 1 mM IPTG. Fermentation was continued for another 20-24 hours and cells were harvested using a bench top centrifuge at 9000 rcf, 15° C. for 60 minutes. Cell pellet recovered from centrifugation was resuspended in a buffer containing 0.5M NaCl and 0.1M KH2PO4 at pH8 in a weight by weight ratio of 2× buffer to 1× cells.

The harvested cells were disrupted in a homogenizer at 14,000 psi pressure in 2 passes. The resulting slurry contained the collagen protein along with other proteins.

The collagen was purified by acid treatment of homogenized cell broth. Additionally, acid treatment was also performed on non-homogenized whole cells recovered from the bioreactor after centrifugation and resuspension in the buffer described above. The pH of the homogenized slurry of the resuspended whole cells was decreased to 3 using 6M Hydrochloric acid. Acidified cell slurry was incubated overnight at 4° C. with mixing, followed by centrifugation. Supernatant of the acidified slurry was tested on a polyacrylamide gel and found to contain collagen in relatively high abundance compared to starting pellet. The collagen slurry thus obtained was high in salts. To obtain volume and salt reduction, concentration and diafiltration steps were performed using an EMD Millipore Tangential Flow Filtration system with ultrafiltration cassettes of 0.1 m² each. Total area of filtration was 0.2 m² using 2 cassettes in parallel. A volume reduction of 5× and a salt reduction of 19× was achieved in the TFF stage. Final collagen slurry was run on an SDS-PAGE gel to confirm presence of the collagen. This slurry was dried using a multi-tray lyophilizer over 3 days to obtain a white, fluffy collagen powder.

The purified truncated collagen obtained from homogenized cell broth or non-homogenized cells were analyzed on an SDS-PAGE gel and a thick and clear band was observed at the expected size of 27 kilodaltons. The purified collagen was also analyzed by mass spectrometry and it was confirmed that the 27 kilodalton protein was jellyfish collagen.

### Truncated Collagen Without His Tag-Linker-Thrombin Cleavage Site

A truncated jellyfish collagen without a His tag, linker, and thrombin cleavage site is disclosed below. The codon-optimized nucleotide sequence encoding this collagen is provided in Seq Id No: 11. The amino acid sequence is disclosed in Seq Id No: 12. The DsbA secretion tag is encoded by nucleotides 1-72 and encodes amino acids 1-24. The truncated collagen sequence is encoded by nucleotides 73-639 and encodes amino acids 25-213.

(Seq Id. No: 11)
ATGAAAAAGATTTGGCTGGCGCTGGCTGGTTTAGTTTTAGCGTTTAGC
GCATCGGCGGCGCAGTATGAAGATGGTCCGCAGGGTGTTGTTGGTGCA
GATGGTAAAGACGGTACCCCGGGTAATGCAGGTCAGAAAGGTCCGTCA
GGTGAACCTGGCAGCCCTGGTAAAGCAGGTAGTGCCGGTGAGCAGGGT
CCGCCGGGCAAAGATGGTAGTAATGGTGAGCCGGGTAGCCCTGGCAAA
GAAGGTGAACGTGGTCTGGCAGGACCGCCGGGTCCTGATGGTCGCCGC
GGTGAAACGGGTTCACCGGGTATTGCCGGTGCCCTGGGTAAACCAGGT
CTGGAAGGTCCGAAAGGTTATCCTGGTCTGCGCGGTCGTGATGGTACC
AATGGCAAACGTGGCGAACAGGGCGAAACCGGTCCAGATGGTGTTCGT
GGTATTCCGGGTAACGATGGTCAGAGCGGTAAACCGGGCATTGATGGT
ATTGATGGCACCAATGGTCAGCCTGGCGAAGCAGGTTATCAGGGTGGT
CGCGGTACCCGTGGTCAGCTGGGTGAAACAGGTGATGTTGGTCAGAAT
GGTGATCGCGGCGCACCGGGTCCGGATGGTAGCAAAGGTAGCGCCGGT
CGTCCGGGTTTACGTtaa
(Seq Id. No: 12)
MKKIWLALAGLVLAFSASAAQYEDGPQGVVGADGKDGTPGNAGQKGPS
GEPGSPGKAGSAGEQGPPGKDGSNGEPGSPGKEGERGLAGPPGPDGRR
GETGSPGIAGALGKPGLEGPKGYPGLRGRDGTNGKRGEQGETGPDGVR
GIPGNDGQSGKPGIDGIDGTNGQPGEAGYQGGRGTRGQLGETGDVGQN
GDRGAPGPDGSKGSAGRPGLR

### Truncated Collagen With GEK Repeats

A jellyfish collagen with GEK repeats is disclosed below. The codon-optimized nucleotide sequence encoding this collagen is provided in Seq Id No: 13. The amino acid sequence is disclosed in Seq Id No: 14. The DsbA secretion tag is encoded by nucleotides 1-72 and encodes amino acids 1-24. The GEK repeat is encoded by nucleotides 73-126 and encodes the GEK repeats of amino acids 25-42. The truncated collagen sequence is encoded by nucleotides 127-693 and encodes amino acids 43-231.

(Seq Id No: 13)
ATGAAAAAGATTTGGCTGGCGCTGGCTGGTTTAGTTTTAGCGTTTAGC
GCATCGGCGGCGCAGTATGAAGATGGTGAAAAAGGTGAaAAGGGCGAG
AAAGGTGAGAAAGGCGAAAAGGGTGAAAAAGGTCCGCAGGGTGTTGTT
GGTGCAGATGGTAAAGACGGTACCCCGGGTAATGCAGGTCAGAAAGGT
CCGTCAGGTGAACCTGGCAGCCCTGGTAAAGCAGGTAGTGCCGGTGAG
CAGGGTCCGCCGGGCAAAGATGGTAGTAATGGTGAGCCGGGTAGCCCT
GGCAAAGAAGGTGAACGTGGTCTGGCAGGACCGCCGGGTCCTGATGGT
CGCCGCGGTGAAACGGGTTCACCGGGTATTGCCGGTGCCCTGGGTAAA
CCAGGTCTGGAAGGTCCGAAAGGTTATCCTGGTCTGCGCGGTCGTGAT
GGTACCAATGGCAAACGTGGCGAACAGGGCGAAACCGGTCCAGATGGT
GTTCGTGGTATTCCGGGTAACGATGGTCAGAGCGGTAAACCGGGCATT
GATGGTATTGATGGCACCAATGGTCAGCCTGGCGAAGCAGGTTATCAG
GGTGGTCGCGGTACCCGTGGTCAGCTGGGTGAAACAGGTGATGTTGGT
CAGAATGGTGATCGCGGCGCACCGGGTCCGGATGGTAGCAAAGGTAGC
GCCGGTCGTCCGGGTTTACGTtaa
(Seq Id No: 14)
MKKIWLALAGLVLAFSASAAQYEDGEKGEKGEKGEKGEKGEKGPQGVV
GADGKDGTPGNAGQKGPSGEPGSPGKAGSAGEQGPPGKDGSNGEPGSP
GKEGERGLAGPPGPDGRRGETGSPGIAGALGKPGLEGPKGYPGLRGRD
GTNGKRGEQGETGPDGVRGIPGNDGQSGKPGIDGIDGTNGQPGEAGYQ
GGRGTRGQLGETGDVGQNGDRGAPGPDGSKGSAGRPGLR

The polynucleotides of Seq ID No: 13 were codon optimized and synthesized by Gen9 DNA, now Gingko Bioworks internal synthesis. Overlaps between the pET28 vector and Seq ID No: 13 were designed to be between 30 and 40 bp long and added using PCR with the enzyme PrimeStar GXL polymerase (http://www.clontech.com/US/Products/PCR/GC_Rich/PrimeSTAR GXL DNA Polymerase?si tex=10020:22372:US). The opened pET28a vector and insert DNA (Seq ID No: 13) were then assembled together into the final plasmid using SGI Gibson assembly (us.vwr.com/store/product/17613857/gibson-assembly-hifi-1-step-kit-synthetic-genomics-inc). Sequence of plasmid was then verified through Sanger sequencing through Eurofins Genomics (www.eurofinsgenomics.com).

The transformed cells were cultivated in minimal media and frozen in 1.5 ml aliquots with glycerol at a ratio of 50:50 of cells to glycerol. One vial of this frozen culture was revived in 50 ml of minimal media overnight at 37° C., 200 rpm. Cells were transferred into 300 ml of minimal media and grown for 6-9 hours to reach an OD600 of 5-10.

A bioreactor was prepared with 2.7 L of minimal media+glucose and 300 ml of OD600 of 5-10 culture was added to bring the starting volume to 3 L. Cells were grown at 28° C., pH7 with Dissolved Oxygen maintained at 20% saturation using a cascade containing agitation, air and oxygen. pH was controlled using 28% w/w ammonium hydroxide solution. Fermentation was run in a fed-batch mode using a DO-stat based feeding algorithm once the initial bolus of 40 g/L was depleted around 13 hours. After 24-26 hours of initial growth, the OD600 reached above 100. At this point, 300 mL of 500 g/L sucrose was added and temperature was reduced to 25° C. High density culture was induced for protein production using 1 mM IPTG. Fermentation was continued for another 20-24 hours and cells were harvested using a bench top centrifuge at 9000 rcf, 15° C. for 60 minutes. Cell pellet recovered from centrifugation was resuspended in a buffer containing 0.5M NaCl and 0.1M KH2PO4 at pH8 in a weight by weight ratio of 2× buffer to 1× cells.

The harvested cells were disrupted in a homogenizer at 14,000 psi pressure in 2 passes. Resulting slurry contained the collagen protein along with other proteins.

The collagen was purified by acid treatment whole cells recovered from bioreactor after centrifugation and resuspension in a buffer as described above. The pH of either the homogenized slurry or the resuspended suspension was decreased to 3 using 6M Hydrochloric acid. Acidified cell slurry was incubated overnight at 4° C. with mixing, followed by centrifugation. Supernatant of the acidified slurry was tested on a polyacrylamide gel and found to contain collagen in relatively high abundance compared to starting pellet. The collagen slurry thus obtained was high in salts. To obtain volume and salt reduction, concentration and diafiltration steps were performed using an EMD Millipore Tangential Flow Filtration system with ultrafiltration cassettes of 0.1 m² each. Total area of filtration was 0.2 m² using 2 cassettes in parallel. A volume reduction of 5× and a salt reduction of 19× was achieved in the TFF stage. Final collagen slurry was run on an SDS-PAGE gel to confirm presence of the collagen. This slurry was dried using a multi-tray lyophilizer over 3 days to obtain a white, fluffy collagen powder.

The purified collagen was analyzed on an SDS-PAGE gel and was observed to run at an apparent molecular weight of 35 kilodaltons. The 35 kilodalton band does not correspond to the expected size of 22 kilodaltons. The upshift between the expected size and the apparent size is thought to be due to the GEK repeats interacting with the gel matrix. The 35 kd band was confirmed by mass spectrometry to be the correct collagen with the GEK repeats.

### Truncated Collagen With GDK Repeats

A jellyfish collagen with GDK repeats is disclosed below. The codon-optimized nucleotide sequence encoding this collagen is provided in Seq Id No: 15. The amino acid sequence is disclosed in Seq Id No: 16. The DsbA secretion tag is encoded by nucleotides 1-72 and encodes amino acids 1-24. The GDK repeat is encoded by nucleotides 73-126 and encodes the GDK repeats of amino acids 25-42. The truncated collagen sequence is encoded by nucleotides 127-693 and encodes amino acids 43-231.

(Seq Id No: 15)
ATGAAAAAGATTTGGCTGGCGCTGGCTGGTTTAGTTTTAGCGTTTAGC
GCATCGGCGGCGCAGTATGAAGATGGTGATAAAGGTGATAAGGGCGAC
AAAGGTGACAAAGGCGATAAGGGTGATAAAGGTCCGCAGGGTGTTGTT
GGTGCAGATGGTAAAGACGGTACCCCGGGTAATGCAGGTCAGAAAGGT
CCGTCAGGTGAACCTGGCAGCCCTGGTAAAGCAGGTAGTGCCGGTGAG
CAGGGTCCGCCGGGCAAAGATGGTAGTAATGGTGAGCCGGGTAGCCCT
GGCAAAGAAGGTGAACGTGGTCTGGCAGGACCGCCGGGTCCTGATGGT
CGCCGCGGTGAAACGGGTTCACCGGGTATTGCCGGTGCCCTGGGTAAA
CCAGGTCTGGAAGGTCCGAAAGGTTATCCTGGTCTGCGCGGTCGTGAT
GGTACCAATGGCAAACGTGGCGAACAGGGCGAAACCGGTCCAGATGGT
GTTCGTGGTATTCCGGGTAACGATGGTCAGAGCGGTAAACCGGGCATT
GATGGTATTGATGGCACCAATGGTCAGCCTGGCGAAGCAGGTTATCAG
GGTGGTCGCGGTACCCGTGGTCAGCTGGGTGAAACAGGTGATGTTGGT
CAGAATGGTGATCGCGGCGCACCGGGTCCGGATGGTAGCAAAGGTAGC
GCCGGTCGTCCGGGTTTACGTtaa
(Seq Id No: 16)
MKKIWLALAGLVLAFSASAAQYEDGDKGDKGDKGDKGDKGDKGPQGVV
GADGKDGTPGNAGQKGPSGEPGSPGKAGSAGEQGPPGKDGSNGEPGSP
GKEGERGLAGPPGPDGRRGETGSPGIAGALGKPGLEGPKGYPGLRGRD
GTNGKRGEQGETGPDGVRGIPGNDGQSGKPGIDGIDGTNGQPGEAGYQ
GGRGTRGQLGETGDVGQNGDRGAPGPDGSKGSAGRPGLR

The polynucleotides of Seq ID No: 15 was codon optimized and synthesized by Gen9 DNA, now Gingko Bioworks internal synthesis. Overlaps between the pET28 vector and Seq ID No: 15 was designed to be between 30 and 40 bp long and added using PCR with the enzyme PrimeStar GXL polymerase (http://www.clontech.com/US/Products/PCR/GC_Rich/PrimeSTAR GXL DNA Polymerase?si tex=10020:22372:US). The opened pET28a vector and insert DNA (Seq ID No: 15) was then assembled together into the final plasmid using SGI Gibson assembly (us.vwr.com/store/product/17613857/gibson-assembly-hifi-1-step-kit-synthetic-genomics-inc). Sequence of plasmid was then verified through sanger sequencing through Eurofins Genomics (www.eurofinsgenomics.com).

The transformed cells were cultivated in minimal media and frozen in 1.5 ml aliquots with glycerol at a ratio of 50:50 of cells to glycerol. One vial of this frozen culture was revived in 50 ml of minimal media overnight at 37° C., 200 rpm. Cells were transferred into 300 ml of minimal media and grown for 6-9 hours to reach an OD600 of 5-10.

A bioreactor was prepared with 2.7 L of minimal media+glucose and 300 ml of OD600 of 5-10 culture was added to bring the starting volume to 3 L. Cells were grown at 28° C., pH7 with Dissolved Oxygen maintained at 20% saturation using a cascade containing agitation, air and oxygen. pH was controlled using 28% w/w Ammonium Hydroxide solution. Fermentation was run in a fed-batch mode using a DO-stat based feeding algorithm once the initial bolus of 40 g/L was depleted around 13 hours. After 24-26 hours of initial growth, the OD600 reached above 100. At this point, 300 mL of 500 g/L sucrose was added and temperature was reduced to 25° C. High density culture was induced for protein production using 1 mM IPTG. Fermentation was continued for another 20-24 hours and cells were harvested using a bench top centrifuge at 9000 rcf, 15° C. for 60 minutes. Cell pellet recovered from centrifugation was resuspended in a buffer containing 0.5M NaCl and 0.1M KH2PO4 at pH8 in a weight by weight ratio of 2× buffer to 1× cells.

The harvested cells were disrupted in a homogenizer at 14,000 psi pressure in 2 passes. Resulting slurry contained the collagen protein along with other proteins.

The collagen was purified by acid treatment of whole cells recovered from bioreactor after centrifugation and resuspension in a buffer as described above. The pH of either the homogenized slurry was decreased to 3 using 6M Hydrochloric acid. Acidified cell slurry was incubated overnight at 4° C. with mixing, followed by centrifugation. Supernatant of the acidified slurry was tested on a polyacrylamide gel and found to contain collagen in relatively high abundance compared to starting pellet. The collagen slurry thus obtained was high in salts. To obtain volume and salt reduction, concentration and diafiltration steps were performed using an EMD Millipore Tangential Flow Filtration system with ultrafiltration cassettes of 0.1 m² each. Total area of filtration was 0.2 m² using 2 cassettes in parallel. A volume reduction of 5× and a salt reduction of 19× was achieved in the TFF stage. Final collagen slurry was run on an SDS-PAGE gel to confirm presence of the collagen. This slurry was dried using a multi-tray lyophilizer over 3 days to obtain a white, fluffy collagen powder.

The purified collagen was analyzed on an SDS-PAGE gel and was observed to run at an apparent molecular weight of 35 kilodaltons. The 35 kilodalton band does not correspond to the expected size of 22 kilodaltons. The upshift between the expected size and the apparent size is thought to be due to the GDK repeats interacting with the gel matrix. The 35 kd band was confirmed by mass spectrometry to be the correct collagen with the GDK repeats.

Truncated Collagen with DsbA Secretion Tag-His Tag-Linker-Thrombin Cleavage Site and GFP Beta-Lactamase Fusion (Version 1):

A jellyfish collagen with DsbA secretion tag-His tag-Linker-Thrombin cleavage site and GFP Beta-lactamase fusion is disclosed below. The codon-optimized nucleotide sequence encoding this collagen is provided in Seq Id No: 17. The amino acid sequence is disclosed in Seq Id No: 18. The DsbA secretion tag is encoded by nucleotides 1-72 and encodes amino acids 1-24. The His tag is encoded by nucleotides 73-99 and encodes a 9 histidine tag (SEQ ID NO: 112) of amino acids 25-33. The linker is encoded by nucleotides 100-111 and encodes amino acids 34-37. The thrombin cleavage side is encoded by nucleotides 112-135 and encodes amino acids 38-45. The green fluorescent protein (GFP) with linker is encoded by nucleotides 136-873 and encodes amino acids 46-291. The truncated collagen sequence is encoded by nucleotides 874-1440 and encodes amino acids 292-480. The Beta-lactamase with linker is encoded by nucleotides 1441-2232 and encodes amino acids 481-744. The Beta-lactamase was properly targeted to the periplasmic space even though the polypeptide did not have an independent secretion tag. The DsbA secretion tag directed the entire transcript (Truncated Collagen with DsbA secretion tag-His tag-Linker-Thrombin cleavage site and GFP Beta-lactamase fusion protein) to the periplasmic space and the Beta-lactamase functioned properly.

(Seq Id No: 17)
ATGAAAAAGATTTGGCTGGCGCTGGCTGGTTTAGTTTTAGCGTTTAGCG
CATCGGCGGCGCAGTATGAAGATCACCATCACCACCACCACCATCACCA
CTCTGGCTCGAGCCTGGTGCCGCGCGGCAGCCATATGTCTGGCTCGAGC
AGTAAAGGTGAAGAACTGTTCACCGGTGTTGTTCCGATCCTGGTTGAAC
TGGATGGTGATGTTAACGGCCACAAATTCTCTGTTCGTGGTGAAGGTGA
AGGTGATGCAACCAACGGTAAACTGACCCTGAAATTCATCTGCACTACC
GGTAAACTGCCGGTTCCATGGCCGACTCTGGTGACTACCCTGACCTATG
GTGTTCAGTGTTTTTCTCGTTACCCGGATCACATGAAGCAGCATGATTT
CTTCAAATCTGCAATGCCGGAAGGTTATGTACAGGAGCGCACCATTTCT
TTCAAAGACGATGGCACCTACAAAACCCGTGCAGAGGTTAAATTTGAAG
GTGATACTCTGGTGAACCGTATTGAACTGAAAGGCATTGATTTCAAAGA
GGACGGCAACATCCTGGGCCACAAACTGGAATATAACTTCAACTCCCAT
AACGTTTACATCACCGCAGACAAACAGAAGAACGGTATCAAAGCTAACT
TCAAAATTCGCCATAACGTTGAAGACGGTAGCGTACAGCTGGCGGACCA
CTACCAGCAGAACACTCCGATCGGTGATGGTCCGGTTCTGCTGCCGGAT
AACCACTACCTGTCCACCCAGTCTaaaCTGTCCAAAGACCCGAACGAAA
AGCGCGACCACATGGTGCTGCTGGAGTTCGTTACTGCAGCAGGTATCAC
GCACGGCATGGATGAACTCTACAAATCTGGCGCGCCGGGCGGTCCGCAG
GGTGTTGTTGGTGCAGATGGTAAAGACGGTACCCCGGGTAATGCAGGTC
AGAAAGGTCCGTCAGGTGAACCTGGCAGCCCTGGTAAAGCAGGTAGTGC
CGGTGAGCAGGGTCCGCCGGGCAAAGATGGTAGTAATGGTGAGCCGGGT
AGCCCTGGCAAAGAAGGTGAACGTGGTCTGGCAGGACCGCCGGGTCCTG
ATGGTCGCCGCGGTGAAACGGGTTCACCGGGTATTGCCGGTGCCCTGGG
TAAACCAGGTCTGGAAGGTCCGAAAGGTTATCCTGGTCTGCGCGGTCGT
GATGGTACCAATGGCAAACGTGGCGAACAGGGCGAAACCGGTCCAGATG
GTGTTCGTGGTATTCCGGGTAACGATGGTCAGAGCGGTAAACCGGGCAT
TGATGGTATTGATGGCACCAATGGTCAGCCTGGCGAAGCAGGTTATCAG
GGTGGTCGCGGTACCCGTGGTCAGCTGGGTGAAACAGGTGATGTTGGTC
AGAATGGTGATCGCGGCGCACCGGGTCCGGATGGTAGCAAAGGTAGCGC
CGGTCGTCCGGGTTTACGTcacccagaaacgctggtgaaagtaaaagat
gctgaagatcagttgggtgcacgagtgggttacatcgaactggatctca
acagcggtaagatccttgagagttttcgccccgaagaacgttttccaat
gatgagcacttttaaagttctgctatgtggcgcggtattatcccgtatt
gacgccgggcaagagcaactcggtcgccgcatacactattctcagaatg
acttggttgagtactcaccagtcacagaaaagcatcttacggatggcat
gacagtaagagaattatgcagtgctgccataaccatgagtgataacact
gcggccaacttacttctgacaacgatcggaggaccgaaggagctaaccg
cttttttgcacaacatgggggatcatgtaactcgccttgatcgttggga
accggagctgaatgaagccataccaaacgacgagcgtgacaccacgatg
cctgtagcaatggcaacaacgttgcgcaaactattaactggcgaactac
ttactctagcttcccggcaacaattaatagactggatggaggcggataa
agttgcaggaccacttctgcgctcggcccttccggctggctggtttatt
gctgataaatctggagccggtgagcgtgggtctcgcggtatcattgcag
cactggggccagatggtaagccctcccgtatcgtagttatctacacgac
ggggagtcaggcaactatggatgaacgaaatagacagatcgctgagata
ggtgcctcactgattaagcattggtaa
(Seq Id No: 18)
MKKIWLALAGLVLAFSASAAQYEDHHHHEIHEIHHSGSSLVPRGSHMSG
SSSKGEELFTGVVPILVELDGDVNGHKFSVRGEGEGDATNGKLTLKFIC
TTGKLPVPWPTLVTTLTYGVQCFSRYPDHMKQHDFFKSAMPEGYVQERT
ISFKDDGTYKTRAEVKFEGDTLVNRIELKGIDEKEDGNILGHKLEYNEN
SHNVYITADKQKNGIKANFKIRHNVEDGSVQLADHYQQNTPIGDGPVLL
PDNHYLSTQSKLSKDPNEKRDHMVLLEFVTAAGITHGMDELYKSGAPGG
PQGVVGADGKDGTPGNAGQKGPSGEPGSPGKAGSAGEQGPPGKDGSNGE
PGSPGKEGERGLAGPPGPDGRRGETGSPGIAGALGKPGLEGPKGYPGLR
GRDGTNGKRGEQGETGPDGVRGIPGNDGQSGKPGIDGIDGTNGQPGEAG
YQGGRGTRGQLGETGDVGQNGDRGAPGPDGSKGSAGRPGLRHPETLVKV
KDAEDQLGARVGYIELDLNSGKILESFRPEERFPMMSTFKVLLCGAVLS
RIDAGQEQLGRRIHYSQNDLVEYSPVTEKHLTDGMTVRELCSAAITMSD
NTAANLLLTTIGGPKELTAFLHNMGDHVTRLDRWEPELNEAIPNDERDT
TMPVAMATTLRKLLTGELLTLASRQQLIDWMEADKVAGPLLRSALPAGW
FIADKSGAGERGSRGIIAALGPDGKPSRIVVIYTTGSQATMDERNRQIA
EIGASLIKHW

The polynucleotides of Seq ID No: 17 were constructed by assembling several DNA fragments. The collagen containing sequence was codon optimized and synthesized by Gen9 DNA, now Gingko Bioworks internal synthesis. The GFP was also synthesized by Gen9. The Beta-lactamase was cloned out of the plasmid pKD46 (http://cgsc2.biology.yale.edu/Strain.php?ID=68099) using PCR with the enzyme PrimeStar GXL polymerase (http://www.clontech.com/US/Products/PCR/GC_Rich/PrimeSTAR GXL DNA Polymerase?si tex=10020:22372:US). Overlaps between the pET28 vector, GFP, Collagen, and Beta-lactamase were designed to be between 30 and 40 bp long and added using PCR with the enzyme PrimeStar GXL polymerase. The opened pET28a vector and inserts were then assembled together into the final plasmid using SGI Gibson assembly (/us.vwr.com/store/product/17613857/gibson-assembly-hifi-1-step-kit-synthetic-genomics-inc). Sequence of plasmid was then verified through sanger sequencing through Eurofins Genomics (www.eurofinsgenomics.com).

The transformed cells were cultivated in minimal media and frozen in 1.5 ml aliquots with glycerol at a ratio of 50:50 of cells to glycerol. One vial of this frozen culture was revived in 50 ml of minimal media overnight at 37° C., 200 rpm. Cells were transferred into 300 ml of minimal media and grown for 6-9 hours to reach an OD600 of 5-10.

A bioreactor was prepared with 2.7 L of minimal media+glucose and 300 ml of OD600 of 5-10 culture was added to bring the starting volume to 3 L. Cells were grown at 28° C., pH7 with Dissolved Oxygen maintained at 20% saturation using a cascade containing agitation, air and oxygen. pH was controlled using 28% w/w ammonium hydroxide solution. Fermentation was run in a fed-batch mode using a DO-stat based feeding algorithm once the initial bolus of 40 g/L was depleted around 13 hours. After 24-26 hours of initial growth, the OD600 reached above 100. At this point, 300 mL of 500 g/L sucrose was added and temperature was reduced to 25° C. High density culture was induced for protein production using 1 mM IPTG. Fermentation was continued for another 20-24 hours and cells were harvested using a bench top centrifuge at 9000 rcf, 15° C. for 60 minutes. Cell pellet recovered from centrifugation was resuspended in a buffer containing 0.5M NaCl and 0.1M KH2PO4 at pH8 in a weight by weight ratio of 2× buffer to 1× cells.

The harvested cells were disrupted in a homogenizer at 14,000 psi pressure in 2 passes. Resulting slurry contained the collagen protein along with other proteins.

The collagen was purified by acid treatment of non-homogenized whole cells recovered from the bioreactor after centrifugation and resuspension in the buffer described above. The pH of the resuspended suspension was decreased to 3 using 6M Hydrochloric acid. Acidified cell slurry was incubated overnight at 4° C. with mixing, followed by centrifugation. The pH was then raised to 9 using 10N NaOH and the supernatant of the slurry was tested on a polyacrylamide gel and found to contain collagen in relatively high abundance compared to starting pellet. The collagen slurry thus obtained was high in salts. To obtain volume and salt reduction, concentration and diafiltration steps were performed using an EMD Millipore Tangential Flow Filtration system with ultrafiltration cassettes of 0.1 m² each. Total area of filtration was 0.2 m² using 2 cassettes in parallel. A volume reduction of 5× and a salt reduction of 19× was achieved in the TFF stage. Final collagen slurry was run on an SDS-PAGE gel to confirm presence of the collagen. This slurry was dried using a multi-tray lyophilizer over 3 days to obtain a white, fluffy collagen powder.

The purified collagen-GFP-Beta-lactamase fusion protein was analyzed on an SDS-PAGE gel and was observed to run at an apparent molecular weight of 90 kilodaltons. The expected size of the fusion protein is 85 kd. The 90 kd band was confirmed by mass spectrometry to be the correct collagen fusion protein.

Truncated Collagen with DsbA Secretion Tag-His Tag-Linker-Thrombin Cleavage Site and GFP Beta-Lactamase Fusion (Version 2):

A jellyfish collagen with DsbA secretion tag-His tag-Linker-Thrombin cleavage site and GFP Beta-lactamase fusion is disclosed below. The codon-optimized nucleotide sequence encoding this collagen is provided in Seq Id No: 19. The amino acid sequence is disclosed in Seq Id No: 20. The DsbA secretion tag is encoded by nucleotides 1-72 and encodes amino acids 1-24. The His tag is encoded by nucleotides 73-99 and encodes a 9 histidine tag (SEQ ID NO: 112) of amino acids 25-33. The linker is encoded by nucleotides 100-111 and encodes amino acids 34-37. The thrombin cleavage side is encoded by nucleotides 112-135 and encodes amino acids 38-45. The green fluorescent protein (GFP) with linker is encoded by nucleotides 136-873 and encodes amino acids 46-291 The truncated collagen sequence is encoded by nucleotides 874-1440 and encodes amino acids 292-480. The Beta-lactamase with linker is encoded by nucleotides 1441-2232 and encodes amino acids 481-744.

(Seq Id No: 19)
ATGAAAAAGATTTGGCTGGCGCTGGCTGGTTTAGTTTTAGCGTTTAG
CGCATCGGCGGCGCAGTATGAAGATCACCATCACCACCACCACCATC
ACCACTCTGGCTCGAGCCTGGTGCCGCGCGGCAGCCATATGTCTGGC
TCGAGCAGTAAAGGTGAAGAACTGTTCACCGGTGTTGTTCCGATCCT
GGTTGAACTGGATGGTGATGTTAACGGCCACAAATTCTCTGTTCGTG
GTGAAGGTGAAGGTGATGCAACCAACGGTAAACTGACCCTGAAATTC
ATCTGCACTACCGGTAAACTGCCGGTTCCATGGCCGACTCTGGTGAC
TACCCTGACCTATGGTGTTCAGTGTTTTTCTCGTTACCCGGATCACA
TGAAGCAGCATGATTTCTTCAAATCTGCAATGCCGGAAGGTTATGTA
CAGGAGCGCACCATTTCTTTCAAAGACGATGGCACCTACAAAACCCG
TGCAGAGGTTAAATTTGAAGGTGATACTCTGGTGAACCGTATTGAAC
TGAAAGGCATTGATTTCAAAGAGGACGGCAACATCCTGGGCCACAAA
CTGGAATATAACTTCAACTCCCATAACGTTTACATCACCGCAGACAA
ACAGAAGAACGGTATCAAAGCTAACTTCAAAATTCGCCATAACGTTG
AAGACGGTAGCGTACAGCTGGCGGACCACTACCAGCAGAACACTCCG
ATCGGTGATGGTCCGGTTCTGCTGCCGGATAACCACTACCTGTCCAC
CCAGTCTaaaCTGTCCAAAGACCCGAACGAAAAGCGCGACCACATGG
TGCTGCTGGAGTTCGTTACTGCAGCAGGTATCACGCACGGCATGGAT
GAACTCTACAAATCTGGCGCGCCGGGCGGTCCGCAGGGTGTTGTTGG
TGCAGATGGTAAAGACGGTACCCCGGGTAATGCAGGTCAGAAAGGTC
CGTCAGGTGAACCTGGCAGCCCTGGTAAAGCAGGTAGTGCCGGTGAG
CAGGGTCCGCCGGGCAAAGATGGTAGTAATGGTGAGCCGGGTAGCCC
TGGCAAAGAAGGTGAACGTGGTCTGGCAGGACCGCCGGGTCCTGATG
GTCGCCGCGGTGAAACGGGTTCACCGGGTATTGCCGGTGCCCTGGGT
AAACCAGGTCTGGAAGGTCCGAAAGGTTATCCTGGTCTGCGCGGTCG
TGATGGTACCAATGGCAAACGTGGCGAACAGGGCGAAACCGGTCCAG
ATGGTGTTCGTGGTATTCCGGGTAACGATGGTCAGAGCGGTAAACCG
GGCATTGATGGTATTGATGGCACCAATGGTCAGCCTGGCGAAGCAGG
TTATCAGGGTGGTCGCGGTACCCGTGGTCAGCTGGGTGAAACAGGTG
ATGTTGGTCAGAATGGTGATCGCGGCGCACCGGGTCCGGATGGTAGC
AAAGGTAGCGCCGGTCGTCCGGGTTTACGTcacccagaaacgctggt
gaaagtaaaagatgctgaagatcagttgggtgcacgagtgggttaca
tcgaactggatctcaacagcggtaagatccttgagagttttcgcccc
gaagaacgttttccaatgatgagcacttttaaagttctgctatgtgg
cgcggtattatcccgtattgacgccgggcaagagcaactcggtcgcc
gcatacactattctcagaatgacttggttgagtactcaccagtcaca
gaaaagcatcttacggatggcatgacagtaagagaattatgcagtgc
tgccataaccatgagtgataacactgcggccaacttacttctgacaa
cgatcggaggaccgaaggagctaaccgcttttttgcacaacatgggg
gatcatgtaactcgccttgatcgttgggaaccggagctgaatgaagc
cataccaaacgacgagcgtgacaccacgatgcctgtagcaatggcaa
caacgttgcgcaaactattaactggcgaactacttactctagcttcc
cggcaacaattaatagactggatggaggcggataaagttgcaggacc
acttctgcgctcggcccttccggctggctggtttattgctgataaat
ctggagccggtgagcgtgggtctcgcggtatcattgcagcactgggg
ccagatggtaagccctcccgtatcgtagttatctacacgacggggag
tcaggcaactatggatgaacgaaatagacagatcgctgagataggtg
cctcactgattaagcattggtaa
(Seq Id No: 20)
MKKIWLALAGLVLAFSASAAQYEDHHHHEIHEIHHSGSSLVPRGSHM
SGSSSKGEELFTGVVPILVELDGDVNGHKFSVRGEGEGDATNGKLTL
KFICTTGKLPVPWPTLVTTLTYGVQCFSRYPDHMKQHDFFKSAMPEG
YVQERTISFKDDGTYKTRAEVKFEGDTLVNRIELKGIDEKEDGNILG
HKLEYNENSHNVYITADKQKNGIKANFKIRHNVEDGSVQLADHYQQN
TPIGDGPVLLPDNHYLSTQSKLSKDPNEKRDHMVLLEFVTAAGITHG
MDELYKSGAPGGPQGVVGADGKDGTPGNAGQKGPSGEPGSPGKAGSA
GEQGPPGKDGSNGEPGSPGKEGERGLAGPPGPDGRRGETGSPGIAGA
LGKPGLEGPKGYPGLRGRDGTNGKRGEQGETGPDGVRGIPGNDGQSG
KPGIDGIDGTNGQPGEAGYQGGRGTRGQLGETGDVGQNGDRGAPGPD
GSKGSAGRPGLRHPETLVKVKDAEDQLGARVGYIELDLNSGKILESF
RPEERFPMMSTFKVLLCGAVLSRIDAGQEQLGRRIHYSQNDLVEYSP
VTEKHLTDGMTVRELCSAAITMSDNTAANLLLTTIGGPKELTAFLHN
MGDHVTRLDRWEPELNEAIPNDERDTTMPVAMATTLRKLLTGELLTL
ASRQQLIDWMEADKVAGPLLRSALPAGWFIADKSGAGERGSRGIIAA
LGPDGKPSRIVVIYTTGSQATMDERNRQIAEIGASLIKHW

### Example 4: Production of Full-Length Elastin

Full length human elastin were expressed as described below. The wild-type, full length amino acid seauence of human elastin is provided below.

(Seq Id No: 21)
MAGLTAAAPRPGVLLLLLSILHPSRPGGVPGAIPGGVPGGVFYPGAG
LGALGGGALGPGGKPLKPVPGGLAGAGLGAGLGAFPAVTFPGALVPG
GVADAAAAYKAAKAGAGLGGVPGVGGLGVSAGAVVPQPGAGVKPGKV
PGVGLPGVYPGGVLPGARFPGVGVLPGVPTGAGVKPKAPGVGGAFAG
IPGVGPFGGPQPGVPLGYPIKAPKLPGGYGLPYTTGKLPYGYGPGGV
AGAAGKAGYPTGTGVGPQAAAAAAAKAAAKFGAGAAGVLPGVGGAGV
PGVPGAIPGIGGIAGVGTPAAAAAAAAAAKAAKYGAAAGLVPGGPGF
GPGVVGVPGAGVPGVGVPGAGIPVVPGAGIPGAAVPGVVSPEAAAKA
AAKAAKYGARPGVGVGGIPTYGVGAGGFPGFGVGVGGIPGVAGVPGV
GGVPGVGGVPGVGISPEAQAAAAAKAAKYGAAGAGVLGGLVPGPQAA
VPGVPGTGGVPGVGTPAAAAAKAAAKAAQFGLVPGVGVAPGVGVAPG
VGVAPGVGLAPGVGVAPGVGVAPGVGVAPGIGPGGVAAAAKSAAKVA
AKAQLRAAAGLGAGIPGLGVGVGVPGLGVGAGVPGLGVGAGVPGFGA
GADEGVRRSLSPELREGDPSSSQHLPSTPSSPRVPGALAAAKAAKYG
AAVPGVLGGLGALGGVGIPGGVVGAGPAAAAAAAKAAAKAAQFGLVG
AAGLGGLGVGGLGVPGVGGLGGIPPAAAAKAAKYGAAGLGGVLGGAG
QFPLGGVAARPGFGLSPIFPGGACLGKACGRKRK
http://www.uniprot.org/uniprot/P15502

The non-codon optimized polynucleotide sequence encoding the full length elastin is disclosed below. In Seq Id No: 22, nucleotides 1-78 encode the DsbA secretion tag and nucleotides 79-2358 encode the full length human elastin.

(Seq Id No: 22)
ATGGCGGGTCTGACGGCGGCGGCCCCGCGGCCCGGAGTCCTCCTGCT
CCTGCTGTCCATCCTCCACCCCTCTCGGCCTGGAGGGGTCCCTGGGG
CCATTCCTGGTGGAGTTCCTGGAGGAGTCTTTTATCCAGGGGCTGGT
CTCGGAGCCCTTGGAGGAGGAGCGCTGGGGCCTGGAGGCAAACCTCT
TAAGCCAGTTCCCGGAGGGCTTGCGGGTGCTGGCCTTGGGGCAGGGC
TCGGCGCCTTCCCCGCAGTTACCTTTCCGGGGGCTCTGGTGCCTGGT
GGAGTGGCTGACGCTGCTGCAGCCTATAAAGCTGCTAAGGCTGGCGC
TGGGCTTGGTGGTGTCCCAGGAGTTGGTGGCTTAGGAGTGTCTGCAG
GTGCGGTGGTTCCTCAGCCTGGAGCCGGAGTGAAGCCTGGGAAAGTG
CCGGGTGTGGGGCTGCCAGGTGTATACCCAGGTGGCGTGCTCCCAGG
AGCTCGGTTCCCCGGTGTGGGGGTGCTCCCTGGAGTTCCCACTGGAG
CAGGAGTTAAGCCCAAGGCTCCAGGTGTAGGTGGAGCTTTTGCTGGA
ATCCCAGGAGTTGGACCCTTTGGGGGACCGCAACCTGGAGTCCCACT
GGGGTATCCCATCAAGGCCCCCAAGCTGCCTGGTGGCTATGGACTGC
CCTACACCACAGGGAAACTGCCCTATGGCTATGGGCCCGGAGGAGTG
CGCTGGTGCAGCGGGCAAGGCTGGTTACCCAAAGGGACAGGGGTTGG
CCCCCAGGCAGCAGCAGCAGCGGCAGCTAAAGCAGCAGCAAAGTTCG
GTGCTGGAGCAGCCGGAGTCCTCCCTGGTGTTGGAGGGGCTGGTGTT
CCTGGCGTGCCTGGGGCAATTCCTGGAATTGGAGGCATCGCAGGCGT
TGGGACTCCAGCTGCAGCTGCAGCTGCAGCAGCAGCCGCTAAGGCAG
CCAAGTATGGAGCTGCTGCAGGCTTAGTGCCTGGTGGGCCAGGCTTT
GGCCCGGGAGTAGTTGGTGTCCCAGGAGCTGGCGTTCCAGGTGTTGG
TGTCCCAGGAGCTGGGATTCCAGTTGTCCCAGGTGCTGGGATCCCAG
GTGCTGCGGTTCCAGGGGTTGTGTCACCAGAAGCAGCTGCTAAGGCA
GCTGCAAAGGCAGCCAAATACGGGGCCAGGCCCGGAGTCGGAGTTGG
AGGCATTCCTACTTACGGGGTTGGAGCTGGGGGCTTTCCCGGCTTTG
GTGTCGGAGTCGGAGGTATCCCTGGAGTCGCAGGTGTCCCTGGTGTC
GGAGGTGTTCCCGGAGTCGGAGGTGTCCCGGGAGTTGGCATTTCCCC
CGAAGCTCAGGCAGCAGCTGCCGCCAAGGCTGCCAAGTACGGTGCTG
CAGGAGCAGGAGTGCTGGGTGGGCTAGTGCCAGGTCCCCAGGCGGCA
GTCCCAGGTGTGCCGGGCACGGGAGGAGTGCCAGGAGTGGGGACCCC
AGCAGCTGCAGCTGCTAAAGCAGCCGCCAAAGCCGCCCAGTTTGGGT
TAGTTCCTGGTGTCGGCGTGGCTCCTGGAGTTGGCGTGGCTCCTGGT
GTCGGTGTGGCTCCTGGAGTTGGCTTGGCTCCTGGAGTTGGCGTGGC
TCCTGGAGTTGGTGTGGCTCCTGGCGTTGGCGTGGCTCCCGGCATTG
GCCCTGGTGGAGTTGCAGCTGCAGCAAAATCCGCTGCCAAGGTGGCT
GCCAAAGCCCAGCTCCGAGCTGCAGCTGGGCTTGGTGCTGGCATCCC
TGGACTTGGAGTTGGTGTCGGCGTCCCTGGACTTGGAGTTGGTGCTG
GTGTTCCTGGACTTGGAGTTGGTGCTGGTGTTCCTGGCTTCGGGGCA
GGTGCAGATGAGGGAGTTAGGCGGAGCCTGTCCCCTGAGCTCAGGGA
AGGAGATCCCTCCTCCTCTCAGCACCTCCCCAGCACCCCCTCATCAC
CCAGGGTACCTGGAGCCCTGGCTGCCGCTAAAGCAGCCAAATATGGA
GCAGCAGTGCCTGGGGTCCTTGGAGGGCTCGGGGCTCTCGGTGGAGT
AGGCATCCCAGGCGGTGTGGTGGGAGCCGGACCCGCCGCCGCCGCTG
CCGCAGCCAAAGCTGCTGCCAAAGCCGCCCAGTTTGGCCTAGTGGGA
GCCGCTGGGCTCGGAGGACTCGGAGTCGGAGGGCTTGGAGTTCCAGG
TGTTGGGGGCCTTGGAGGTATACCTCCAGCTGCAGCCGCTAAAGCAG
CTAAATACGGTGCTGCTGGCCTTGGAGGTGTCCTAGGGGGTGCCGGGC
AGTTCCCACTTGGAGGAGTGGCAGCAAGACCTGGCTTCGGATTGTCTC
CCATTTTCCCAGGTGGGGCCTGCCTGGGGAAAGCTTGTGGCCGGAAGA
GAAAATGA

Codon Optimized Elastin with DsbA Secretion Tag-His Tag-Linker-Thrombin Cleavage Site

The codon optimized polynucleotide sequence encoding the full length human elastin with DsbA secretion tag-His tag-Linker-Thrombin cleavage site is disclosed below. In Seq Id No: 23: nucleotides 1-72 encode the DsbA secretion tag encoding amino acids 1-24 of Seq Id No: 24; nucleotides 73-99 encode the 9 His tag (SEQ ID NO: 112) encoding amino acids 25-33 of Seq Id No: 24; nucleotides 100-111 encode the linker encoding amino acids 34-37 of Seq Id No: 24; nucleotides 112-135 encode the thrombin cleavage tag encoding amino acids 38-45 of Seq Id No: 24; nucleotides 136-2415 encode the amino acids 46-805 of the full length human elastin of Seq Id No: 24.

(Seq Id No: 23)
ATGAAAAAGATTTGGCTGGCGCTGGCTGGTTTAGTTTTAGCGTTTAG
CGCATCGGCGGCGCAGTATGAAGATCACCATCACCACCACCACCATC
ACCACTCTGGCTCGAGCCTGGTGCCGCGCGGCAGCCATATGGGTGGC
GTACCAGGCGCAATTCCTGGGGGTGTCCCAGGCGGTGTTTTTTATCC
GGGCGCCGGTCTTGGCGCACTGGGTGGCGGTGCACTGGGCCCGGGCG
GCAAACCGCTGAAACCGGTACCAGGTGGTTTAGCAGGCGCCGGCTTA
GGCGCAGGTCTGGGAGCATTTCCGGCAGTTACCTTTCCAGGGGCACT
GGTTCCTGGAGGTGTGGCCGATGCAGCCGCGGCATATAAAGCCGCTA
AAGCCGGTGCGGGTTTAGGAGGCGTCCCAGGTGTCGGTGGCCTGGGT
GTTAGCGCCGGTGCAGTTGTTCCGCAGCCGGGAGCAGGGGTTAAACC
TGGTAAAGTGCCGGGAGTAGGTCTGCCAGGCGTTTATCCTGGTGGTG
TTTTGCCGGGTGCCCGTTTTCCGGGCGTTGGTGTTCTTCCAGGCGTG
CCGACCGGAGCCGGTGTTAAACCGAAAGCCCCCGGTGTTGGAGGTGC
ATTTGCAGGCATCCCGGGAGTTGGCCCGTTTGGTGGTCCGCAACCTG
GGGTTCCGTTAGGTTATCCGATTAAAGCACCGAAACTGCCCGGCGGT
TATGGTCTGCCGTACACAACCGGTAAACTGCCGTATGGTTATGGCCC
GGGTGGAGTTGCGGGTGCAGCAGGTAAAGCGGGTTATCCTACCGGAA
CCGGTGTAGGTCCGCAGGCCGCTGCTGCCGCCGCCGCAAAAGCAGCG
GCTAAATTTGGCGCCGGAGCAGCGGGTGTTCTGCCTGGAGTTGGTGG
TGCGGGCGTGCCAGGGGTACCTGGTGCAATTCCGGGTATTGGTGGTA
TTGCCGGTGTCGGCACCCCGGCCGCGGCAGCTGCGGCAGCGGCGGCT
GCCAAAGCTGCTAAATACGGTGCCGCGGCGGGTCTGGTGCCAGGAGG
TCCGGGTTTTGGTCCGGGAGTGGTTGGCGTGCCTGGCGCAGGCGTTC
CTGGTGTGGGCGTTCCAGGTGCAGGGATTCCTGTTGTGCCTGGTGCC
GGTATTCCCGGCGCGGCCGTTCCGGGGGTGGTTAGCCCGGAAGCCGC
AGCGAAGGCTGCGGCAAAGGCAGCAAAGTATGGCGCACGCCCAGGAG
TCGGCGTGGGTGGTATCCCGACCTATGGGGTGGGCGCAGGGGGTTTT
CCTGGTTTCGGCGTAGGTGTAGGAGGTATACCGGGCGTGGCCGGTGT
ACCAGGGGTTGGTGGCGTCCCTGGTGTTGGCGGTGTGCCAGGTGTTG
GTATTTCACCGGAAGCACAGGCAGCAGCCGCAGCTAAGGCAGCGAAA
TATGGTGCCGCCGGCGCAGGAGTTTTAGGTGGGCTGGTTCCGGGCCC
GCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCA
CAGTTTGGCTTAGTACCGGGTGTGGGAGTTGCCCCCGGCGTTGGCGT
TGCTCCAGGGGTGGGTGTTGCTCCTGGCGTCGGTCTGGCTCCTGGAG
TGGGCGTAGCACCCGGTGTGGGGGTGGCCCCGGGTGTTGGGGTTGCA
CCGGGTATCGGTCCGGGCGGTGTCGCAGCAGCAGCTAAAAGCGCGGC
GAAAGTTGCGGCCAAAGCCCAACTGCGCGCCGCCGCGGGCCTCGGTG
CAGGTATTCCGGGGCTGGGTGTCGGAGTTGGAGTCCCGGGTTTGGGC
GTGGGCGCGGGAGTTCCGGGACTGGGAGTGGGTGCCGGAGTTCCTGG
CTTTGGTGCAGGCGCAGATGAAGGTGTTCGTCGTAGCCTGAGTCCGG
AACTGCGTGAAGGTGATCCGAGTAGCAGCCAGCATCTGCCGAGCACC
CCGAGCAGCCCGCGTGTTCCGGGTGCATTAGCTGCAGCAAAAGCCGC
CAAGTATGGTGCAGCCGTGCCGGGCGTCTTAGGTGGTCTGGGCGCCC
TGGGTGGTGTAGGCATTCCGGGAGGTGTTGTGGGTGCAGGACCGGCC
GCCGCAGCTGCGGCCGCCAAAGCAGCTGCAAAAGCGGCCCAGTTTGG
TTTAGTGGGCGCCGCAGGTTTAGGCGGTTTAGGTGTGGGTGGACTGG
GTGTACCTGGCGTAGGCGGTCTGGGTGGAATTCCGCCCGCAGCGGCC
GCGAAAGCGGCAAAATATGGCGCGGCAGGCCTGGGCGGCGTGCTGGG
TGGGGCAGGTCAGTTTCCGCTGGGCGGGGTTGCCGCACGTCCGGGAT
TTGGTCTGAGCCCGATTTTCCCTGGCGGCGCATGTCTGGGTAAAGCA
TGTGGTCGTAAACGTAAAtaa
(Seq Id No: 24)
MKKIWLALAGLVLAFSASAAQYEDHHHHHHHHHSGSSLVPRGSHMGG
VPGAIPGGVPGGVFYPGAGLGALGGGALGPGGKPLKPVPGGLAGAGL
GAGLGAFPAVTFPGALVPGGVADAAAAYKAAKAGAGLGGVPGVGGLG
VSAGAVVPQPGAGVKPGKVPGVGLPGVYPGGVLPGARFPGVGVLPGV
PTGAGVKPKAPGVGGAFAGIPGVGPFGGPQPGVPLGYPIKAPKLPGG
YGLPYTTGKLPYGYGPGGVAGAAGKAGYPTGTGVGPQAAAAAAAKAA
AKFGAGAAGVLPGVGGAGVPGVPGAIPGIGGIAGVGTPAAAAAAAAA
AKAAKYGAAAGLVPGGPGFGPGVVGVPGAGVPGVGVPGAGIPVVPGA
GIPGAAVPGVVSPEAAAKAAAKAAKYGARPGVGVGGIPTYGVGAGGF
PGFGVGVGGIPGVAGVPGVGGVPGVGGVPGVGISPEAQAAAAAKAAK
YGAAGAGVLGGLVPGPQAAVPGVPGTGGVPGVGTPAAAAAKAAAKAA
QFGLVPGVGVAPGVGVAPGVGVAPGVGLAPGVGVAPGVGVAPGVGVA
PGIGPGGVAAAAKSAAKVAAKAQLRAAAGLGAGIPGLGVGVGVPGLG
VGAGVPGLGVGAGVPGFGAGADEGVRRSLSPELREGDPSSSQHLPST
PSSPRVPGALAAAKAAKYGAAVPGVLGGLGALGGVGIPGGVVGAGPA
AAAAAAKAAAKAAQFGLVGAAGLGGLGVGGLGVPGVGGLGGIPPAAA
AKAAKYGAAGLGGVLGGAGQFPLGGVAARPGFGLSPIFPGGACLGKA
CGRKRK

Codon Optimized Elastin with DsbA Secretion Tag

The codon optimized polynucleotide sequence encoding the full length human elastin with a DsbA secretion tag is disclosed in Seq Id No: 25. In Seq Id No: 25: nucleotides 1-72 encode the DsbA secretion tag encoding amino acids 1-24 of Seq Id No: 26; nucleotides 73-2355 encode the amino acids 25-785 of the full length human elastin of Seq Id No: 26.

(Seq Id No: 25)
ATGAAAAAGATTTGGCTGGCGCTGGCTGGTTTAGTTTTAGCGTTTAG
CGCATCGGCGGCGCAGTATGAAGATATGGGTGGCGTACCAGGCGCAA
TTCCTGGGGGTGTCCCAGGCGGTGTTTTTTATCCGGGCGCCGGTCTT
GGCGCACTGGGTGGCGGTGCACTGGGCCCGGGCGGCAAACCGCTGAA
ACCGGTACCAGGTGGTTTAGCAGGCGCCGGCTTAGGCGCAGGTCTGG
GAGCATTTCCGGCAGTTACCTTTCCAGGGGCACTGGTTCCTGGAGGT
GTGGCCGATGCAGCCGCGGCATATAAAGCCGCTAAAGCCGGTGCGGG
TTTAGGAGGCGTCCCAGGTGTCGGTGGCCTGGGTGTTAGCGCCGGTG
CAGTTGTTCCGCAGCCGGGAGCAGGGGTTAAACCTGGTAAAGTGCCG
GGAGTAGGTCTGCCAGGCGTTTATCCTGGTGGTGTTTTGCCGGGTGC
CCGTTTTCCGGGCGTTGGTGTTCTTCCAGGCGTGCCGACCGGAGCCG
GTGTTAAACCGAAAGCCCCCGGTGTTGGAGGTGCATTTGCAGGCATC
CCGGGAGTTGGCCCGTTTGGTGGTCCGCAACCTGGGGTTCCGTTAGG
TTATCCGATTAAAGCACCGAAACTGCCCGGCGGTTATGGTCTGCCGT
ACACAACCGGTAAACTGCCGTATGGTTATGGCCCGGGTGGAGTTGCG
GGTGCAGCAGGTAAAGCGGGTTATCCTACCGGAACCGGTGTAGGTCC
GCAGGCCGCTGCTGCCGCCGCCGCAAAAGCAGCGGCTAAATTTGGCG
CCGGAGCAGCGGGTGTTCTGCCTGGAGTTGGTGGTGCGGGCGTGCCA
GGGGTACCTGGTGCAATTCCGGGTATTGGTGGTATTGCCGGTGTCGG
CACCCCGGCCGCGGCAGCTGCGGCAGCGGCGGCTGCCAAAGCTGCTA
AATACGGTGCCGCGGCGGGTCTGGTGCCAGGAGGTCCGGGTTTTGGT
CCGGGAGTGGTTGGCGTGCCTGGCGCAGGCGTTCCTGGTGTGGGCGT
TCCAGGTGCAGGGATTCCTGTTGTGCCTGGTGCCGGTATTCCCGGCG
CGGCCGTTCCGGGGGTGGTTAGCCCGGAAGCCGCAGCGAAGGCTGCG
GCAAAGGCAGCAAAGTATGGCGCACGCCCAGGAGTCGGCGTGGGTGG
TATCCCGACCTATGGGGTGGGCGCAGGGGGTTTTCCTGGTTTCGGCG
TAGGTGTAGGAGGTATACCGGGCGTGGCCGGTGTACCAGGGGTTGGT
GGCGTCCCTGGTGTTGGCGGTGTGCCAGGTGTTGGTATTTCACCGGA
AGCACAGGCAGCAGCCGCAGCTAAGGCAGCGAAATATGGTGCCGCCG
GCGCAGGAGTTTTAGGTGGGCTGGTTCCGGGCCCGCAGGCAGCTGTG
CCGGGGGTTCCAGGCACCGGTGGTGTCCCTGGAGTCGGTACGCCGGC
TGCAGCGGCAGCCAAAGCGGCTGCGAAAGCAGCACAGTTTGGCTTAG
TACCGGGTGTGGGAGTTGCCCCCGGCGTTGGCGTTGCTCCAGGGGTG
GGTGTTGCTCCTGGCGTCGGTCTGGCTCCTGGAGTGGGCGTAGCACC
CGGTGTGGGGGTGGCCCCGGGTGTTGGGGTTGCACCGGGTATCGGTC
CGGGCGGTGTCGCAGCAGCAGCTAAAAGCGCGGCGAAAGTTGCGGCC
AAAGCCCAACTGCGCGCCGCCGCGGGCCTCGGTGCAGGTATTCCGGG
GCTGGGTGTCGGAGTTGGAGTCCCGGGTTTGGGCGTGGGCGCGGGAG
TTCCGGGACTGGGAGTGGGTGCCGGAGTTCCTGGCTTTGGTGCAGGC
GCAGATGAAGGTGTTCGTCGTAGCCTGAGTCCGGAACTGCGTGAAGG
TGATCCGAGTAGCAGCCAGCATCTGCCGAGCACCCCGAGCAGCCCGC
GTGTTCCGGGTGCATTAGCTGCAGCAAAAGCCGCCAAGTATGGTGCA
GCCGTGCCGGGCGTCTTAGGTGGTCTGGGCGCCCTGGGTGGTGTAGG
CATTCCGGGAGGTGTTGTGGGTGCAGGACCGGCCGCCGCAGCTGCGG
CCGCCAAAGCAGCTGCAAAAGCGGCCCAGTTTGGTTTAGTGGGCGCC
GCAGGTTTAGGCGGTTTAGGTGTGGGTGGACTGGGTGTACCTGGCGT
AGGCGGTCTGGGTGGAATTCCGCCCGCAGCGGCCGCGAAAGCGGCAA
AATATGGCGCGGCAGGCCTGGGCGGCGTGCTGGGTGGGGCAGGTCAG
TTTCCGCTGGGCGGGGTTGCCGCACGTCCGGGATTTGGTCTGAGCCC
GATTTTCCCTGGCGGCGCATGTCTGGGTAAAGCATGTGGTCGTAAAC
GTAAAtaa
(Seq Id No: 26)
MKKIWLALAGLVLAFSASAAQYEDMGGVPGAIPGGVPGGVFYPGAGL
GALGGGALGPGGKPLKPVPGGLAGAGLGAGLGAFPAVTFPGALVPGG
VADAAAAYKAAKAGAGLGGVPGVGGLGVSAGAVVPQPGAGVKPGKVP
GVGLPGVYPGGVLPGARFPGVGVLPGVPTGAGVKPKAPGVGGAFAGI
PGVGPFGGPQPGVPLGYPIKAPKLPGGYGLPYTTGKLPYGYGPGGVA
GAAGKAGYPTGTGVGPQAAAAAAAKAAAKFGAGAAGVLPGVGGAGVP
GVPGAIPGIGGIAGVGTPAAAAAAAAAAKAAKYGAAAGLVPGGPGFG
PGVVGVPGAGVPGVGVPGAGIPVVPGAGIPGAAVPGVVSPEAAAKAA
AKAAKYGARPGVGVGGIPTYGVGAGGFPGFGVGVGGIPGVAGVPGVG
GVPGVGGVPGVGISPEAQAAAAAKAAKYGAAGAGVLGGLVPGPQAAV
PGVPGTGGVPGVGTPAAAAAKAAAKAAQFGLVPGVGVAPGVGVAPGV
GVAPGVGLAPGVGVAPGVGVAPGVGVAPGIGPGGVAAAAKSAAKVAA
KAQLRAAAGLGAGIPGLGVGVGVPGLGVGAGVPGLGVGAGVPGFGAG
ADEGVRRSLSPELREGDPSSSQHLPSTPSSPRVPGALAAAKAAKYGA
AVPGVLGGLGALGGVGIPGGVVGAGPAAAAAAAKAAAKAAQFGLVGA
AGLGGLGVGGLGVPGVGGLGGIPPAAAAKAAKYGAAGLGGVLGGAGQ
FPLGGVAARPGFGLSPIFPGGACLGKACGRKRK

The polynucleotides of Seq ID No: 22 were codon optimized and synthesized by Gen9 DNA, now Gingko Bioworks internal synthesis. Overlaps between the pET28 vector and Seq ID No: 22 were designed to be between 30 and 40 bp long and added using PCR with the enzyme PrimeStar GXL polymerase (http://www.clontech.com/US/Products/PCR/GC_Rich/PrimeSTAR GXL DNA Polymerase?si tex=10020:22372:US). The opened pET28a vector and insert DNA (Seq ID No: 22) was then assembled together into the final plasmid using SGI Gibson assembly (us.vwr.com/store/product/17613857/gibson-assembly-hifi-1-step-kit-synthetic-genomics-inc). Sequence of plasmid was then verified through sanger sequencing through Eurofins Genomics (www.eurofinsgenomics.com).

The transformed cells were cultivated in minimal media and frozen in 1.5 ml aliquots with glycerol at a ratio of 50:50 of cells to glycerol. One vial of this frozen culture was revived in 50 ml of minimal media overnight at 37° C., 200 rpm. Cells were transferred into 300 ml of minimal media and grown for 6-9 hours to reach an OD600 of 5-10.

A bioreactor was prepared with 2.7 L of minimal media+glucose and 300 ml of OD600 of 5-10 culture was added to bring the starting volume to 3 L. Cells were grown at 28° C., pH7 with Dissolved Oxygen maintained at 20% saturation using a cascade containing agitation, air and oxygen. pH was controlled using 28% w/w ammonium hydroxide solution. Fermentation was run in a fed-batch mode using a DO-stat based feeding algorithm once the initial bolus of 40 g/L was depleted around 13 hours. After 24-26 hours of initial growth, the OD600 reached above 100. At this point, 300 mL of 500 g/L sucrose was added and temperature was reduced to 25° C. High density culture was induced for protein production using 1 mM IPTG. Fermentation was continued for another 20-24 hours and cells were harvested using a bench top centrifuge at 9000 rcf, 15° C. for 60 minutes. Cell pellet recovered from centrifugation was resuspended in a buffer containing 0.5M NaCl and 0.1M KH2PO4 at pH8 in a weight by weight ratio of 2× buffer to 1× cells.

The harvested cells were disrupted in a homogenizer at 14,000 psi pressure in 2 passes. Resulting slurry contained the collagen protein along with other proteins.

The supernatant from the homogenized cells was analyzed on an SDS-PAGE gel and a clear band was observed at around 70 kilodaltons corresponding to the expected size of 68 kilodaltons. The purified elastin is analyzed by mass spectrometry.

Full Length Elastin with DsbA Secretion Tag-His Tag-Linker-Thrombin Cleavage Site and GFP Beta-Lactamase Fusion

A human elastin with DsbA secretion tag-His tag-Linker-Thrombin cleavage site and GFP Beta-lactamase fusion is disclosed below. The codon-optimized nucleotide sequence encoding this elastin is provided in Seq Id No: 27. The amino acid sequence is disclosed in Seq Id No: 28. The DsbA secretion tag is encoded by nucleotides 1-72 and encodes amino acids 1-24. The His tag is encoded by nucleotides 73-99 and encodes a 9 histidine tag (SEQ ID NO: 112) of amino acids 25-33. The linker is encoded by nucleotides 100-111 and encodes amino acids 34-37. The thrombin cleavage side is encoded by nucleotides 112-135 and encodes amino acids 38-45. The green fluorescent protein (GFP) with linker is encoded by nucleotides 136-873 and encodes amino acids 46-291. The full-length elastin sequence is encoded by nucleotides 874-3153 and encodes amino acids 292-1051. The Beta-lactamase with linker is encoded by nucleotides 3154-3945 and encodes amino acids 1052-1315.

(Seq Id No: 27)
ATGAAAAAGATTTGGCTGGCGCTGGCTGGTTTAGTTTTAGCGTTTAG
CGCATCGGCGGCGCAGTATGAAGATCACCATCACCACCACCACCATC
ACCACTCTGGCTCGAGCCTGGTGCCGCGCGGCAGCCATATGTCTGGC
TCGAGCAGTAAAGGTGAAGAACTGTTCACCGGTGTTGTTCCGATCCT
GGTTGAACTGGATGGTGATGTTAACGGCCACAAATTCTCTGTTCGTG
GTGAAGGTGAAGGTGATGCAACCAACGGTAAACTGACCCTGAAATTC
ATCTGCACTACCGGTAAACTGCCGGTTCCATGGCCGACTCTGGTGAC
TACCCTGACCTATGGTGTTCAGTGTTTTTCTCGTTACCCGGATCACA
TGAAGCAGCATGATTTCTTCAAATCTGCAATGCCGGAAGGTTATGTA
CAGGAGCGCACCATTTCTTTCAAAGACGATGGCACCTACAAAACCCG
TGCAGAGGTTAAATTTGAAGGTGATACTCTGGTGAACCGTATTGAAC
TGAAAGGCATTGATTTCAAAGAGGACGGCAACATCCTGGGCCACAAA
CTGGAATATAACTTCAACTCCCATAACGTTTACATCACCGCAGACAA
ACAGAAGAACGGTATCAAAGCTAACTTCAAAATTCGCCATAACGTTG
AAGACGGTAGCGTACAGCTGGCGGACCACTACCAGCAGAACACTCCG
ATCGGTGATGGTCCGGTTCTGCTGCCGGATAACCACTACCTGTCCAC
CCAGTCTaaaCTGTCCAAAGACCCGAACGAAAAGCGCGACCACATGG
TGCTGCTGGAGTTCGTTACTGCAGCAGGTATCACGCACGGCATGGAT
GAACTCTACAAATCTGGCGCGCCGGGCGGTGGCGTACCAGGCGCAAT
TCCTGGGGGTGTCCCAGGCGGTGTTTTTTATCCGGGCGCCGGTCTTG
GCGCACTGGGTGGCGGTGCACTGGGCCCGGGCGGCAAACCGCTGAAA
CCGGTACCAGGTGGTTTAGCAGGCGCCGGCTTAGGCGCAGGTCTGGG
AGCATTTCCGGCAGTTACCTTTCCAGGGGCACTGGTTCCTGGAGGTG
TGGCCGATGCAGCCGCGGCATATAAAGCCGCTAAAGCCGGTGCGGGT
TTAGGAGGCGTCCCAGGTGTCGGTGGCCTGGGTGTTAGCGCCGGTGC
AGTTGTTCCGCAGCCGGGAGCAGGGGTTAAACCTGGTAAAGTGCCGG
GAGTAGGTCTGCCAGGCGTTTATCCTGGTGGTGTTTTGCCGGGTGCC
CGTTTTCCGGGCGTTGGTGTTCTTCCAGGCGTGCCGACCGGAGCCGG
TGTTAAACCGAAAGCCCCCGGTGTTGGAGGTGCATTTGCAGGCATCC
CGGGAGTTGGCCCGTTTGGTGGTCCGCAACCTGGGGTTCCGTTAGGT
TATCCGATTAAAGCACCGAAACTGCCCGGCGGTTATGGTCTGCCGTA
CACAACCGGTAAACTGCCGTATGGTTATGGCCCGGGTGGAGTTGCGG
GTGCAGCAGGTAAAGCGGGTTATCCTACCGGAACCGGTGTAGGTCCG
CAGGCCGCTGCTGCCGCCGCCGCAAAAGCAGCGGCTAAATTTGGCGC
CGGAGCAGCGGGTGTTCTGCCTGGAGTTGGTGGTGCGGGCGTGCCAG
GGGTACCTGGTGCAATTCCGGGTATTGGTGGTATTGCCGGTGTCGGC
ACCCCGGCCGCGGCAGCTGCGGCAGCGGCGGCTGCCAAAGCTGCTAA
ATACGGTGCCGCGGCGGGTCTGGTGCCAGGAGGTCCGGGTTTTGGTC
CGGGAGTGGTTGGCGTGCCTGGCGCAGGCGTTCCTGGTGTGGGCGTT
CCAGGTGCAGGGATTCCTGTTGTGCCTGGTGCCGGTATTCCCGGCGC
GGCCGTTCCGGGGGTGGTTAGCCCGGAAGCCGCAGCGAAGGCTGCGG
CAAAGGCAGCAAAGTATGGCGCACGCCCAGGAGTCGGCGTGGGTGGT
ATCCCGACCTATGGGGTGGGCGCAGGGGGTTTTCCTGGTTTCGGCGT
AGGTGTAGGAGGTATACCGGGCGTGGCCGGTGTACCAGGGGTTGGTG
GCGTCCCTGGTGTTGGCGGTGTGCCAGGTGTTGGTATTTCACCGGAA
GCACAGGCAGCAGCCGCAGCTAAGGCAGCGAAATATGGTGCCGCCGG
CGCAGGAGTTTTAGGTGGGCTGGTTCCGGGCCCGCAGGCAGCTGTGC
CGGGGGTTCCAGGCACCGGTGGTGTCCCTGGAGTCGGTACGCCGGCT
GCAGCGGCAGCCAAAGCGGCTGCGAAAGCAGCACAGTTTGGCTTAGT
ACCGGGTGTGGGAGTTGCCCCCGGCGTTGGCGTTGCTCCAGGGGTGG
GTGTTGCTCCTGGCGTCGGTCTGGCTCCTGGAGTGGGCGTAGCACCC
GGTGTGGGGGTGGCCCCGGGTGTTGGGGTTGCACCGGGTATCGGTCC
GGGCGGTGTCGCAGCAGCAGCTAAAAGCGCGGCGAAAGTTGCGGCCA
AAGCCCAACTGCGCGCCGCCGCGGGCCTCGGTGCAGGTATTCCGGGG
CTGGGTGTCGGAGTTGGAGTCCCGGGTTTGGGCGTGGGCGCGGGAGT
TCCGGGACTGGGAGTGGGTGCCGGAGTTCCTGGCTTTGGTGCAGGCG
CAGATGAAGGTGTTCGTCGTAGCCTGAGTCCGGAACTGCGTGAAGGT
GATCCGAGTAGCAGCCAGCATCTGCCGAGCACCCCGAGCAGCCCGCG
TGTTCCGGGTGCATTAGCTGCAGCAAAAGCCGCCAAGTATGGTGCAG
CCGTGCCGGGCGTCTTAGGTGGTCTGGGCGCCCTGGGTGGTGTAGGC
ATTCCGGGAGGTGTTGTGGGTGCAGGACCGGCCGCCGCAGCTGCGGC
CGCCAAAGCAGCTGCAAAAGCGGCCCAGTTTGGTTTAGTGGGCGCCG
CAGGTTTAGGCGGTTTAGGTGTGGGTGGACTGGGTGTACCTGGCGTA
GGCGGTCTGGGTGGAATTCCGCCCGCAGCGGCCGCGAAAGCGGCAAA
ATATGGCGCGGCAGGCCTGGGCGGCGTGCTGGGTGGGGCAGGTCAGT
TTCCGCTGGGCGGGGTTGCCGCACGTCCGGGATTTGGTCTGAGCCCG
ATTTTCCCTGGCGGCGCATGTCTGGGTAAAGCATGTGGTCGTAAACG
TAAAcacccagaaacgctggtgaaagtaaaagatgctgaagatcagt
tgggtgcacgagtgggttacatcgaactggatctcaacagcggtaag
atccttgagagttttcgccccgaagaacgttttccaatgatgagcac
ttttaaagttctgctatgtggcgcggtattatcccgtattgacgccg
ggcaagagcaactcggtcgccgcatacactattctcagaatgacttg
gttgagtactcaccagtcacagaaaagcatcttacggatggcatgac
agtaagagaattatgcagtgctgccataaccatgagtgataacactg
cggccaacttacttctgacaacgatcggaggaccgaaggagctaacc
gcttttttgcacaacatgggggatcatgtaactcgccttgatcgttg
ggaaccggagctgaatgaagccataccaaacgacgagcgtgacacca
cgatgcctgtagcaatggcaacaacgttgcgcaaactattaactggc
gaactacttactctagatcccggcaacaattaatagactggatggag
gcggataaagttgcaggaccacttctgcgctcggcccttccggctgg
ctggtttattgctgataaatctggagccggtgagcgtgggtctcgcg
gtatcattgcagcactggggccagatggtaagccctcccgtatcgta
gttatctacacgacggggagtcaggcaactatggatgaacgaaatag
acagatcgctgagataggtgcctcactgattaagcattggtaa
(Seq Id No: 28)
MKKIWLALAGLVLAFSASAAQYEDHHHHEIHEIHHSGSSLVPRGSHM
SGSSSKGEELFTGVVPILVELDGDVNGHKFSVRGEGEGDATNGKLTL
KFICTTGKLPVPWPTLVTTLTYGVQCFSRYPDHMKQHDFFKSAMPEG
YVQERTISFKDDGTYKTRAEVKFEGDTLVNRIELKGIDEKEDGNILG
HKLEYNENSHNVYITADKQKNGIKANFKIRHNVEDGSVQLADHYQQN
TPIGDGPVLLPDNHYLSTQSKLSKDPNEKRDHMVLLEFVTAAGITHG
MDELYKSGAPGGGVPGAIPGGVPGGVEYPGAGLGALGGGALGPGGKP
LKPVPGGLAGAGLGAGLGAFPAVTFPGALVPGGVADAAAAYKAAKAG
AGLGGVPGVGGLGVSAGAVVPQPGAGVKPGKVPGVGLPGVYPGGVLP
GARFPGVGVLPGVPTGAGVKPKAPGVGGAFAGIPGVGPFGGPQPGVP
LGYPIKAPKLPGGYGLPYTTGKLPYGYGPGGVAGAAGKAGYPTGTGV
GPQAAAAAAAKAAAKFGAGAAGVLPGVGGAGVPGVPGAIPGIGGIAG
VGTPAAAAAAAAAAKAAKYGAAAGLVPGGPGFGPGVVGVPGAGVPGV
GVPGAGIPVVPGAGIPGAAVPGVVSPEAAAKAAAKAAKYGARPGVGV
GGIPTYGVGAGGFPGEGVGVGGIPGVAGVPGVGGVPGVGGVPGVGIS
PEAQAAAAAKAAKYGAAGAGVLGGLVPGPQAAVPGVPGTGGVPGVGT
PAAAAAKAAAKAAQFGLVPGVGVAPGVGVAPGVGVAPGVGLAPGVGV
APGVGVAPGVGVAPGIGPGGVAAAAKSAAKVAAKAQLRAAAGLGAGI
PGLGVGVGVPGLGVGAGVPGLGVGAGVPGFGAGADEGVRRSLSPELR
EGDPSSSQHLPSTPSSPRVPGALAAAKAAKYGAAVPGVLGGLGALGG
VGIPGGVVGAGPAAAAAAAKAAAKAAQFGLVGAAGLGGLGVGGLGVP
GVGGLGGIPPAAAAKAAKYGAAGLGGVLGGAGQFPLGGVAARPGEGL
SPIFPGGACLGKACGRKRKHPETLVKVKDAEDQLGARVGYIELDLNS
GKILESFRPEERFPMMSTFKVLLCGAVLSRIDAGQEQLGRRIHYSQN
DLVEYSPVTEKHLTDGMTVRELCSAAITMSDNTAANLLLTTIGGPKE
LTAFLHNMGDHVTRLDRWEPELNEAIPNDERDTTMPVAMATTLRKLL
TGELLTLASRQQLIDWMEADKVAGPLLRSALPAGWFIADKSGAGERG
SRGITAALGPDGKPSRIVVIYTTGSQATMDERNRQIAEIGASLIKHW

### Example 5: Production of Truncated Elastin

Truncated human elastin is produced using the expression system as described in Example 4. The full length amino acid sequence lacking the native secretion tag is disclosed in Seq Id No: 29.

(Seq Id No: 29)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTPAAAAAKAAAKAAQFGLVPGVGVAPGVGVA
PGVGVAPGVGLAPGVGVAPGVGVAPGVGVAPGIGPGGVAAAAKSAAKVA
AKAQLRAAAGLGAGIPGLGVGVGVPGLGVGAGVPGLGVGAGVPGFGAGA
DEGVRRSLSPELREGDPSSSQHLPSTPSSPRVPGALAAAKAAKYGAAVP
GVLGGLGALGGVGIPGGVVGAGPAAAAAAAKAAAKAAQFGLVGAAGLGG
LGVGGLGVPGVGGLGGIPPAAAAKAAKYGAAGLGGVLGGAGQFPLGGVA
ARPGFGLSPIFPGGACLGKACGRKRK

The codon optimized polynucleotide sequence encoding the full length human elastin lacking the native secretion tag is disclosed in Seq Id No: 30.

(Seq Id No: 30)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCACA
GTTTGGCTTAGTACCGGGTGTGGGAGTTGCCCCCGGCGTTGGCGTTGCT
CCAGGGGTGGGTGTTGCTCCTGGCGTCGGTCTGGCTCCTGGAGTGGGCG
TAGCACCCGGTGTGGGGGTGGCCCCGGGTGTTGGGGTTGCACCGGGTAT
CGGTCCGGGCGGTGTCGCAGCAGCAGCTAAAAGCGCGGCGAAAGTTGCG
GCCAAAGCCCAACTGCGCGCCGCCGCGGGCCTCGGTGCAGGTATTCCGG
GGCTGGGTGTCGGAGTTGGAGTCCCGGGTTTGGGCGTGGGCGCGGGAGT
TCCGGGACTGGGAGTGGGTGCCGGAGTTCCTGGCTTTGGTGCAGGCGCA
GATGAAGGTGTTCGTCGTAGCCTGAGTCCGGAACTGCGTGAAGGTGATC
CGAGTAGCAGCCAGCATCTGCCGAGCACCCCGAGCAGCCCGCGTGTTCC
GGGTGCATTAGCTGCAGCAAAAGCCGCCAAGTATGGTGCAGCCGTGCCG
GGCGTCTTAGGTGGTCTGGGCGCCCTGGGTGGTGTAGGCATTCCGGGAG
GTGTTGTGGGTGCAGGACCGGCCGCCGCAGCTGCGGCCGCCAAAGCAGC
TGCAAAAGCGGCCCAGTTTGGTTTAGTGGGCGCCGCAGGTTTAGGCGGT
TTAGGTGTGGGTGGACTGGGTGTACCTGGCGTAGGCGGTCTGGGTGGAA
TTCCGCCCtaa

The amino acid sequence of a 60.7 KD human elastin truncated at the C-terminal is disclosed in Seq Id No: 31. The 60.7 KD truncated elastin has amino acids 706-761 deleted from the full length elastin.

Seq Id No: 31
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTPAAAAAKAAAKAAQFGLVPGVGVAPGVGVA
PGVGVAPGVGLAPGVGVAPGVGVAPGVGVAPGIGPGGVAAAAKSAAKVA
AKAQLRAAAGLGAGIPGLGVGVGVPGLGVGAGVPGLGVGAGVPGFGAGA
DEGVRRSLSPELREGDPSSSQHLPSTPSSPRVPGALAAAKAAKYGAAVP
GVLGGLGALGGVGIPGGVVGAGPAAAAAAAKAAAKAAQFGLVGAAGLGG
LGVGGLGVPGVGGLGGIPP

The codon optimized polynucleotide sequence encoding the truncated 60.7 KD human elastin is disclosed in Seq Id No: 32.

(Seq Id No: 32)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCACA
GTTTGGCTTAGTACCGGGTGTGGGAGTTGCCCCCGGCGTTGGCGTTGCT
CCAGGGGTGGGTGTTGCTCCTGGCGTCGGTCTGGCTCCTGGAGTGGGCG
TAGCACCCGGTGTGGGGGTGGCCCCGGGTGTTGGGGTTGCACCGGGTAT
CGGTCCGGGCGGTGTCGCAGCAGCAGCTAAAAGCGCGGCGAAAGTTGCG
GCCAAAGCCCAACTGCGCGCCGCCGCGGGCCTCGGTGCAGGTATTCCGG
GGCTGGGTGTCGGAGTTGGAGTCCCGGGTTTGGGCGTGGGCGCGGGAGT
TCCGGGACTGGGAGTGGGTGCCGGAGTTCCTGGCTTTGGTGCAGGCGCA
GATGAAGGTGTTCGTCGTAGCCTGAGTCCGGAACTGCGTGAAGGTGATC
CGAGTAGCAGCCAGCATCTGCCGAGCACCCCGAGCAGCCCGCGTGTTCC
GGGTGCATTAGCTGCAGCAAAAGCCGCCAAGTATGGTGCAGCCGTGCCG
GGCGTCTTAGGTGGTCTGGGCGCCCTGGGTGGTGTAGGCATTCCGGGAG
GTGTTGTGGGTGCAGGACCGGCCGCCGCAGCTGCGGCCGCCAAAGCAGC
TGCAAAAGCGGCCCAGTTTGGTTTAGTGGGCGCCGCAGGTTTAGGCGGT
TTAGGTGTGGGTGGACTGGGTGTACCTGGCGTAGGCGGTCTGGGTGGAA
TTCCGCCCtaa

The amino acid sequence of a 58.8 KD human elastin truncated at the N-terminal is disclosed in Seq Id No: 33. The 58.8 KD truncated elastin has amino acids 2-85 deleted from the full length elastin.

(Seq Id No: 33)
MGLGGVPGVGGLGVSAGAVVPQPGAGVKPGKVPGVGLPGVYPGGVLPGA
RFPGVGVLPGVPTGAGVKPKAPGVGGAFAGIPGVGPFGGPQPGVPLGYP
IKAPKLPGGYGLPYTTGKLPYGYGPGGVAGAAGKAGYPTGTGVGPQAAA
AAAAKAAAKFGAGAAGVLPGVGGAGVPGVPGAIPGIGGIAGVGTPAAAA
AAAAAAKAAKYGAAAGLVPGGPGFGPGVVGVPGAGVPGVGVPGAGIPVV
PGAGIPGAAVPGVVSPEAAAKAAAKAAKYGARPGVGVGGIPTYGVGAGG
FPGFGVGVGGIPGVAGVPGVGGVPGVGGVPGVGISPEAQAAAAAKAAKY
GAAGAGVLGGLVPGPQAAVPGVPGTGGVPGVGTPAAAAAKAAAKAAQFG
LVPGVGVAPGVGVAPGVGVAPGVGLAPGVGVAPGVGVAPGVGVAPGIGP
GGVAAAAKSAAKVAAKAQLRAAAGLGAGIPGLGVGVGVPGLGVGAGVPG
LGVGAGVPGFGAGADEGVRRSLSPELREGDPSSSQHLPSTPSSPRVPGA
LAAAKAAKYGAAVPGVLGGLGALGGVGIPGGVVGAGPAAAAAAAKAAAK
AAQFGLVGAAGLGGLGVGGLGVPGVGGLGGIPPAAAAKAAKYGAAGLGG
VLGGAGQFPLGGVAARPGFGLSPIFPGGACLGKACGRKRK

The codon optimized polynucleotide sequence encoding the 58.8 KD truncated human elastin is disclosed in Seq Id No: 34.

(Seq Id No: 34)
ATGGGTTTAGGAGGCGTCCCAGGTGTCGGTGGCCTGGGTGTTAGCGCCG
GTGCAGTTGTTCCGCAGCCGGGAGCAGGGGTTAAACCTGGTAAAGTGCC
GGGAGTAGGTCTGCCAGGCGTTTATCCTGGTGGTGTTTTGCCGGGTGCC
CGTTTTCCGGGCGTTGGTGTTCTTCCAGGCGTGCCGACCGGAGCCGGTG
TTAAACCGAAAGCCCCCGGTGTTGGAGGTGCATTTGCAGGCATCCCGGG
AGTTGGCCCGTTTGGTGGTCCGCAACCTGGGGTTCCGTTAGGTTATCCG
ATTAAAGCACCGAAACTGCCCGGCGGTTATGGTCTGCCGTACACAACCG
GTAAACTGCCGTATGGTTATGGCCCGGGTGGAGTTGCGGGTGCAGCAGG
TAAAGCGGGTTATCCTACCGGAACCGGTGTAGGTCCGCAGGCCGCTGCT
GCCGCCGCCGCAAAAGCAGCGGCTAAATTTGGCGCCGGAGCAGCGGGTG
TTCTGCCTGGAGTTGGTGGTGCGGGCGTGCCAGGGGTACCTGGTGCAAT
TCCGGGTATTGGTGGTATTGCCGGTGTCGGCACCCCGGCCGCGGCAGCT
GCGGCAGCGGCGGCTGCCAAAGCTGCTAAATACGGTGCCGCGGCGGGTC
TGGTGCCAGGAGGTCCGGGTTTTGGTCCGGGAGTGGTTGGCGTGCCTGG
CGCAGGCGTTCCTGGTGTGGGCGTTCCAGGTGCAGGGATTCCTGTTGTG
CCTGGTGCCGGTATTCCCGGCGCGGCCGTTCCGGGGGTGGTTAGCCCGG
AAGCCGCAGCGAAGGCTGCGGCAAAGGCAGCAAAGTATGGCGCACGCCC
AGGAGTCGGCGTGGGTGGTATCCCGACCTATGGGGTGGGCGCAGGGGGT
TTTCCTGGTTTCGGCGTAGGTGTAGGAGGTATACCGGGCGTGGCCGGTG
TACCAGGGGTTGGTGGCGTCCCTGGTGTTGGCGGTGTGCCAGGTGTTGG
TATTTCACCGGAAGCACAGGCAGCAGCCGCAGCTAAGGCAGCGAAATAT
GGTGCCGCCGGCGCAGGAGTTTTAGGTGGGCTGGTTCCGGGCCCGCAGG
CAGCTGTGCCGGGGGTTCCAGGCACCGGTGGTGTCCCTGGAGTCGGTAC
GCCGGCTGCAGCGGCAGCCAAAGCGGCTGCGAAAGCAGCACAGTTTGGC
TTAGTACCGGGTGTGGGAGTTGCCCCCGGCGTTGGCGTTGCTCCAGGGG
TGGGTGTTGCTCCTGGCGTCGGTCTGGCTCCTGGAGTGGGCGTAGCACC
CGGTGTGGGGGTGGCCCCGGGTGTTGGGGTTGCACCGGGTATCGGTCCG
GGCGGTGTCGCAGCAGCAGCTAAAAGCGCGGCGAAAGTTGCGGCCAAAG
CCCAACTGCGCGCCGCCGCGGGCCTCGGTGCAGGTATTCCGGGGCTGGG
TGTCGGAGTTGGAGTCCCGGGTTTGGGCGTGGGCGCGGGAGTTCCGGGA
CTGGGAGTGGGTGCCGGAGTTCCTGGCTTTGGTGCAGGCGCAGATGAAG
GTGTTCGTCGTAGCCTGAGTCCGGAACTGCGTGAAGGTGATCCGAGTAG
CAGCCAGCATCTGCCGAGCACCCCGAGCAGCCCGCGTGTTCCGGGTGCA
TTAGCTGCAGCAAAAGCCGCCAAGTATGGTGCAGCCGTGCCGGGCGTCT
TAGGTGGTCTGGGCGCCCTGGGTGGTGTAGGCATTCCGGGAGGTGTTGT
GGGTGCAGGACCGGCCGCCGCAGCTGCGGCCGCCAAAGCAGCTGCAAAA
GCGGCCCAGTTTGGTTTAGTGGGCGCCGCAGGTTTAGGCGGTTTAGGTG
TGGGTGGACTGGGTGTACCTGGCGTAGGCGGTCTGGGTGGAATTCCGCC
CGCAGCGGCCGCGAAAGCGGCAAAATATGGCGCGGCAGGCCTGGGCGGC
GTGCTGGGTGGGGCAGGTCAGTTTCCGCTGGGCGGGGTTGCCGCACGTC
CGGGATTTGGTCTGAGCCCGATTTTCCCTGGCGGCGCATGTCTGGGTAA
AGCATGTGGTCGTAAACGTAAAtaa

The amino acid sequence of a 57 KD human elastin truncated at the C-terminal is disclosed in Seq Id No: 35. The 57 KD truncated elastin has amino acids 661-761 deleted from the full length elastin.

(Seq Id No: 35)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTPAAAAAKAAAKAAQFGLVPGVGVAPGVGVA
PGVGVAPGVGLAPGVGVAPGVGVAPGVGVAPGIGPGGVAAAAKSAAKVA
AKAQLRAAAGLGAGIPGLGVGVGVPGLGVGAGVPGLGVGAGVPGFGAGA
DEGVRRSLSPELREGDPSSSQHLPSTPSSPRVPGALAAAKAAKYGAAVP
GVLGGLGALGGVGIPGGVVGAGP

The codon optimized polynucleotide sequence encoding the 57 KD truncated human elastin is disclosed in Seq Id No: 36

(Seq Id No: 36)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCACA
GTTTGGCTTAGTACCGGGTGTGGGAGTTGCCCCCGGCGTTGGCGTTGCT
CCAGGGGTGGGTGTTGCTCCTGGCGTCGGTCTGGCTCCTGGAGTGGGCG
TAGCACCCGGTGTGGGGGTGGCCCCGGGTGTTGGGGTTGCACCGGGTAT
CGGTCCGGGCGGTGTCGCAGCAGCAGCTAAAAGCGCGGCGAAAGTTGCG
GCCAAAGCCCAACTGCGCGCCGCCGCGGGCCTCGGTGCAGGTATTCCGG
GGCTGGGTGTCGGAGTTGGAGTCCCGGGTTTGGGCGTGGGCGCGGGAGT
TCCGGGACTGGGAGTGGGTGCCGGAGTTCCTGGCTTTGGTGCAGGCGCA
GATGAAGGTGTTCGTCGTAGCCTGAGTCCGGAACTGCGTGAAGGTGATC
CGAGTAGCAGCCAGCATCTGCCGAGCACCCCGAGCAGCCCGCGTGTTCC
GGGTGCATTAGCTGCAGCAAAAGCCGCCAAGTATGGTGCAGCCGTGCCG
GGCGTCTTAGGTGGTCTGGGCGCCCTGGGTGGTGTAGGCATTCCGGGAG
GTGTTGTGGGTGCAGGACCGtaa

The amino acid sequence of a 53.9 KD human elastin truncated at the C-terminal is disclosed in Seq Id No: 37. The 53.9 KD truncated elastin has amino acids 624-761 deleted from the full length elastin.

(Seq Id No: 37)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTPAAAAAKAAAKAAQFGLVPGVGVAPGVGVA
PGVGVAPGVGLAPGVGVAPGVGVAPGVGVAPGIGPGGVAAAAKSAAKVA
AKAQLRAAAGLGAGIPGLGVGVGVPGLGVGAGVPGLGVGAGVPGFGAGA
DEGVRRSLSPELREGDPSSSQHLPSTPSSPRVPGA

The codon optimized polynucleotide sequence encoding the 53.9 KD truncated human elastin is disclosed in Seq Id No: 38

(Seq Id No: 38)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCACA
GTTTGGCTTAGTACCGGGTGTGGGAGTTGCCCCCGGCGTTGGCGTTGCT
CCAGGGGTGGGTGTTGCTCCTGGCGTCGGTCTGGCTCCTGGAGTGGGCG
TAGCACCCGGTGTGGGGGTGGCCCCGGGTGTTGGGGTTGCACCGGGTAT
CGGTCCGGGCGGTGTCGCAGCAGCAGCTAAAAGCGCGGCGAAAGTTGCG
GCCAAAGCCCAACTGCGCGCCGCCGCGGGCCTCGGTGCAGGTATTCCGG
GGCTGGGTGTCGGAGTTGGAGTCCCGGGTTTGGGCGTGGGCGCGGGAGT
TCCGGGACTGGGAGTGGGTGCCGGAGTTCCTGGCTTTGGTGCAGGCGCA
GATGAAGGTGTTCGTCGTAGCCTGAGTCCGGAACTGCGTGAAGGTGATC
CGAGTAGCAGCCAGCATCTGCCGAGCACCCCGAGCAGCCCGCGTGTTCC
GGGTGCAtaa

The amino acid sequence of a 45.3 KD human elastin truncated at the C-terminal is disclosed in Seq Id No: 39. The 45.3 KD truncated elastin has amino acids 529-761 deleted from the full length elastin.

(Seq Id No: 39)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTPAAAAAKAAAKAAQFGLVPGVGVAPGVGVA
PGVGVAPGVGLAPGVGVAPGVGVAPGVGVAPGIGPGGV

The codon optimized polynucleotide sequence encoding the 45.3 KD truncated human elastin is disclosed in Seq Id No: 40

(Seq Id No: 40)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCACA
GTTTGGCTTAGTACCGGGTGTGGGAGTTGCCCCCGGCGTTGGCGTTGCT
CCAGGGGTGGGTGTTGCTCCTGGCGTCGGTCTGGCTCCTGGAGTGGGCG
TAGCACCCGGTGTGGGGGTGGCCCCGGGTGTTGGGGTTGCACCGGGTAT
CGGTCCGGGCGGTGTCtaa

The amino acid sequence of a 44.4 KD human elastin truncated at the N-terminal is disclosed in Seq Id No: 41. The 44.4 KD truncated elastin has amino acids 2-246 deleted from the full length elastin.

(Seq Id No: 41)
MGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTPAAAAAKAAAKAAQFGLVPGVGVAPGVGVA
PGVGVAPGVGLAPGVGVAPGVGVAPGVGVAPGIGPGGVAAAAKSAAKVA
AKAQLRAAAGLGAGIPGLGVGVGVPGLGVGAGVPGLGVGAGVPGFGAGA
DEGVRRSLSPELREGDPSSSQHLPSTPSSPRVPGALAAAKAAKYGAAVP
GVLGGLGALGGVGIPGGVVGAGPAAAAAAAKAAAKAAQFGLVGAAGLGG
LGVGGLGVPGVGGLGGIPPAAAAKAAKYGAAGLGGVLGGAGQFPLGGVA
ARPGFGLSPIFPGGACLGKACGRKRK

The codon optimized polynucleotide sequence encoding the 44.4 KD truncated human elastin is disclosed in Seq Id No: 42

(Seq Id No: 42)
ATGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCACA
GTTTGGCTTAGTACCGGGTGTGGGAGTTGCCCCCGGCGTTGGCGTTGCT
CCAGGGGTGGGTGTTGCTCCTGGCGTCGGTCTGGCTCCTGGAGTGGGCG
TAGCACCCGGTGTGGGGGTGGCCCCGGGTGTTGGGGTTGCACCGGGTAT
CGGTCCGGGCGGTGTCGCAGCAGCAGCTAAAAGCGCGGCGAAAGTTGCG
GCCAAAGCCCAACTGCGCGCCGCCGCGGGCCTCGGTGCAGGTATTCCGG
GGCTGGGTGTCGGAGTTGGAGTCCCGGGTTTGGGCGTGGGCGCGGGAGT
TCCGGGACTGGGAGTGGGTGCCGGAGTTCCTGGCTTTGGTGCAGGCGCA
GATGAAGGTGTTCGTCGTAGCCTGAGTCCGGAACTGCGTGAAGGTGATC
CGAGTAGCAGCCAGCATCTGCCGAGCACCCCGAGCAGCCCGCGTGTTCC
GGGTGCATTAGCTGCAGCAAAAGCCGCCAAGTATGGTGCAGCCGTGCCG
GGCGTCTTAGGTGGTCTGGGCGCCCTGGGTGGTGTAGGCATTCCGGGAG
GTGTTGTGGGTGCAGGACCGGCCGCCGCAGCTGCGGCCGCCAAAGCAGC
TGCAAAAGCGGCCCAGTTTGGTTTAGTGGGCGCCGCAGGTTTAGGCGGT
TTAGGTGTGGGTGGACTGGGTGTACCTGGCGTAGGCGGTCTGGGTGGAA
TTCCGCCCGCAGCGGCCGCGAAAGCGGCAAAATATGGCGCGGCAGGCCT
GGGCGGCGTGCTGGGTGGGGCAGGTCAGTTTCCGCTGGGCGGGGTTGCC
GCACGTCCGGGATTTGGTCTGAGCCCGATTTTCCCTGGCGGCGCATGTC
TGGGTAAAGCATGTGGTCGTAAACGTAAAtaa

The amino acid sequence of a 40.4 KD human elastin truncated at the N-terminal is disclosed in Seq Id No: 43. The 40.4 KD truncated elastin has amino acids 2-295 deleted from the full length elastin.

(Seq Id No: 43)
MGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTPAAAAAKAAAKAAQFGLVPGVGVAPGVGVA
PGVGVAPGVGLAPGVGVAPGVGVAPGVGVAPGIGPGGVAAAAKSAAKVA
AKAQLRAAAGLGAGIPGLGVGVGVPGLGVGAGVPGLGVGAGVPGFGAGA
DEGVRRSLSPELREGDPSSSQHLPSTPSSPRVPGALAAAKAAKYGAAVP
GVLGGLGALGGVGIPGGVVGAGPAAAAAAAKAAAKAAQFGLVGAAGLGG
LGVGGLGVPGVGGLGGIPPAAAAKAAKYGAAGLGGVLGGAGQFPLGGVA
ARPGFGLSPIFPGGACLGKACGRKRK

The codon optimized polynucleotide sequence encoding the 40.4 KD truncated human elastin is disclosed in Seq Id No: 44

(Seq Id No: 44)
ATGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGGCTGCAGCGGCAGCCAAAGCGGCTGCGAAAGCAGCACA
GTTTGGCTTAGTACCGGGTGTGGGAGTTGCCCCCGGCGTTGGCGTTGCT
CCAGGGGTGGGTGTTGCTCCTGGCGTCGGTCTGGCTCCTGGAGTGGGCG
TAGCACCCGGTGTGGGGGTGGCCCCGGGTGTTGGGGTTGCACCGGGTAT
CGGTCCGGGCGGTGTCGCAGCAGCAGCTAAAAGCGCGGCGAAAGTTGCG
GCCAAAGCCCAACTGCGCGCCGCCGCGGGCCTCGGTGCAGGTATTCCGG
GGCTGGGTGTCGGAGTTGGAGTCCCGGGTTTGGGCGTGGGCGCGGGAGT
TCCGGGACTGGGAGTGGGTGCCGGAGTTCCTGGCTTTGGTGCAGGCGCA
GATGAAGGTGTTCGTCGTAGCCTGAGTCCGGAACTGCGTGAAGGTGATC
CGAGTAGCAGCCAGCATCTGCCGAGCACCCCGAGCAGCCCGCGTGTTCC
GGGTGCATTAGCTGCAGCAAAAGCCGCCAAGTATGGTGCAGCCGTGCCG
GGCGTCTTAGGTGGTCTGGGCGCCCTGGGTGGTGTAGGCATTCCGGGAG
GTGTTGTGGGTGCAGGACCGGCCGCCGCAGCTGCGGCCGCCAAAGCAGC
TGCAAAAGCGGCCCAGTTTGGTTTAGTGGGCGCCGCAGGTTTAGGCGGT
TTAGGTGTGGGTGGACTGGGTGTACCTGGCGTAGGCGGTCTGGGTGGAA
TTCCGCCCGCAGCGGCCGCGAAAGCGGCAAAATATGGCGCGGCAGGCCT
GGGCGGCGTGCTGGGTGGGGCAGGTCAGTTTCCGCTGGGCGGGGTTGCC
GCACGTCCGGGATTTGGTCTGAGCCCGATTTTCCCTGGCGGCGCATGTC
TGGGTAAAGCATGTGGTCGTAAACGTAAAtaa

The amino acid sequence of a 39.8 KD human elastin truncated at the C-terminal is disclosed in Seq Id No: 45. The 39.8 KD truncated elastin has amino acids 462-761 deleted from the full length elastin.

(Seq Id No: 45)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTYGVGAGGFPGFGVGVGGIPGV
AGVPGVGGVPGVGGVPGVGISPEAQAAAAAKAAKYGAAGAGVLGGLVPG
PQAAVPGVPGTGGVPGVGTP

The codon optimized polynucleotide sequence encoding the 39.8 KD truncated human elastin is disclosed in Seq Id No: 46

(Seq Id No: 46)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGGCAGCAGCCGCAGCTAAGGCAGC
GAAATATGGTGCCGCCGGCGCAGGAGTTTTAGGTGGGCTGGTTCCGGGC
CCGCAGGCAGCTGTGCCGGGGGTTCCAGGCACCGGTGGTGTCCCTGGAG
TCGGTACGCCGtaa

The amino acid sequence of a 36.1 KD human elastin truncated at the C-terminal is disclosed in Seq Id No: 47. The 36.1KD truncated elastin has amino acids 418-761 deleted from the full length elastin. MGGVPGAIPGGVPGGVFYPGAGLGALGGGALGPGGKPLKPVPGGLAGAGLGAG LGAFPAVTFPGALVPGGVADAAAAYKAAKAGAGLGGVPGVGGLGVSAGAVVPQPGA GVKPGKVPGVGLPGVYPGGVLPGARFPGVGVLPGVPTGAGVKPKAPGVGGAFAGIPGV GPFGGPQPGVPLGYPIKAPKLPGGYGLPYTTGKLPYGYGPGGVAGAAGKAGYPTGTGV GPQAAAAAAAKAAAKFGAGAAGVLPGVGGAGVPGVPGAIPGIGGIAGVGTPAAAAAA AAAAKAAKYGAAAGLVPGGPGFGPGVVGVPGAGVPGVGVPGAGIPVVPGAGIPGAAV PGVVSPEAAAKAAAKAAKYGARPGVGVGGIPTYGVGAGGFPGFGVGVGGIPGVAGVP GVGGVPGVGGVPGVGISPEAQ (Seq Id No: 47)

The codon optimized polynucleotide sequence encoding the 36.1 KD truncated human elastin is disclosed in Seq Id No: 48

(Seq Id No: 48)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATGGGGTGGGCGC
AGGGGGTTTTCCTGGTTTCGGCGTAGGTGTAGGAGGTATACCGGGCGTG
GCCGGTGTACCAGGGGTTGGTGGCGTCCCTGGTGTTGGCGGTGTGCCAG
GTGTTGGTATTTCACCGGAAGCACAGtaa

The amino acid sequence of a 34.9 KD human elastin truncated at the N-terminal is disclosed in Seq Id No: 49. The 34.9 KD truncated elastin has amino acids 2-360 deleted from the full length elastin.

(Seq Id No: 49)
MRPGVGVGGIPTYGVGAGGFPGFGVGVGGIPGVAGVPGVGGVPGVGGVP
GVGISPEAQAAAAAKAAKYGAAGAGVLGGLVPGPQAAVPGVPGTGGVPG
VGTPAAAAAKAAAKAAQFGLVPGVGVAPGVGVAPGVGVAPGVGLAPGVG
VAPGVGVAPGVGVAPGIGPGGVAAAAKSAAKVAAKAQLRAAAGLGAGIP
GLGVGVGVPGLGVGAGVPGLGVGAGVPGFGAGADEGVRRSLSPELREGD
PSSSQHLPSTPSSPRVPGALAAAKAAKYGAAVPGVLGGLGALGGVGIPG
GVVGAGPAAAAAAAKAAAKAAQFGLVGAAGLGGLGVGGLGVPGVGGLGG
IPPAAAAKAAKYGAAGLGGVLGGAGQFPLGGVAARPGFGLSPIFPGGAC
LGKACGRKRK

The codon optimized polynucleotide sequence encoding the 34.9 KD truncated human elastin is disclosed in Seq Id No: 50

(Seq Id No: 50)
ATGCGCCCAGGAGTCGGCGTGGGTGGTATCCCGACCTATGGGGTGGGCG
CAGGGGGTTTTCCTGGTTTCGGCGTAGGTGTAGGAGGTATACCGGGCGT
GGCCGGTGTACCAGGGGTTGGTGGCGTCCCTGGTGTTGGCGGTGTGCCA
GGTGTTGGTATTTCACCGGAAGCACAGGCAGCAGCCGCAGCTAAGGCAG
CGAAATATGGTGCCGCCGGCGCAGGAGTTTTAGGTGGGCTGGTTCCGGG
CCCGCAGGCAGCTGTGCCGGGGGTTCCAGGCACCGGTGGTGTCCCTGGA
GTCGGTACGCCGGCTGCAGCGGCAGCCAAAGCGGCTGCGAAAGCAGCAC
AGTTTGGCTTAGTACCGGGTGTGGGAGTTGCCCCCGGCGTTGGCGTTGC
TCCAGGGGTGGGTGTTGCTCCTGGCGTCGGTCTGGCTCCTGGAGTGGGC
GTAGCACCCGGTGTGGGGGTGGCCCCGGGTGTTGGGGTTGCACCGGGTA
TCGGTCCGGGCGGTGTCGCAGCAGCAGCTAAAAGCGCGGCGAAAGTTGC
GGCCAAAGCCCAACTGCGCGCCGCCGCGGGCCTCGGTGCAGGTATTCCG
GGGCTGGGTGTCGGAGTTGGAGTCCCGGGTTTGGGCGTGGGCGCGGGAG
TTCCGGGACTGGGAGTGGGTGCCGGAGTTCCTGGCTTTGGTGCAGGCGC
AGATGAAGGTGTTCGTCGTAGCCTGAGTCCGGAACTGCGTGAAGGTGAT
CCGAGTAGCAGCCAGCATCTGCCGAGCACCCCGAGCAGCCCGCGTGTTC
CGGGTGCATTAGCTGCAGCAAAAGCCGCCAAGTATGGTGCAGCCGTGCC
GGGCGTCTTAGGTGGTCTGGGCGCCCTGGGTGGTGTAGGCATTCCGGGA
GGTGTTGTGGGTGCAGGACCGGCCGCCGCAGCTGCGGCCGCCAAAGCAG
CTGCAAAAGCGGCCCAGTTTGGTTTAGTGGGCGCCGCAGGTTTAGGCGG
TTTAGGTGTGGGTGGACTGGGTGTACCTGGCGTAGGCGGTCTGGGTGGA
ATTCCGCCCGCAGCGGCCGCGAAAGCGGCAAAATATGGCGCGGCAGGCC
TGGGCGGCGTGCTGGGTGGGGCAGGTCAGTTTCCGCTGGGCGGGGTTGC
CGCACGTCCGGGATTTGGTCTGAGCCCGATTTTCCCTGGCGGCGCATGT
CTGGGTAAAGCATGTGGTCGTAAACGTAAAtaa

The amino acid sequence of a 32 KD human elastin truncated at the C-terminal is disclosed in Seq Id No: 51. The 32 KD truncated elastin has amino acids 373-761 deleted from the full length elastin.

(Seq Id No: 51)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPEAAAKAAAKAAKYGARPGVGVGGIPTY

The codon optimized polynucleotide sequence encoding the 32 KD truncated human elastin is disclosed in Seq Id No: 52

(Seq Id No: 52)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAGCCGCAGCGAAGGCTGCGGCAAAGGCAGCAAAGTATGGCG
CACGCCCAGGAGTCGGCGTGGGTGGTATCCCGACCTATtaa

The amino acid sequence of a 29.9 KD human elastin truncated at the C-terminal is disclosed in Seq Id No: 53. The 60.7 KD truncated elastin has amino acids 347-761 deleted from the full length elastin.

(Seq Id No: 53)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTPAAAAAAAAAAKAAKYGAA
AGLVPGGPGFGPGVVGVPGAGVPGVGVPGAGIPVVPGAGIPGAAVPGVV
SPE

The codon optimized polynucleotide sequence encoding the 29.9 KD truncated human elastin is disclosed in Seq Id No: 54

(Seq Id No: 54)
ATGGGTGGCGTACCAGGCGCAATTCCTGGGGGTGTCCCAGGCGGTGTTT
TTTATCCGGGCGCCGGTCTTGGCGCACTGGGTGGCGGTGCACTGGGCCC
GGGCGGCAAACCGCTGAAACCGGTACCAGGTGGTTTAGCAGGCGCCGGC
TTAGGCGCAGGTCTGGGAGCATTTCCGGCAGTTACCTTTCCAGGGGCAC
TGGTTCCTGGAGGTGTGGCCGATGCAGCCGCGGCATATAAAGCCGCTAA
AGCCGGTGCGGGTTTAGGAGGCGTCCCAGGTGTCGGTGGCCTGGGTGTT
AGCGCCGGTGCAGTTGTTCCGCAGCCGGGAGCAGGGGTTAAACCTGGTA
AAGTGCCGGGAGTAGGTCTGCCAGGCGTTTATCCTGGTGGTGTTTTGCC
GGGTGCCCGTTTTCCGGGCGTTGGTGTTCTTCCAGGCGTGCCGACCGGA
GCCGGTGTTAAACCGAAAGCCCCCGGTGTTGGAGGTGCATTTGCAGGCA
TCCCGGGAGTTGGCCCGTTTGGTGGTCCGCAACCTGGGGTTCCGTTAGG
TTATCCGATTAAAGCACCGAAACTGCCCGGCGGTTATGGTCTGCCGTAC
ACAACCGGTAAACTGCCGTATGGTTATGGCCCGGGTGGAGTTGCGGGTG
CAGCAGGTAAAGCGGGTTATCCTACCGGAACCGGTGTAGGTCCGCAGGC
CGCTGCTGCCGCCGCCGCAAAAGCAGCGGCTAAATTTGGCGCCGGAGCA
GCGGGTGTTCTGCCTGGAGTTGGTGGTGCGGGCGTGCCAGGGGTACCTG
GTGCAATTCCGGGTATTGGTGGTATTGCCGGTGTCGGCACCCCGGCCGC
GGCAGCTGCGGCAGCGGCGGCTGCCAAAGCTGCTAAATACGGTGCCGCG
GCGGGTCTGGTGCCAGGAGGTCCGGGTTTTGGTCCGGGAGTGGTTGGCG
TGCCTGGCGCAGGCGTTCCTGGTGTGGGCGTTCCAGGTGCAGGGATTCC
TGTTGTGCCTGGTGCCGGTATTCCCGGCGCGGCCGTTCCGGGGGTGGTT
AGCCCGGAAtaa

The amino acid sequence of a 29.4 KD human elastin truncated at the N-terminal is disclosed in Seq Id No: 55. The 29.4 KD truncated elastin has amino acids 2-425 deleted from the full length elastin.

(Seq Id No: 55)
MKYGAAGAGVLGGLVPGPQAAVPGVPGTGGVPGVGTPAAAAAKAAAKAA
QFGLVPGVGVAPGVGVAPGVGVAPGVGLAPGVGVAPGVGVAPGVGVAPG
IGPGGVAAAAKSAAKVAAKAQLRAAAGLGAGIPGLGVGVGVPGLGVGAG
VPGLGVGAGVPGFGAGADEGVRRSLSPELREGDPSSSQHLPSTPSSPRV
PGALAAAKAAKYGAAVPGVLGGLGALGGVGIPGGVVGAGPAAAAAAAKA
AAKAAQFGLVGAAGLGGLGVGGLGVPGVGGLGGIPPAAAAKAAKYGAAG
LGGVLGGAGQFPLGGVAARPGFGLSPIFPGGACLGKACGRKRK

The codon optimized polynucleotide sequence encoding the 29.4 KD truncated human elastin is disclosed in Seq Id No: 56

(Seq Id No: 56)
ATGAAATATGGTGCCGCCGGCGCAGGAGTTTTAGGTGGGCTGGTTCCGG
GCCCGCAGGCAGCTGTGCCGGGGGTTCCAGGCACCGGTGGTGTCCCTGG
AGTCGGTACGCCGGCTGCAGCGGCAGCCAAAGCGGCTGCGAAAGCAGCA
CAGTTTGGCTTAGTACCGGGTGTGGGAGTTGCCCCCGGCGTTGGCGTTG
CTCCAGGGGTGGGTGTTGCTCCTGGCGTCGGTCTGGCTCCTGGAGTGGG
CGTAGCACCCGGTGTGGGGGTGGCCCCGGGTGTTGGGGTTGCACCGGGT
ATCGGTCCGGGCGGTGTCGCAGCAGCAGCTAAAAGCGCGGCGAAAGTTG
CGGCCAAAGCCCAACTGCGCGCCGCCGCGGGCCTCGGTGCAGGTATTCC
GGGGCTGGGTGTCGGAGTTGGAGTCCCGGGTTTGGGCGTGGGCGCGGGA
GTTCCGGGACTGGGAGTGGGTGCCGGAGTTCCTGGCTTTGGTGCAGGCG
CAGATGAAGGTGTTCGTCGTAGCCTGAGTCCGGAACTGCGTGAAGGTGA
TCCGAGTAGCAGCCAGCATCTGCCGAGCACCCCGAGCAGCCCGCGTGTT
CCGGGTGCATTAGCTGCAGCAAAAGCCGCCAAGTATGGTGCAGCCGTGC
CGGGCGTCTTAGGTGGTCTGGGCGCCCTGGGTGGTGTAGGCATTCCGGG
AGGTGTTGTGGGTGCAGGACCGGCCGCCGCAGCTGCGGCCGCCAAAGCA
GCTGCAAAAGCGGCCCAGTTTGGTTTAGTGGGCGCCGCAGGTTTAGGCG
GTTTAGGTGTGGGTGGACTGGGTGTACCTGGCGTAGGCGGTCTGGGTGG
AATTCCGCCCGCAGCGGCCGCGAAAGCGGCAAAATATGGCGCGGCAGGC
CTGGGCGGCGTGCTGGGTGGGGCAGGTCAGTTTCCGCTGGGCGGGGTTG
CCGCACGTCCGGGATTTGGTCTGAGCCCGATTTTCCCTGGCGGCGCATG
TCTGGGTAAAGCATGTGGTCGTAAACGTAAAtaa

The amino acid sequence of a 25.3 KD human elastin truncated at the N-terminal is disclosed in Seq Id No: 57. The 25.3 KD truncated elastin has amino acids 2-473 deleted from the full length elastin.

(Seq Id No: 57)
MQFGLVPGVGVAPGVGVAPGVGVAPGVGLAPGVGVAPGVGVAPGVGVAP
GIGPGGVAAAAKSAAKVAAKAQLRAAAGLGAGIPGLGVGVGVPGLGVGA
GVPGLGVGAGVPGFGAGADEGVRRSLSPELREGDPSSSQHLPSTPSSPR
VPGALAAAKAAKYGAAVPGVLGGLGALGGVGIPGGVVGAGPAAAAAAAK
AAAKAAQFGLVGAAGLGGLGVGGLGVPGVGGLGGIPPAAAAKAAKYGAA
GLGGVLGGAGQFPLGGVAARPGFGLSPIFPGGACLGKACGRKRK

The codon optimized polynucleotide sequence encoding the 25.3 KD truncated human elastin is disclosed in Seq Id No: 58

(Seq Id No: 58)
ATGCAGTTTGGCTTAGTACCGGGTGTGGGAGTTGCCCCCGGCGTTGGCG
TTGCTCCAGGGGTGGGTGTTGCTCCTGGCGTCGGTCTGGCTCCTGGAGT
GGGCGTAGCACCCGGTGTGGGGGTGGCCCCGGGTGTTGGGGTTGCACCG
GGTATCGGTCCGGGCGGTGTCGCAGCAGCAGCTAAAAGCGCGGCGAAAG
TTGCGGCCAAAGCCCAACTGCGCGCCGCCGCGGGCCTCGGTGCAGGTAT
TCCGGGGCTGGGTGTCGGAGTTGGAGTCCCGGGTTTGGGCGTGGGCGCG
GGAGTTCCGGGACTGGGAGTGGGTGCCGGAGTTCCTGGCTTTGGTGCAG
GCGCAGATGAAGGTGTTCGTCGTAGCCTGAGTCCGGAACTGCGTGAAGG
TGATCCGAGTAGCAGCCAGCATCTGCCGAGCACCCCGAGCAGCCCGCGT
GTTCCGGGTGCATTAGCTGCAGCAAAAGCCGCCAAGTATGGTGCAGCCG
TGCCGGGCGTCTTAGGTGGTCTGGGCGCCCTGGGTGGTGTAGGCATTCC
GGGAGGTGTTGTGGGTGCAGGACCGGCCGCCGCAGCTGCGGCCGCCAAA
GCAGCTGCAAAAGCGGCCCAGTTTGGTTTAGTGGGCGCCGCAGGTTTAG
GCGGTTTAGGTGTGGGTGGACTGGGTGTACCTGGCGTAGGCGGTCTGGG
TGGAATTCCGCCCGCAGCGGCCGCGAAAGCGGCAAAATATGGCGCGGCA
GGCCTGGGCGGCGTGCTGGGTGGGGCAGGTCAGTTTCCGCTGGGCGGGG
TTGCCGCACGTCCGGGATTTGGTCTGAGCCCGATTTTCCCTGGCGGCGC
ATGTCTGGGTAAAGCATGTGGTCGTAAACGTAAAtaa

The amino acid sequence of a 24.1 KD human elastin truncated at the C-terminal is disclosed in Seq Id No: 59. The 24.1 KD truncated elastin has amino acids 277-761 deleted from the full length elastin.

(Seq Id No: 59)
MGGVPGAIPGGVPGGVFYPGAGLGALGGGALGPGGKPLKPVPGGLAGAG
LGAGLGAFPAVTFPGALVPGGVADAAAAYKAAKAGAGLGGVPGVGGLGV
SAGAVVPQPGAGVKPGKVPGVGLPGVYPGGVLPGARFPGVGVLPGVPTG
AGVKPKAPGVGGAFAGIPGVGPFGGPQPGVPLGYPIKAPKLPGGYGLPY
TTGKLPYGYGPGGVAGAAGKAGYPTGTGVGPQAAAAAAAKAAAKFGAGA
AGVLPGVGGAGVPGVPGAIPGIGGIAGVGTP

The codon optimized polynucleotide sequence encoding the 24.1 KD truncated human elastin is disclosed in Seq Id No: 60

(Seq Id No: 60)
ATGGGTGGCGTACCAGGCGCAATTCCTGGGGGTGTCCCAGGCGGTGTTTT
TTATCCGGGCGCCGGTCTTGGCGCACTGGGTGGCGGTGCACTGGGCCCGG
GCGGCAAACCGCTGAAACCGGTACCAGGTGGTTTAGCAGGCGCCGGCTTA
GGCGCAGGTCTGGGAGCATTTCCGGCAGTTACCTTTCCAGGGGCACTGGT
TCCTGGAGGTGTGGCCGATGCAGCCGCGGCATATAAAGCCGCTAAAGCCG
GTGCGGGTTTAGGAGGCGTCCCAGGTGTCGGTGGCCTGGGTGTTAGCGCC
GGTGCAGTTGTTCCGCAGCCGGGAGCAGGGGTTAAACCTGGTAAAGTGCC
GGGAGTAGGTCTGCCAGGCGTTTATCCTGGTGGTGTTTTGCCGGGTGCCC
GTTTTCCGGGCGTTGGTGTTCTTCCAGGCGTGCCGACCGGAGCCGGTGTT
AAACCGAAAGCCCCCGGTGTTGGAGGTGCATTTGCAGGCATCCCGGGAGT
TGGCCCGTTTGGTGGTCCGCAACCTGGGGTTCCGTTAGGTTATCCGATTA
AAGCACCGAAACTGCCCGGCGGTTATGGTCTGCCGTACACAACCGGTAAA
CTGCCGTATGGTTATGGCCCGGGTGGAGTTGCGGGTGCAGCAGGTAAAGC
GGGTTATCCTACCGGAACCGGTGTAGGTCCGCAGGCCGCTGCTGCCGCCG
CCGCAAAAGCAGCGGCTAAATTTGGCGCCGGAGCAGCGGGTGTTCTGCCT
GGAGTTGGTGGTGCGGGCGTGCCAGGGGTACCTGGTGCAATTCCGGGTAT
TGGTGGTATTGCCGGTGTCGGCACCCCGtaa

The amino acid sequence of a 20.3 KD human elastin truncated at the C-terminal is disclosed in Seq Id No: 61. The 20.3 KD truncated elastin has amino acids 229-761 deleted from the full length elastin.

(Seq Id No: 61)
MGGVPGAIPGGVPGGVFYPGAGLGALGGGALGPGGKPLKPVPGGLAGAGL
GAGLGAFPAVTFPGALVPGGVADAAAAYKAAKAGAGLGGVPGVGGLGVSA
GAVVPQPGAGVKPGKVPGVGLPGVYPGGVLPGARFPGVGVLPGVPTGAGV
KPKAPGVGGAFAGIPGVGPFGGPQPGVPLGYPIKAPKLPGGYGLPYTTGK
LPYGYGPGGVAGAAGKAGYPTGTGVGPQ

The codon optimized polynucleotide sequence encoding the 20.3 KD truncated human elastin is disclosed in Seq Id No: 62

(Seq Id No: 62)
ATGGGTGGCGTACCAGGCGCAATTCCTGGGGGTGTCCCAGGCGGTGTTTT
TTATCCGGGCGCCGGTCTTGGCGCACTGGGTGGCGGTGCACTGGGCCCGG
GCGGCAAACCGCTGAAACCGGTACCAGGTGGTTTAGCAGGCGCCGGCTTA
GGCGCAGGTCTGGGAGCATTTCCGGCAGTTACCTTTCCAGGGGCACTGGT
TCCTGGAGGTGTGGCCGATGCAGCCGCGGCATATAAAGCCGCTAAAGCCG
GTGCGGGTTTAGGAGGCGTCCCAGGTGTCGGTGGCCTGGGTGTTAGCGCC
GGTGCAGTTGTTCCGCAGCCGGGAGCAGGGGTTAAACCTGGTAAAGTGCC
GGGAGTAGGTCTGCCAGGCGTTTATCCTGGTGGTGTTTTGCCGGGTGCCC
GTTTTCCGGGCGTTGGTGTTCTTCCAGGCGTGCCGACCGGAGCCGGTGTT
AAACCGAAAGCCCCCGGTGTTGGAGGTGCATTTGCAGGCATCCCGGGAGT
TGGCCCGTTTGGTGGTCCGCAACCTGGGGTTCCGTTAGGTTATCCGATTA
AAGCACCGAAACTGCCCGGCGGTTATGGTCTGCCGTACACAACCGGTAAA
CTGCCGTATGGTTATGGCCCGGGTGGAGTTGCGGGTGCAGCAGGTAAAGC
GGGTTATCCTACCGGAACCGGTGTAGGTCCGCAGtaa

The amino acid sequence of a19.6 KD human elastin truncated at the N-terminal is disclosed in Seq Id No: 63. The 19.6 KD truncated elastin has amino acids 2-542 deleted from the full length elastin.

(Seq Id No: 63)
MQLRAAAGLGAGIPGLGVGVGVPGLGVGAGVPGLGVGAGVPGFGAGADEG
VRRSLSPELREGDPSSSQHLPSTPSSPRVPGALAAAKAAKYGAAVPGVLG
GLGALGGVGIPGGVVGAGPAAAAAAAKAAAKAAQFGLVGAAGLGGLGVGG
LGVPGVGGLGGIPPAAAAKAAKYGAAGLGGVLGGAGQFPLGGVAARPGFG
LSPIFPGGACLGKACGRKRK

The codon optimized polynucleotide sequence encoding the 19.6 KD truncated human elastin is disclosed in Seq Id No: 64

(Seq Id No: 64)
ATGCAACTGCGCGCCGCCGCGGGCCTCGGTGCAGGTATTCCGGGGCTGGG
TGTCGGAGTTGGAGTCCCGGGTTTGGGCGTGGGCGCGGGAGTTCCGGGAC
TGGGAGTGGGTGCCGGAGTTCCTGGCTTTGGTGCAGGCGCAGATGAAGGT
GTTCGTCGTAGCCTGAGTCCGGAACTGCGTGAAGGTGATCCGAGTAGCAG
CCAGCATCTGCCGAGCACCCCGAGCAGCCCGCGTGTTCCGGGTGCATTAG
CTGCAGCAAAAGCCGCCAAGTATGGTGCAGCCGTGCCGGGCGTCTTAGGT
GGTCTGGGCGCCCTGGGTGGTGTAGGCATTCCGGGAGGTGTTGTGGGTGC
AGGACCGGCCGCCGCAGCTGCGGCCGCCAAAGCAGCTGCAAAAGCGGCCC
AGTTTGGTTTAGTGGGCGCCGCAGGTTTAGGCGGTTTAGGTGTGGGTGGA
CTGGGTGTACCTGGCGTAGGCGGTCTGGGTGGAATTCCGCCCGCAGCGGC
CGCGAAAGCGGCAAAATATGGCGCGGCAGGCCTGGGCGGCGTGCTGGGTG
GGGCAGGTCAGTTTCCGCTGGGCGGGGTTGCCGCACGTCCGGGATTTGGT
CTGAGCCCGATTTTCCCTGGCGGCGCATGTCTGGGTAAAGCATGTGGTCG
TAAACGTAAAtaa

The amino acid sequence of a 11 KD human elastin truncated at the N-terminal is disclosed in Seq Id No: 65. The 11 KD truncated elastin has amino acids 2-635 deleted from the full length elastin.

(Seq Id No: 65)
MVPGVLGGLGALGGVGIPGGVVGAGPAAAAAAAKAAAKAAQFGLVGAAGL
GGLGVGGLGVPGVGGLGGIPPAAAAKAAKYGAAGLGGVLGGAGQFPLGGV
AARPGFGLSPIFPGGACLGKACGRKRK

The codon optimized polynucleotide sequence encoding the 11 KD truncated human elastin is disclosed in Seq Id No: 66

(Seq Id No: 66)
ATGGTGCCGGGCGTCTTAGGTGGTCTGGGCGCCCTGGGTGGTGTAGGCAT
TCCGGGAGGTGTTGTGGGTGCAGGACCGGCCGCCGCAGCTGCGGCCGCCA
AAGCAGCTGCAAAAGCGGCCCAGTTTGGTTTAGTGGGCGCCGCAGGTTTA
GGCGGTTTAGGTGTGGGTGGACTGGGTGTACCTGGCGTAGGCGGTCTGGG
TGGAATTCCGCCCGCAGCGGCCGCGAAAGCGGCAAAATATGGCGCGGCAG
GCCTGGGCGGCGTGCTGGGTGGGGCAGGTCAGTTTCCGCTGGGCGGGGTT
GCCGCACGTCCGGGATTTGGTCTGAGCCCGATTTTCCCTGGCGGCGCATG
TCTGGGTAAAGCATGTGGTCGTAAACGTAAAtaa

The amino acid sequence of a 7.9 KD human elastin truncated at the N-terminal is disclosed in Seq Id No: 67. The 7.9 KD truncated elastin has amino acids 2-674 deleted from the full length elastin.

(Seq Id No: 67)
MQFGLVGAAGLGGLGVGGLGVPGVGGLGGIPPAAAAKAAKYGAAGLGGVL
GGAGQFPLGGVAARPGFGLSPIFPGGACLGKACGRKRK

The codon optimized polynucleotide sequence encoding the 7.9 KD truncated human elastin is disclosed in Seq Id No: 68

(Seq Id No: 68)
ATGCAGTTTGGTTTAGTGGGCGCCGCAGGTTTAGGCGGTTTAGGTGTGGG
TGGACTGGGTGTACCTGGCGTAGGCGGTCTGGGTGGAATTCCGCCCGCAG
CGGCCGCGAAAGCGGCAAAATATGGCGCGGCAGGCCTGGGCGGCGTGCTG
GGTGGGGCAGGTCAGTTTCCGCTGGGCGGGGTTGCCGCACGTCCGGGATT
TGGTCTGAGCCCGATTTTCCCTGGCGGCGCATGTCTGGGTAAAGCATGTG
GTCGTAAACGTAAAtaa

The amino acid sequence of a 6.3 KD human elastin truncated at the C-terminal is disclosed in Seq Id No: 69. The 6.3 KD truncated elastin has amino acids 74-761 deleted from the full length elastin.

(Seq Id No: 69)
MGGVPGAIPGGVPGGVFYPGAGLGALGGGALGPGGKPLKPVPGGLAGAGL
GAGLGAFPAVTFPGALVPGGVAD

The codon optimized polynucleotide sequence encoding the 6.3 KD truncated human elastin is disclosed in Seq Id No: 70:

(Seq Id No:70)
ATGGGTGGCGTACCAGGCGCAATTCCTGGGGGTGTCCCAGGCGGTGTTTT
TTATCCGGGCGCCGGTCTTGGCGCACTGGGTGGCGGTGCACTGGGCCCGG
GCGGCAAACCGCTGAAACCGGTACCAGGTGGTTTAGCAGGCGCCGGCTTA
GGCGCAGGTCTGGGAGCATTTCCGGCAGTTACCTTTCCAGGGGCACTGGT
TCCTGGAGGTGTGGCCGATtaa

The amino acid sequence of a 4.3 KD human elastin truncated at the N-terminal is disclosed in Seq Id No: 71. The 4.3 KD truncated elastin has amino acids 2-717 deleted from the full length elastin.

(Seq Id No: 71)
MGLGGVLGGAGQFPLGGVAARPGFGLSPIFPGGACLGKACGRKRK

The codon optimized polynucleotide sequence encoding the 4.3 KD truncated human elastin is disclosed in Seq Id No: 72.

(Seq Id No: 72)
ATGGGCCTGGGCGGCGTGCTGGGTGGGGCAGGTCAGTTTCCGCTGGGCGG
GGTTGCCGCACGTCCGGGATTTGGTCTGAGCCCGATTTTCCCTGGCGGCG
CATGTCTGGGTAAAGCATGTGGTCGTAAACGTAAAtaa

### Example 6: Production of Mastodon Collagen with DsbA Secretion Tag, Histidine Tag, and Thrombin Cleavage Site

Due to the existence of well-preserved mastodon fossils, the amino acid sequence of mastodon collagen has been determined and was published in Molecular phylogenetics of mastodon and Tyrannosaurus rex, Science 320 (5875), 499 (2008). The sequence can be found at www.ncbi.nlm.nih.gov/protein/378405256?report=genbank&log$=protalign&blast rank=2&RI D=0T4XBT5J014.

The amino acid sequence of mastodon collagen is provided in Seq Id No: 73.

(Seq Id No:73)
MKKIWLALAGLVLAFSASAAQYEDHHHHHHHHHSGSSLVPRGSHMQLSYG
YDEKSAGGISVPGPMGPSGPRGLPGPPGAPGPQGFQGPPGEPGEPGASGP
MGPRGPPGPPGKNGDDGEAGKPGRPGERGPPGPQGARGLPGTAGLPGMKG
HRGFSGLDGAKGDAGPAGPKGEPGSPGENGAPGQMGPRGLPGERGRPGAP
GPAGARGNDGATGAAGPPGPTGPAGPPGFPGAVGAKGEAGPQGARGSEGP
QGVRGEPGPPGPAGAAGPAGNPGADGQPGAKGANGAPGIAGAPGFPGARG
PAGPQGPSGAPGPKGNSGEPGAPGSKGDAGAKGEPGPIGIQGPPGPAGEE
GKRGARGEPGPTGLPGPPGERGGPGSRGFPGADGVAGPKGPAGERGSPGP
AGPKGSPGEAGRPGEAGLPGAKGLTGSPGSPGPDGKTGPPGPAGQDGRPG
PPGPPGARGQAGVMGFPGPKGAAGEPGKAGERGVPGPPGAVGAAGKDGEA
GAQGPPGPAGPAGERGEQGPAGSPGFQGLPGPAGPPGEAGKPGEQGVPGD
LGAPGPSGARGERGFPGERGVQGPPGPAGPRGSNGAPGNDGAKGDAGAPG
APGSQGAPGLQGMPGERGAAGLPGPKGDRGDAGPKGADGSPGKDGPRGLT
GPIGPPGPAGAPGDKGEAGPSGPAGPTGARGAPGDRGEPGPPGPAGFAGP
PGADGQPGAKGEPGDAGAKGDAGPPGPAGPTGAPGPIGNVGAPGAKGARG
SAGPPGATGFPGAAGRVGPPGPSGNAGPPGPPGPAGKEGGKGPRGETGPA
GRPGEVGPPGPPGPAGEKGSPGADGPAGAPGTPGPQGIGGQRGVVGLPGQ
RGERGFPGLPGPSGEPGKQGPSGSSGERGPPGPAGPPGLAGPPGESGREG
APGAEGSPGRDGSPGPKGDRGETGPSGPPGAPGAPGAPGPVGPAGKSGDR
GETGPAGPAGPAGPAGVRGPAGPQGPRGDKGETGEQGDRGLKGHRGFSGL
QGPPGPPGSPGEQGPSGASGPAGPRGPPGSAGAPGKDGLNGLPGPPGPPG
PRGRTGDAGPVGPPGPPGPPGPPGPPSGAFDFSFLPQPPQEKAHDGGRYY
RA

The codon optimized polynucleotide sequence encoding the full length mastodon collagen is disclosed in Seq Id No: 74.

(Seq ID No. 74)
ATGAAAAAGATTTGGCTGGCGCTGGCTGGTTTAGTTTTAGCGTTTAGCGC
ATCGGCGGCGCAGTATGAAGATCACCATCACCACCACCACCATCACCACT
CTGGCTCGAGCCTGGTGCCGCGCGGCAGCCATATGCAGCTGAGCTATGGT
TATGATGAAAAAAGCGCCGGTGGTATTAGCGTCCCGGGCCCTATGGGCCC
GAGCGGGCCGCGGGGTCTGCCGGGTCCTCCCGGAGCCCCTGGGCCTCAGG
GTTTTCAGGGGCCACCGGGAGAACCTGGCGAACCCGGGGCAAGCGGTCCT
ATGGGTCCACGTGGTCCGCCGGGGCCTCCGGGGAAAAATGGTGACGATGG
TGAAGCTGGTAAACCTGGCCGTCCAGGGGAACGGGGGCCGCCTGGACCGC
AGGGAGCGCGCGGTTTACCGGGTACCGCAGGTTTGCCGGGTATGAAAGGC
CATCGTGGTTTTAGCGGTCTGGATGGTGCAAAAGGTGACGCTGGGCCAGC
CGGGCCAAAAGGCGAGCCGGGGTCACCGGGGGAGAATGGAGCTCCAGGCC
AGATGGGTCCTCGGGGTTTACCTGGTGAACGTGGTAGACCGGGAGCACCA
GGTCCGGCGGGCGCACGTGGTAACGATGGCGCAACCGGTGCCGCTGGTCC
CCCCGGTCCTACAGGCCCTGCGGGCCCACCAGGTTTTCCTGGTGCCGTTG
GCGCGAAAGGCGAAGCAGGTCCGCAAGGTGCACGCGGTAGCGAAGGGCCG
CAGGGTGTTCGCGGCGAGCCTGGGCCCCCAGGTCCTGCTGGCGCGGCGGG
TCCTGCCGGTAATCCTGGCGCCGATGGTCAGCCGGGTGCTAAAGGAGCAA
ATGGCGCCCCCGGTATTGCAGGAGCACCGGGCTTTCCAGGGGCAAGGGGT
CCGGCTGGTCCTCAAGGTCCTAGTGGTGCACCTGGGCCTAAAGGTAATAG
CGGTGAACCGGGTGCACCGGGTAGTAAAGGCGATGCCGGTGCGAAAGGTG
AACCAGGGCCTATTGGTATTCAGGGCCCTCCTGGGCCTGCTGGTGAAGAA
GGTAAACGTGGCGCAAGAGGGGAACCGGGACCTACCGGTCTTCCGGGTCC
GCCTGGGGAACGTGGAGGTCCGGGTAGCCGTGGCTTTCCTGGAGCAGATG
GTGTAGCGGGGCCGAAAGGCCCAGCCGGAGAAAGAGGTAGCCCGGGTCCC
GCTGGACCGAAAGGTAGTCCGGGTGAGGCAGGCCGTCCGGGGGAAGCAGG
ACTGCCAGGCGCTAAAGGCTTAACCGGCAGCCCGGGGAGCCCTGGCCCGG
ATGGTAAAACGGGACCGCCGGGACCGGCAGGTCAGGATGGTCGCCCTGGT
CCACCAGGCCCTCCGGGAGCCCGCGGTCAGGCAGGCGTTATGGGTTTTCC
GGGACCAAAAGGGGCAGCAGGCGAACCGGGCAAAGCCGGCGAACGGGGCG
TTCCAGGACCGCCTGGTGCAGTTGGTGCCGCAGGCAAAGATGGAGAAGCC
GGAGCACAAGGACCTCCCGGACCGGCGGGGCCTGCCGGTGAGCGCGGTGA
GCAGGGTCCAGCTGGGAGTCCGGGATTTCAGGGACTTCCGGGCCCAGCAG
GTCCCCCGGGTGAAGCGGGTAAACCAGGTGAACAGGGCGTGCCGGGTGAT
CTGGGCGCACCTGGCCCAAGCGGTGCACGGGGTGAGCGTGGTTTCCCGGG
CGAGCGGGGTGTTCAGGGTCCCCCAGGGCCAGCTGGTCCGCGTGGCAGCA
ACGGTGCGCCTGGTAATGATGGCGCCAAAGGTGATGCAGGGGCCCCGGGA
GCTCCGGGTTCACAGGGTGCGCCGGGTCTGCAGGGTATGCCGGGAGAGCG
CGGCGCAGCAGGTCTGCCTGGTCCGAAGGGTGATCGTGGCGATGCAGGTC
CGAAAGGAGCCGACGGTTCTCCGGGTAAAGATGGCCCGCGTGGACTGACC
GGCCCGATAGGTCCGCCAGGGCCGGCTGGAGCGCCGGGGGATAAAGGAGA
AGCGGGCCCCAGCGGCCCTGCTGGCCCGACTGGTGCACGTGGAGCACCTG
GAGATCGTGGAGAACCAGGACCACCCGGGCCGGCGGGTTTTGCGGGACCT
CCGGGTGCCGATGGCCAGCCTGGGGCCAAAGGAGAACCCGGTGATGCGGG
TGCCAAAGGCGACGCAGGCCCGCCCGGACCCGCTGGCCCTACCGGGGCGC
CGGGCCCGATTGGTAATGTTGGCGCACCAGGAGCTAAAGGTGCCCGTGGT
AGCGCCGGACCACCTGGGGCAACAGGCTTTCCGGGCGCTGCTGGTCGTGT
TGGCCCACCCGGTCCGAGCGGTAACGCGGGTCCTCCAGGTCCTCCTGGCC
CCGCAGGTAAAGAAGGTGGTAAAGGACCGCGTGGTGAGACGGGCCCTGCA
GGTCGTCCTGGAGAAGTTGGCCCTCCCGGCCCACCGGGGCCGGCCGGTGA
AAAAGGTTCCCCGGGGGCAGACGGCCCGGCAGGGGCACCTGGTACCCCAG
GCCCACAGGGCATTGGTGGTCAGCGTGGTGTTGTTGGCCTTCCGGGGCAG
CGTGGCGAACGCGGTTTTCCAGGTCTTCCTGGTCCCAGTGGTGAGCCTGG
CAAACAAGGTCCGAGTGGTAGCAGCGGAGAACGTGGGCCACCTGGTCCTG
CGGGTCCTCCGGGCTTAGCTGGGCCGCCAGGAGAAAGCGGTCGTGAAGGC
GCCCCAGGAGCAGAAGGGAGTCCTGGTCGGGATGGTAGCCCAGGACCTAA
AGGGGATCGCGGTGAAACCGGTCCGTCTGGCCCGCCGGGCGCCCCTGGCG
CGCCGGGAGCGCCAGGTCCAGTTGGTCCGGCAGGTAAAAGCGGCGATCGT
GGTGAAACTGGGCCGGCAGGTCCAGCCGGTCCTGCAGGCCCGGCCGGCGT
TCGTGGTCCCGCGGGGCCACAGGGTCCGCGGGGAGATAAAGGTGAGACAG
GAGAACAGGGTGATAGAGGTCTGAAAGGTCATAGAGGTTTTAGTGGTCTG
CAAGGTCCACCGGGCCCCCCAGGCAGTCCAGGCGAACAGGGACCGTCTGG
TGCAAGTGGACCGGCCGGACCGCGCGGCCCTCCAGGCAGCGCGGGGGCTC
CAGGGAAAGATGGTCTGAATGGTCTGCCCGGTCCGCCCGGCCCGCCTGGC
CCTCGTGGTCGTACGGGTGATGCTGGACCAGTTGGACCGCCAGGCCCCCC
TGGACCACCGGGTCCACCTGGACCCCCGTCAGGTGCATTTGATTTTAGCT
TTCTGCCGCAGCCGCCGCAGGAAAAAGCACATGATGGTGGTCGCTATTAT
CGTGCATAA

The DsbA secretion tag is encoded by nucleotides 1-71. The histidine tag comprising 9 histidine residues (SEQ ID NO: 112) is encoded by nucleotides 73-99 and encodes amino acids 25-33. The linker is encoded by nucleotides 100-111. The thrombin cleavage tag is encoded by nucleotides 112-135 and encodes amino acids 38-45. The mastodon collagen is encoded by nucleotides 136-3309 and encodes amino acids 46-1102. The polynucleotide is disclosed in Seq Id No: 74.

The polynucleotides of Seq ID No: 74 were synthesized by Gen9 DNA, now Gingko Bioworks internal synthesis. Overlaps between the pET28 vector and Seq ID No: 3 and Seq ID No: 4 were designed to be between 30 and 40 bp long and added using PCR with the enzyme PrimeStar GXL polymerase (http://www.clontech.com/US/Products/PCR/GC_Rich/PrimeSTAR GXL DNA Polymerase?si tex=10020:22372:US). The opened pET28a vector and insert DNA (Seq ID No: 3 or Seq ID No: 4) were then assembled together into the final plasmid using SGI Gibson assembly (us.vwr.com/store/product/17613857/gibson-assembly-hifi-1-step-kit-synthetic-genomics-inc). Sequence of plasmid was then verified through sanger sequencing through Eurofins Genomics (www.eurofinsgenomics.com).

The transformed cells were cultivated in minimal media and frozen in 1.5 ml aliquots with glycerol at a ratio of 50:50 of cells to glycerol. One vial of this frozen culture was revived in 50 ml of minimal media overnight at 37° C., 200 rpm. Cells were transferred into 300 ml of minimal media and grown for 6-9 hours to reach an OD600 of 5-10.

The collagen was purified by acid treatment of homogenized cell broth. The pH of the homogenized slurry was decreased to 3 using 6M Hydrochloric acid. Acidified cell slurry was incubated overnight at 4° C. with mixing, followed by centrifugation. Supernatant of the acidified slurry was tested on a polyacrylamide gel and found to contain collagen in relatively high abundance compared to starting pellet. The collagen slurry thus obtained was high in salts. To obtain volume and salt reduction, concentration and diafiltration steps were performed using an EMD Millipore Tangential Flow Filtration system with ultrafiltration cassettes of 0.1 m² each. Total area of filtration was 0.2 m² using 2 cassettes in parallel. A volume reduction of 5× and a salt reduction of 19× was achieved in the TFF stage. Final collagen slurry was run on an SDS-PAGE gel to confirm presence of the collagen. This slurry was dried using a multi-tray lyophilizer over 3 days to obtain a white, fluffy collagen powder.

The collagen was analyzed on an SDS-PAGE gel and a clear band was observed at the expected size of 97 kilodaltons.

### Example 7: SCOBY Production Using Acetobacter

One liter of media was prepared by boiling water. Two bags of black tea (www.pgtips.com.uk) were steeped in the boiled water and 60 g of sucrose was added. After the media was cooled to 60° C., the pH was adjusted to 3.0 by adding HCL. The media cooled until slightly warmer than room temperature and a SCOBY purchased on eBay was added to the media and cultivated for one week.

After one week of growth, the SCOBY was harvested and the bacteria present in the SCOBY were isolated. GYC medium plates were prepared by combining 10% glucose, 1.0% yeast extract, 2.0% calcium carbonate and 1.5% agar and pH was adjusted to 3.5.Cellulose producing colonies were isolated by taking a sample of the SCOBY and streaking on the GYC plates. After incubation at 37° C., individual colonies were picked and the 16S ribosomal RNA was isolated and sequenced. The sequence analysis confirmed that the isolated bacterial colony was Acetobacter.

To isolate the Yeast present in the SCOBY, YPD plates were prepared by combining in 1 liter, 10 g yeast extract, 20 g Bacto peptone and 20 g Bacto-agar. The mixture was autoclaved and 50 mL of 40% (w/w) glucose was added. Yeast colonies were isolated by taking a sample of the SCOBY and streaking on the YPD plates. After incubation at 37° C., individual colonies were picked and the ribosomal RNA was isolated and sequenced. The sequence analysis confirmed that the isolated yeast colony was Zygosaccharomyces.

### Example 8: SCOBY Production

Prepare media by combining 2 g/L ammonium sulfate, 13.6 g/L potassium phosphate monobasic, 2 g/L magnesium sulfate heptahydrate, 50 g/L glucose, 50 g/L sucrose, 1 mL/L trace metal solution, TM #5, of Table 2 to a 20 L container.

Brewed black tea was added to the culture media. The number of tea bags used was one tea bag for four liters of media. It is possible to produce SCOBY in the culture media without the use of brewed black tea. However, the addition of the brewed black tea accelerated the growth of the SCOBY.

The culture media was inoculated with a SCOBY produced as described in Example 6. To inoculate the culture media, the SCOBY of example 6 was divided into multiple pieces and one piece was placed in a blender and culture media was added to the blender. After blending, a portion or all of the blended liquid was added to the 20 L container.

Cotton fabric of sufficient size to cover most or all of the surface of the culture media in the 20 L container was carefully laid on top of the media. The SCOBY grows beneath cotton fabric. When the SCOBY was harvested, the cotton fabric was removed.

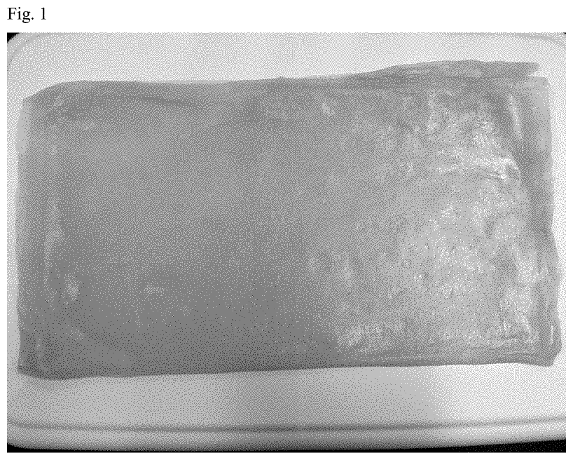

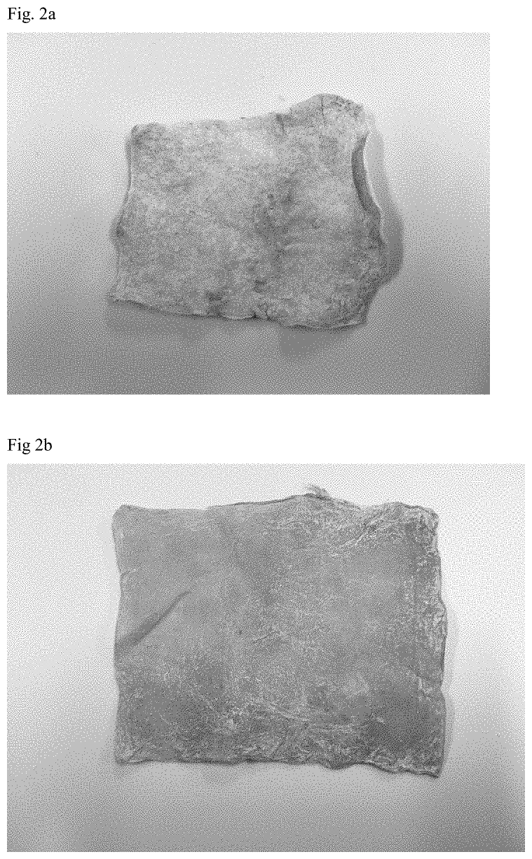

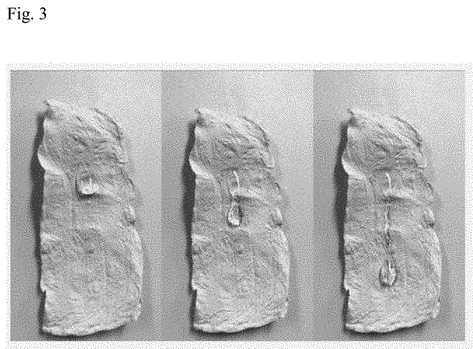

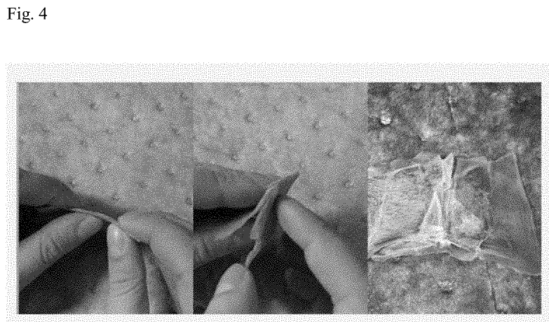

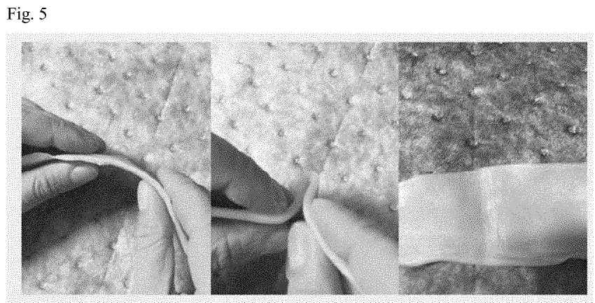

The SCOBY was cultivated for 3-7 days, harvested and washed with water. The thickness of the SCOBY was typically between 1 mm and 10 mm. The cultivation period can be adjusted according to the desired thickness of the wet SCOBY. FIG. 1 shows a photograph of the SCOBY produced after 7 days of cultivation. After 7 days of cultivation, the SCOBY was 4.42 mm thick. The wet SCOBY of FIG. 1 is several stacked SCOBYs. When cultures were cultivated for 2 months, the SCOBY was 50-100 mm thick.

### Example 9: Preparation of a Flexible, Hydrophobic Textile

The washed SCOBY of example 7 was placed in an aqueous solution of polyethylene glycol 200 (PEG 200) and incubated and dried to prepare the dried SCOBY sheet that contained PEG 200. In addition, SCOBY without the incubation in PEG was dried to prepare the dried SCOBY sheet. The dried SCOBY sheet comprising PEG 200 was 0.40 mm thick.

The silica sol was prepared as follows. In 100 mL deionized water, 10 ml of water glass and 7.5 mL of GPTMS were added and stirred. The water glass, catalog no. 338443, was purchased from Sigma-Aldrich. The Water glass consisted of 10.6% Na₂O and −26.5% SiO₂. The GPTMS stock solution, >97% GPTMS by weight, was purchased from Sigma-Aldrich, catalog no. G1535. After the admixture of water glass and GPTMS was prepared, 25 mL of 2N HCL was slowly added dropwise into the admixture while stirring. After all of the HCL was added, the resulting solution was stirred continuously for one hour.

The SCOBY sheet, either with or without PEG, was placed in the silica sol for 14 hours to prepare the SCOBY/silica sol matrix.

The SCOBY/silica sol matrix was heat treated by placing it in an oven at a temperature of 80° C. for 1.5 hours to prepare the dried, silanized SCOBY pad. The dried, silanized SCOBY pad (made from PEG treated SCOBY sheet) was 0.44 mm thick.

Next, ODTES was applied to the dried, silanized SCOBY pad. ODTES was applied by first dissolving four grams of ODTES in 96 grams of ethanol and placing the dried, silanized SCOBY pad and incubating in the ODTES/ethanol solution for four hours to prepare the uncured textile.

The uncured textile was cured by baking in an oven at a temperature of 120° C. for one hour to prepare the flexible, hydrophobic textile.

### Example 10: Properties of a Flexible, Hydrophobic Textile

Two textiles were prepared, one with PEG 200 and one without PEG 200. FIG. 3 shows a photograph of a textile made with PEG200 onto which water was deposited. As can be seen, the water was not absorbed into the textile. The textile was raised at an angle and the photograph shows the water drop rolling off the textile.

FIG. 4 shows a textile prepared without PEG 200 being bent. As can be seen, the textile was bent 180 degrees without completely breaking. When the textile was returned to its original position, it can be seen that portions of the textile were cracked.

FIG. 5 shows a textile prepared with PEG200 being bent. As can be seen, the textile was bent 180 degrees without breaking. When the textile was returned to its original position, it can be seen that the textile did not break or show any sign of cracking.

1. A flexible, hydrophobic textile comprising a symbiotic culture of bacteria and yeast (SCOBY), silica sol, and optionally polyglycol, wherein hydroxyl moieties present in the SCOBY and/or the polyglycol are covalently bonded to the silica sol.

2. The flexible, hydrophobic textile of claim 1, further comprising collagen or elastin.

3. The flexible, hydrophobic textile of claim 2, wherein the collagen or elastin is a recombinant collagen or elastin selected from the group consisting of: jellyfish collagen, truncated jellyfish collagen, jellyfish elastin, truncated jellyfish elastin, mastodon collagen, truncated mastodon collagen, mastodon elastin, and truncated mastodon elastin.

4. The flexible, hydrophobic textile of claim 1, wherein the polyglycol is selected from the group consisting of: polyethylene glycol, polyethylene oxide, polyoxypropylene, polypropylene glycol, polypropylene oxide, polyoxypropylene, polyvinyl alcohol, and polyvinylpyrrolidone.

5. The flexible, hydrophobic textile of claim 4, wherein the polyglycol is polyethylene glycol.

6. The flexible, hydrophobic textile of claim 1, wherein the silica sol comprises the reaction products of water glass and silicon alkoxide.

7. The flexible, hydrophobic textile of claim 6, wherein the silicon alkoxide is selected from the group consisting of: 3-aminopropyl triethoxysilane (APTES), 3-methacryloxypropyltrimethoxysilane (MAPMS), methyltrimethoxysilane (MTMS), dimethyldimethoxysilane (DMDMS),tetramethoxysilane (TMOS), tetraethoxysilane (TEOS), tetrapropoxysilane (TPOS), tetraisopropoxysilane (TiPOS), vinyltrimethoxysilane (VTMS), 3-glycidyloxypropyltrimethoxysilane (GPTMS), and n-octadecyltriethoxysilane (ODTES).

8. The flexible, hydrophobic textile of claim 1, wherein the SCOBY comprises cellulose-producing cellulose producing bacteria.

9. The flexible, hydrophobic textile of claim 8, wherein the cellulose-producing bacteria is of a genus selected from the group consisting of: Acetobacter, Allobaculum, Bacillus, Bifidobacterium, Enterococcus, Gluconacetobacter, Lactobaccilus, Lactococcus, Leuconostoc, Ruminancoccaceae Incertae Sedis, Pediococcus, Propionibacterium, Streptococcus, and Thermus.

10. The flexible, hydrophobic textile of claim 9, wherein the bacteria is of the genus Acetobacter.

11. The flexible, hydrophobic textile of claim 1, wherein the cellulose-producing bacteria produces nanocellulose.

12. The flexible, hydrophobic textile of claim 1, wherein the SCOBY further comprises yeast of the genus selected from the group consisting of: Candida, Davidiella, Dekerra, Hansenula, Hanseniaospora, Kazachstania, Kloeckera, Kluyveromyces, Lachanacea, Leucosporidiella, Meyerozyma, Naumovozyma, Picchia, Saccharomyces, Wallemia, and Zygosacchromyces.

13. The flexible, hydrophobic textile of claim 12, wherein the yeast is of the genus Zygosaccharomyces.

14. The flexible, hydrophobic textile of claim 6, wherein hydroxyl moieties present in the collagen or elastin are covalently linked to the silica sol or the silicon alkoxide.

15. The flexible, hydrophobic textile of claim 1, wherein the flexible, hydrophobic textile has a moisture content of between 0.1% and 10%.

16. The flexible, hydrophobic textile of claim 1, wherein the flexible, hydrophobic textile further comprises a plasticizer.

17. The flexible, hydrophobic textile of claim 16, wherein the plasticizer is selected from the group consisting of: polyacrylamide, polyacrylic acid, polymethacrylate, and polyethylene imine.

18.-36. (canceled)

37. A method of producing a flexible, hydrophobic textile comprising a symbiotic culture of bacteria and yeast (SCOBY) and silica sol, the method comprising:
a. optionally drying the SCOBY to prepare a dried SCOBY sheet;
b. exposing the SCOBY or the dried SCOBY sheet to a silica sol to prepare a SCOBY/silica sol matrix, the silica sol prepared from water glass and a first silicon alkoxide;
c. heat treating the SCOBY/silica sol matrix to prepare a dried, silanized SCOBY pad;
d. applying a second silicon alkoxide to the dried, silanized SCOBY pad to prepare an uncured textile; and
e. curing the uncured textile by exposure to heat to prepare the flexible, hydrophobic textile.

38.-63. (canceled)

64. An article of commerce comprising the flexible, hydrophobic textile of claim 1.

65. The article of commerce of claim 64, wherein the article of commerce is selected from the group consisting of: clothing, shoes, luggage, furniture, sports equipment, and upholstery.

66. The article of commerce of claim 64, wherein the article of commerce does not comprise leather.
